(19) United States
(12) Patent Application Publication
(10) Pub. No.: US 2016/0124123 A1
(43) Pub. Date: May 5, 2016

(54) CELLULOSE ACYLATE FILM, POLARIZING PLATE, AND LIQUID CRYSTAL DISPLAY USING THE SAME

(71) Applicant: FUJIFILM Corporation, Tokyo (JP)

(72) Inventors: Masaki NORO, Kanagawa (JP); Yutaka NOZOE, Kanagawa (JP); Hiroshi INADA, Kanagawa (JP); Naoya SHIMOJU, Kanagawa (JP); Hisato NAGASE, Kanagawa (JP); Hiroyuki HAGIO, Kanagawa (JP); Yu NAITO, Kanagawa (JP); Nobutaka FUKAGAWA, Kanagawa (JP)

(73) Assignee: FUJIFILM Corporation, Tokyo (JP)

(21) Appl. No.: 14/991,544

(22) Filed: Jan. 8, 2016

Related U.S. Application Data
(63) Continuation of application No. PCT/JP2014/068355, filed on Jul. 9, 2014.

(30) Foreign Application Priority Data
Jul. 9, 2013 (JP) 2013-143708
Dec. 10, 2013 (JP) 2013-255377

(51) Int. Cl. G02B 1/14; G02F 1/1335; G02B 5/30; C08J 5/18

(52) U.S. Cl. CPC G02B 1/14; C08J 5/18; G02F 1/133528; G02B 5/3033; C08J 2301/10

(57) ABSTRACT

A cellulose acylate film, containing at least: a cellulose acylate; and a compound represented by the following Formula (I):

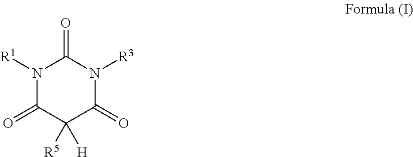

wherein R¹, R³ and R⁵ each independently designate a hydrogen atom, an alkyl group, a cycloalkyl group, an alkenyl group, or an aromatic group, which groups may have a further substituent; with the proviso that at least one of R¹, R³ and R⁵ is an alkyl group substituted with a group having a ring structure or a cycloalkyl group, and the total number of the ring structures existing in R¹, R³ and R⁵ is 3 or more.

### CROSS-REFERENCE TO RELATED APPLICATIONS

This application is a Continuation of PCT International Application No. PCT/JP2014/068355 filed on Jul. 9, 2014, which claims priority under 35 U.S.C. §119 (a) to Japanese Patent Application No. 2013-143708 filed on Jul. 9, 2013, and Japanese Patent Application No. 2013-255377 filed on Dec. 10, 2013. Each of the above applications is hereby expressly incorporated by reference, in its entirety, into the present application.

### TECHNICAL FIELD

The present invention relates to a cellulose acylate film, a polarizing plate, and a liquid crystal display using the same.

### BACKGROUND ART

Cellulose acylate films are used for various liquid crystal displays, as optical elements thereof, such as supports for optical compensation films, and protective films for polarizing plates.

In addition to an indoor use of the liquid crystal display, such as a TV use, a chance of the outdoor use thereof is increased, for example, use as a mobile device. As a result, development of a liquid crystal display is required, which is durable to the use under hygrothermal conditions than ever before. However, when the liquid crystal display is used under the hygrothermal conditions, there is a problem of deterioration of image quality due to occurrence of unevenness caused by contraction of the polarizer or lowering in polarization performance, caused by contraction of the polarizer. Further, in the liquid crystal display, a demand for durability in a wide array of uses and under extreme use condition has been increasing, and year after year a durability at a higher level than that of conventional liquid crystal displays before has been required. Further, more improvement in the performances of these liquid crystal displays has been required as a result of making a liquid crystal display thinner in recent years.

Patent Literature 1 describes that durability of the polarizer under the hygrothermal conditions can be improved, by a resin film (including a cellulose acylate film) containing an organic acid with acid dissociation constant of from 2 to 7 in a particular solvent. Further, Patent Literature 2 also discloses a cellulose acylate film containing a barbituric acid derivative known as an organic acid. However, durability of the polarizer is not described in this literature.

### CITATION LIST

### Patent Literatures

Patent Literature 1: JP-A-2011-118135 (“JP-A” means unexamined published Japanese patent application)
Patent Literature 2: JP-A-2011-126968

### SUMMARY OF INVENTION

### Technical Problem

The present inventors conducted intensive studies for further improving the polarizer durability under the hygrothermal conditions. As a result, the present inventors have found that, in addition to the improvement of the durability, it is necessary to solve problems newly caused by adverse effects due to addition of various kinds of additives, for example: improvement of optical film coloration and adhesion to a hard coat layer in a case of providing the hard coat layer; lowering of metal corrosiveness; and the like.

The present invention is contemplated for providing: a cellulose acylate film which improves not only a durability of a polarizing plate incorporating therein a polarizer but also inhibition of optical film coloration and an adhesion to the hard coat layer or the like in a case of providing the hard coat layer or the like, so that a image quality of the liquid crystal display can be further enhanced; and a polarizing plate and a liquid crystal display each using the same.

### Solution to Problem

As a result of studies regarding a relation between various kinds of additives and various performances due to them for dissolving the above problem, the present inventors found that the durability of the polarizing plate can be improved by using a cellulose acylate film containing a barbituric acid having a particular structure as a protective film for the polarizer. As a result of further intensive studies regarding substituents as well as a combination of these substituents, the present inventors recognized the importance of the ring structure which a barbituric acid has as a substituent. In consequence, the present inventors found that coloration due to light irradiation over time can be suppressed by addition of a barbituric acid derivative having a particular structure to a cellulose acylate film.

Further, the present inventors found that the barbituric acid derivative having the above-described particular structure has almost no metal corrosiveness and exhibits less volatilization and therefore the above-described cellulose acylate film has an advantage in production thereof.

That is, the above problem was solved by the following means:

<1> A cellulose acylate film, comprising at least:

a cellulose acylate; and

a compound represented by the following Formula (I):

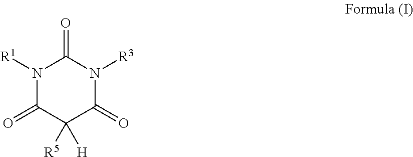

wherein R¹, R³ and R⁵ each independently designate a hydrogen atom, an alkyl group, a cycloalkyl group, an alkenyl group, or an aromatic group, which groups may have a further substituent; with the proviso that at least one of R¹, R³ and R⁵ is an alkyl group substituted with a group having a ring structure or a cycloalkyl group, and the total number of the ring structures existing in R¹, R³ and R⁵ is 3 or more.

<2> The cellulose acylate film described in the item <1>,

wherein at least two of R¹, R³ and R⁵ are an alkyl group substituted further with a group having a ring structure as a substituent or a cycloalkyl group.

<3> The cellulose acylate film described in the item <1> or <2>,

wherein R⁵ is an alkyl group substituted further with a group having a ring structure as a substituent or a cycloalkyl group.

<4> The cellulose acylate film described in any one of the items <1> to <3>,

wherein R¹ and R³ each independently designate an alkyl group which may have a further substituent or an aromatic group which may have a further substituent.

<5> The cellulose acylate film described in any one of the items <1> to <4>,

wherein the cellulose acylate has a total acyl substitution degree “A” which is in the range represented by the following formula:

1.5≦A≦3.0

<6> The cellulose acylate film described in any one of the items <1> to <5>,

wherein an acyl group of the cellulose acylate is an acetyl group, and the cellulose acylate has a total acetyl substitution degree “B” which is in the range represented by the following formula:

2.0≦B≦3.0

<7> The cellulose acylate film described in the item <6>,

wherein the total acetyl substitution degree “B” is 2.5 or more and less than 2.97.

<8> The cellulose acylate film described in any one of the items <1> to <7>, comprising at least one polycondensation ester compound.
<9> The cellulose acylate film described in the item <8>,

wherein the polycondensation ester compound is a compound obtained by polycondensing at least one dicarboxylic acid represented by the following Formula (a) and at least one diol represented by the following Formula (b):

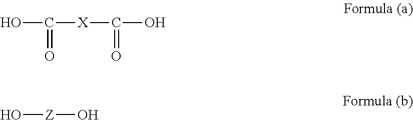

wherein,

in formula (a), X designates a divalent aliphatic group having 2 to 18 carbon atoms or a divalent aromatic group having 6 to 18 carbon atoms, and

in formula (b), Z designates a divalent aliphatic group having 2 to 8 carbon atoms.

<10> The cellulose acylate film described in the item <8> or <9>,

wherein the polycondensation ester compound has a number average molecular weight from 500 to 2,000.

<11> The cellulose acylate film described in any one of the items <8> to <10>,

wherein the polycondensation ester compound has sealed terminals.

<12> The cellulose acylate film described in any one of the items <1> to <1>, comprising: a monosaccharide or at least one carbohydrate compound containing 2 to 10 monosaccharide units.
<13> The cellulose acylate film described in the item <12>,

wherein the carbohydrate compound has an alkyl group, an aryl group, or an acyl group, as a substituent.

<14> A polarizing plate, comprising at least:

the cellulose acylate film described in any one of the items <1> to <13>; and

a polarizer.

<15> A liquid crystal display, at least comprising at least:

the polarizing plate described in the item <14>; and

a liquid crystal cell.

Note that, in this specification, any numerical expressions in a style of “ . . . to . . . ” will be used to indicate a range including the lower and upper limits represented by the numerals given before and after “to”, respectively.

Further, in the present specification, the term “group” which is explained about each group is used in a sense such that any of the aspect having no substituent and the aspect having a substituent is incorporated therein, unless otherwise indicated. For example, the term “alkyl group” means an alkyl group which may have a substituent. Further, in the present specification, the term “aliphatic group” may be a straight chain, branched, or cyclic aliphatic group which may be saturated or unsaturated (except that it results in an aromatic ring).

In the present specification, when a plurality of substituents, linking groups or the like (hereinafter, referred to as “substituent or the like”) are simultaneously or alternatively defined herein, respective substituents or the like may be identical with or different from each other.

### Advantageous Effects of Invention

The cellulose acylate film of the present invention enables improvement of polarizer durability of the polarizing plate, inhibition of optical film coloration and adhesion to a hard coat layer in a case of providing the hard coat layer or the like. In consequence, this allowed provision of a cellulose acylate film which enabled an image quality of the liquid crystal display to enhance, and a polarizing plate and a liquid crystal display each using the same.

Other and further features and advantages of the invention will appear more fully from the following description, appropriately referring to the accompanying drawings.

### BRIEF DESCRIPTION OF DRAWINGS

FIG. 1 is an example of an exploded perspective view schematically showing an internal structure of a liquid crystal display.

FIG. 2 is a schematic view showing an example in which casting of a cellulose acylate film having a three-layer structure is carried out by a simultaneous co-casting using a co-casting die.

### DESCRIPTION OF EMBODIMENTS

Hereinafter, the present invention is described in detail referring to the embodiments.

The cellulose acylate film of the present invention is composed of at least one layer of a cellulose acylate film containing a cellulose acylate and at least one compound represented by Formula (I). Further, the cellulose acylate film may be composed of two or more layers, and the compound represented by Formula (I) may be contained in any of the two or more layers or may be contained in all of the layers.

Herein, the cellulose acylate film or layer means a film or a layer, in which a cellulose acylate is contained in the content of 50% by mass or more, with respect to the resin component which constitutes the film or layer. In this regard, the content of the cellulose acylate in the resin component is preferably 60% by mass or more, more preferably 70% by mass or more, still more preferably 80% by mass or more, and particularly preferably 85% by mass or more. It is noted that the upper limit of the content of the cellulose acylate is not limited in particular.

On the other hand, the cellulose acylate film of the present invention may form a multilayer configuration including another layer in which no cellulose acylate is contained as a resin component or, if any, a cellulose acylate is contained in the content of less than 50% by mass, in addition to the layer in which a cellulose acylate is contained in the content of 50% by mass or more. Such another layer includes various kinds of functional layers each of which specializes in a particular function. Examples of the functional layer include a hard coat layer.

The cellulose acylate film of the present invention is able to exhibit an effect of suppressing deterioration of the polarizing plate and therefore it is useful for various kinds of intended uses such as a polarizing plate protective film, a surface protective film which is provided on the surface of the image display, and the like.

### <<Cellulose Acylate Film>>

In the present invention, as described above, the cellulose acylate film is composed of a film in which the proportion of cellulose acylate to the resin structural component is 50% by mass or more, and the cellulose acylate film is a narrow definition of optical film in the present invention.

The cellulose acylate film may be either a single layer or a layered product having at least two layers. However, the layer in this context means a layer which does not contain such functional layer as described above, but a layer in which cellulose acylate is contained in the proportion of 50% by mass or more with respect to the total of the resin component. In the case where the cellulose acylate film is the layered product having at least two layers, a double-layered structure or a three-layered structure is preferable, and a three-layered structure is more preferable. In case of the three-layered structure, the cellulose acylate film preferably has one core layer (that is, this layer is the thickest layer and hereinafter is also referred to as a basic layer), a skin A layer and a skin B layer with which the core layer is sandwiched. That is to say, the cellulose acylate film of the present invention preferably has the three-layered structure formed of skin B layer/core layer/skin A layer. Such layered product can be produced by a wide variety of arbitrary casting methods, such as a co-casting as described below. The skin B layer is a layer which contacts with a metal support described below, at the time when the cellulose acylate film is produced by a solution film forming method, and the skin A layer is a layer located at the air interface on the side opposite to the metal support. It is noted that generically both the skin A layer and the skin B layer are also referred to as a skin layer (or a surface layer).

As for the cellulose acylate film of the present invention, the acyl substitution degree of the cellulose acylate in each layer thereof may be uniform, or alternatively plural kinds of cellulose acylate may be incorporated as a mixture thereof in the same layer. However, it is preferable from the viewpoint of adjusting optical properties that the acyl substitution degree of the cellulose acylate in each layer is entirely constant. In the case where the cellulose acylate film of the present invention is a three-layered structure, it is preferable from the viewpoint of production cost to use cellulose acylates having the same acyl substitution degree as for the cellulose acrylates which are incorporated in surface layers on the two sides.

### <Compound Represented by Formula (I)>

The cellulose acylate film of the present invention contains at least one compound represented by the following formula (I).

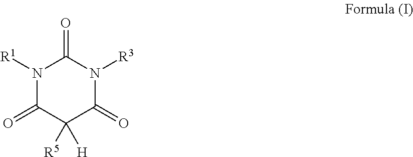

In formula (I), R¹, R³ and R⁵ each independently designate a hydrogen atom, an alkyl group, a cycloalkyl group, an alkenyl group, or an aromatic group. An alkyl group, a cycloalkyl group, an alkenyl group, and an aromatic group may have a substituent. However, any one of R¹, R³ and R⁵ is an alkyl group substituted with a group having a ring structure or a cycloalkyl group, and the total number of ring structures existing in R¹, R³ and R⁵ is 3 or more.

The number of carbon atoms of the alkyl group in R¹, R³ and R⁵ is preferably from 1 to 20, more preferably from 1 to 10, further preferably from 1 to 5, and particularly preferably from 1 to 3. The alkyl group in R¹, R³ and R⁵ is particularly preferably a methyl group or an ethyl group. However, in the case of the alkyl group substituted with a group having a ring structure, the number of carbon atoms of the alkyl group is preferably from 7 to 20, more preferably from 7 to 12, and still more preferably from 7 to 10. The ring structure in the alkyl group having a ring structure may be an aromatic ring (in which an aromatic hetero ring is contained) or an aliphatic ring. Of these, an aromatic hydrocarbon ring or an aliphatic ring is preferable.

The number of carbon atoms of the cycloalkyl group in R¹, R³ and R⁵ is preferably from 3 to 20, more preferably from 3 to 10, further preferably from 4 to 8, and particularly preferably 5 or 6. Preferred specific examples of the cycloalkyl group include cyclopropyl, cyclopentyl, and cyclohexyl. Of these, cyclohexyl is particularly preferable.

The number of carbon atoms of the alkenyl group in R¹, R³ and R⁵ is preferably from 2 to 20, more preferably from 2 to 10, and further preferably from 2 to 5. Specific examples thereof include vinyl and allyl.

The aromatic group in R¹, R³ and R⁵ may be an aromatic hydrocarbon group or an aromatic heterocyclic group. Of these, the aromatic hydrocarbon group is preferable. The number of carbon atoms of the aromatic group is preferably from 6 to 20, more preferably from 6 to 16, and still more preferably from 6 to 12.

As the aromatic group (in particular, as the aromatic hydrocarbon group), phenyl and naphtyl are preferable, and phenyl is more preferable.

The above groups of R¹, R³ and R⁵ may have a substituent.

The substituent is not particularly limited and examples thereof include: alkyl groups (preferably those having from 1 to 10 carbon atoms, for example, methyl, ethyl, isopropyl, t-butyl, pentyl, heptyl, 1-ethylpentyl, benzyl and the like); alkenyl groups (preferably those having from 2 to 20 carbon atoms, for example, vinyl, allyl, oleyl and the like); alkynyl groups (preferably those having from 2 to 20 carbon atoms, for example, ethynyl, 2-butynyl, phenylethynyl and the like); cycloalkyl groups (preferably those having from 3 to 20 carbon atoms, for example, cyclopropyl, cyclopentyl, cyclohexyl, 4-methylcyclohexyl and the like); aryl groups (preferably those having from 6 to 26 carbon atoms, for example, phenyl, 1-naphtyl, 4-methoxyphenyl, 2-chlorophenyl, 3-methylphenyl and the like); heterocyclic groups (those preferably having from 0 to 20 carbon atoms and preferably having a ring-constituting heteroatom selected from an oxygen atom, a nitrogen atom and a sulfur atom, and those preferably having a 5- or 6-membered ring which may be condensed with a benzene ring or a hetero ring, and said ring may be a saturated ring, an unsaturated ring or an aromatic ring, for example, 2-pyridinyl, 3-pyridinyl, 4-pyridinyl, 2-imidazolyl, 2-benzoimidazolyl, 2-thiazolyl, 2-oxazolyl and the like); alkoxy groups (preferably those having from 1 to 20 carbon atoms, for example, methoxy, ethoxy, isopropyloxy, benzyloxy and the like); aryloxy groups (preferably those having from 6 to 26 carbon atoms, for example, phenoxy, 1-naphthyloxy, 3-methylphenoxy, 4-methoxyphenoxy and the like);

alkylthio groups (preferably those having from 1 to 20 carbon atoms, for example, methylthio, ethylthio, isopropylthio, benzylthio and the like); arylthio groups (preferably those having from 6 to 26 carbon atoms, for example, phenylthio, 1-naphtylthio, 3-methylphenylthio, 4-methoxyphenylthio and the like); sulfonyl groups (preferably alkyl- or -aryl-sulfonyl groups and those having from 1 to 20 carbon atoms, for example, methyl sulfonyl, ethyl sulfonyl, benzene sulfonyl, toluene sulfonyl and the like); acyl groups (those including an alkylcarbonyl group, an alkenylcarbonyl group, an arylcarbonyl group and a heterocyclic carbonyl group, and preferably having 20 or less carbon atoms, for example, acetyl, pivaloyl, acryloyl, methacryloyl, benzoyl, nicotinoyl and the like); alkoxycarbonyl groups (preferably those having from 2 to 20 carbon atoms, for example, ethoxycarbonyl, 2-ethylhexyloxycarbonyl and the like); aryloxycarbonyl groups (preferably those having from 7 to 20 carbon atoms, for example, phenyloxycarbonyl, naphthyloxycarbonyl and the like); amino groups (those including an amino group, an alkylamino group, an arylamino group and a heterocyclic amino group, and preferably having from 0 to 20 carbon atoms, for example, amino, N,N-dimethyl amino, N,N-diethylamino, N-ethyl amino, anilino, 1-pyrrolidinyl, piperidino, morpholinyl and the like); sulfonamido groups (preferably alkyl- or -aryl-sulfonamido groups and those having from 0 to 20 carbon atoms, for example, N,N-dimethylsulfonamido, N-phenylsulfonamido and the like); sulfamoyl groups (preferably alkyl- or -aryl-sulfamoyl groups and those having from 0 to 20 carbon atoms, for example, N,N-dimethylsulfamoyl, N-phenylsulfamoyl and the like); acyloxy groups (preferably those having from 1 to 20 carbon atoms, for example, acetyloxy, benzoyloxy and the like); carbamoyl groups (preferably alkyl- or -aryl-carbamoyl groups and those having from 1 to 20 carbon atoms, for example, N,N-dimethyl carbamoyl, N-phenylcarbamoyl and the like); acylamino groups (preferably those having from 1 to 20 carbon atoms, for example, acetylamino, acryloylamino, benzoylamino, nicotine amido and the like); a cyano group; a hydroxy group; a mercapto group; a carboxyl group; and a halogen atom (for example, fluorine atom, chlorine atom, bromine atom, iodine atom and the like).

The above-described substituent may be further substituted with the above-described substituent. Examples of such substituents include: a perfluoroalkyl group such as a trifluoromethyl; an aralkyl group; an alkyl group substituted with an acyl group; and the like.

It is noted that these substituents are not only applied to the substituent which each of R¹, R³ and R⁵ may have, but also applied to the substituent for all of the compounds described in the present specification.

Herein, as the substituent with which each group of R¹, R³ and R⁵ may be substituted, an alkyl group, an aryl group, an alkoxy group, an alkylthio group, an alkylsulfonyl group, a halogen atom, and an acyl group are preferable; an alkyl group, an aryl group, an alkoxy group, and an acyl group are more preferable; and an alkyl group and an alkoxy group are further preferable.

In the compound represented by Formula (I), any one of R¹, R³ and R⁵ is an alkyl group substituted with a group having a ring structure, or a cycloalkyl group. Any one of them is preferably an alkyl group substituted with a group having a ring structure.

In particular, the compound in which R⁵ is an alkyl group substituted with a group having a ring structure, or a cycloalkyl group is preferable.

In this regard, the ring of the group having a ring structure is preferably a benzene ring, a naphthalene ring, a cyclopentane ring, a cyclohexane ring, and a nitrogen-containing heteroaromatic ring (for example, pyrrol ring, pyrazole ring, imidazole ring, oxazole ring, thiazole ring, pyridine ring, indole ring, isoindol ring, and the like).

Further, the compound represented by Formula (I), in which at least two of R¹, R³ and R⁵ are an alkyl group having a ring structure as a substituent, or a cycloalkyl group, is preferable. Further, the case where R¹ and R³ each independently represent an alkyl group which may have a substituent, or an aromatic group or cycloalkyl group which may have a substituent, is particularly preferable.

The compound represented by Formula (I), in which the total of the ring structure existing in the substituent of R¹, R³ and R⁵ is a maximum number of 4, is still more preferable.

R⁵ is preferably an alkyl group which may be substituted with a ring-structural group or an acyl group, or a cycloalkyl group, more preferably an alkyl group substituted with an aryl group, or an alkyl group substituted with an acyl group, or a cycloalkyl group, and still more preferably an alkyl group substituted with an aryl group, or a cycloalkyl group.

Hereinafter, the above-described preferable alkyl group or cycloalkyl group in R⁵ will be described in more detail.

With respect to the alkyl group, examples of the unsubstituted alkyl group include methyl, ethyl, propyl, isopropyl, n-butyl, n-hexyl, 2-ethylhexyl, and n-octyl.

Examples of the alkyl group substituted with a ring-structural group include: an aralkyl group such as benzyl, phenetyl, 3-phenylpropyl, and naphthylmethyl; pyridine-2-yl methyl; pyridine-3-yl methyl; pyridine-4-yl methyl; and indol-3-yl methyl.

The acyl group in the alkyl group substituted with an acyl group is preferably an alkylcarbonyl group, a cycloalkylcarbonyl group, or an arylcarbonyl group; more preferably a cycloalkylcarbonyl group or an arylcarbonyl group having a ring structure; and particularly preferably an arylcarbonyl group.

Examples of the above-described alkylcarbonyl group include acetyl, propionyl, butyryl, and pivaloyl. Examples of the above-described cycloalkylcarbonyl group include cyclopropylcarbonyl, cyclopentylcarbonyl, and cyclohexylcarbonyl. Examples of the above-described arylcarbonyl group include benzoyl, toluoyl, and naphthoyl.

Examples of the alkyl group substituted with an acyl group include a 2-acylethyl group, a 3-acylpropyl group, and a 2-acylpropyl group. Of these, a 2-acylethyl group is preferable.

Examples of the cycloalkyl group include those exemplified in R¹, R³ and R⁵.

Although the mechanism is not clear, the absorption wavelength of the compound represented by Formula (I) is thought to have been shifted to a shorter wavelength by suppressing extension of the conjugated structure due to R⁵. Therefore, the compound is thought to effectively act with cellulose acylate, thereby contributing to inhibition of coloration over time and improvement of adhesion to the hard coat layer.

Preferable compounds among the compound represented by Formula (I) are listed below.

Compounds in which at least one of R¹, R³ and R⁵ is an alkyl group substituted with an aromatic ring:

It is noted that, among alkyl groups substituted with an aromatic ring, an alkyl group substituted with one or two aryl groups is preferable (in the case of substitution with two aryl groups, the two aryl groups are preferably substituted at the same carbon atom). Further, an alkyl group substituted with both an aryl group and an acyl group (preferably an aryloyl group) is also preferable.

Compounds in which any one of R¹, R³ and R⁵ is a group having a cycloalkyl group, preferably compounds in which the group having a cycloalkyl group is a cycloalkyl group:

In the case where “the ring structures existing in R¹, R³ and R⁵ are 3 or more in total” as described above, the ring structure also includes such a configuration that the substituent which R¹, R³ or R⁵ has, possesses a ring structure as exemplified already, in addition to the configuration that the basic skeleton itself of the substituent represented by R¹, R³ or R⁵ has a ring structure.

As for the above-described ring structure, an alicyclic structure or an aromatic ring structure (aromatic hydrocarbon structure or aromatic hetero ring structure) is preferable. Further, the ring structure may be a condensed ring structure.

In the case where the above-described ring structure is an alicyclic structure, the alicyclic structure preferably presents as a cycloalkyl group having 3 to 20 carbon atoms. More specifically, the alicyclic structure more preferably presents as a cyclopropyl group, a cyclopentyl group, or a cyclohexyl group, and particularly preferably presents as a cyclohexyl group.

Further, in the case where the above-described ring structure is an aromatic ring structure, the aromatic ring structure is preferably an aromatic hydrocarbon structure. The aromatic hydrocarbon structure preferably presents as an aryl group having 6 to 20 carbon atoms. More specifically, the ring of the aryl group more preferably presents as a benzene ring or a naphthalene ring, and particularly preferably presents as a benzene ring.

The above-described ring structure may have a substituent. In the case where the ring structure has a substituent, a preferable range thereof is the same as the range of the substituent which R¹, R³ and R⁵ may have.

In the compound represented by Formula (I), the embodiment in which R¹, R³ and R⁵ are an alkyl group, an alkenyl group, or an aryl group is more preferable. Further, the embodiment in which each of R¹, R³ and R⁵ has one or more ring structure are more preferable, and the embodiment in which each of R¹, R³ and R⁵ has one ring structure are still more preferable.

The molecular weight of the compound represented by formula (I) is preferably 250 to 1,200, more preferably 300 to 800, and particularly 350 to 600.

By setting the molecular weight to such a preferable range, a high-transparent film which is excellent in inhibiting volatilization of the compound represented by formula (I) in the present invention from the film, can be obtained.

Hereinafter, the specific examples of the compound represented by formula (I) in the present invention are described, but the present invention is not limited thereto.

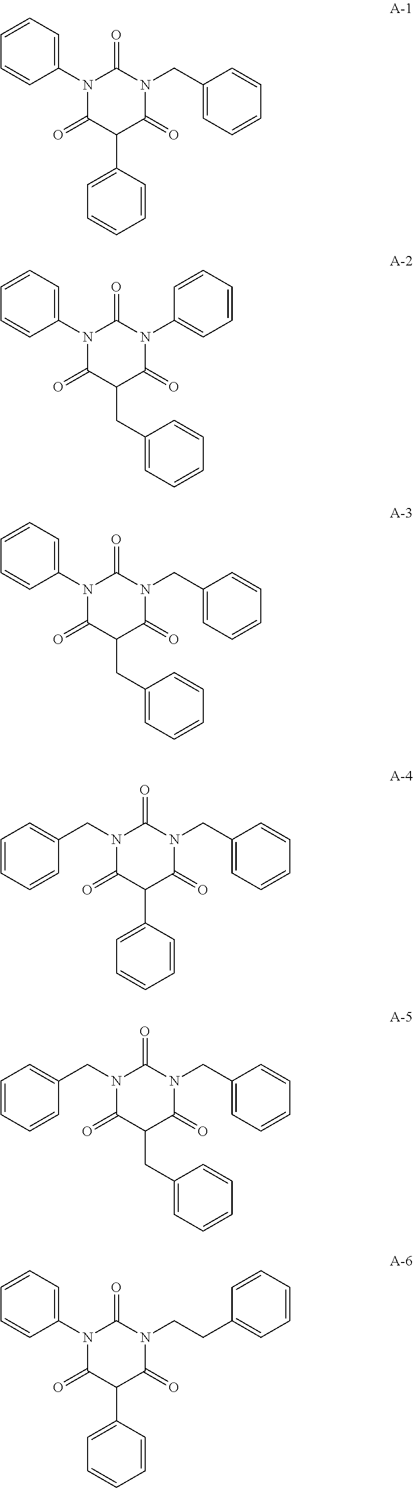

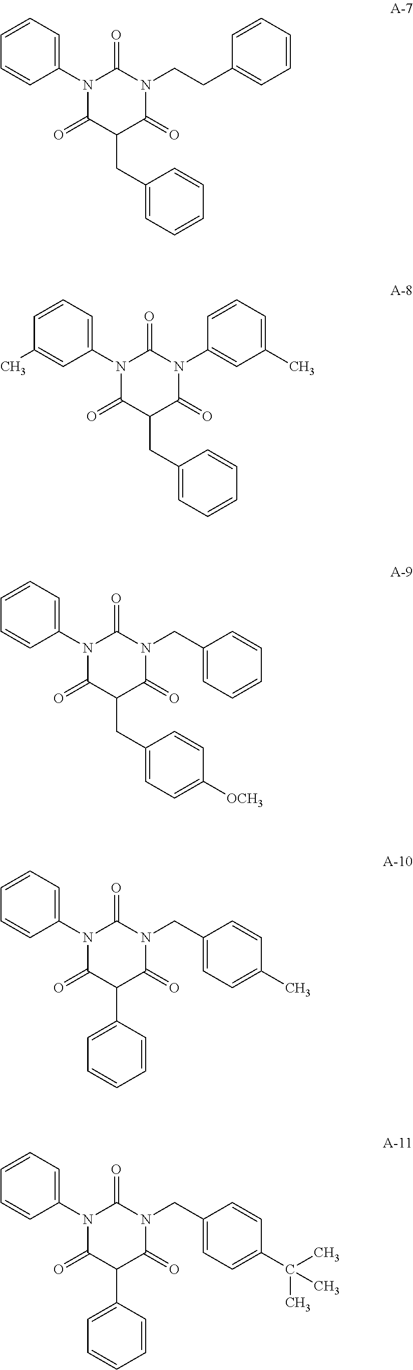

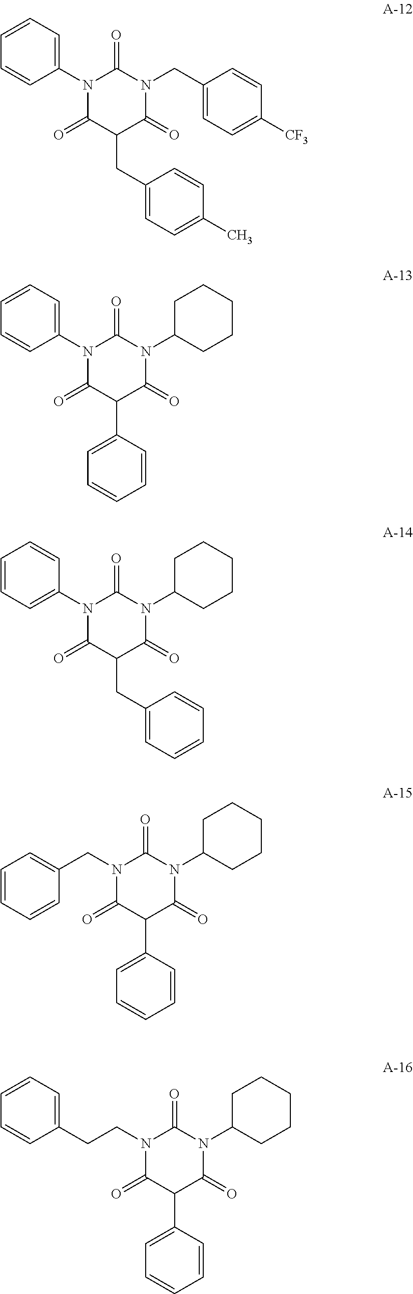 [SMILES: Cc1ccc(CC2C(=O)N(Cc3ccc(C(F)(F)F)cc3)C(=O)N(c3ccccc3)C2=O)cc1 ; O=C1C(c2ccccc2)C(=O)N(C2CCCCC2)C(=O)N1c1ccccc1 ; O=C1C(Cc2ccccc2)C(=O)N(C2CCCCC2)C(=O)N1c1ccccc1 ; O=C1C(c2ccccc2)C(=O)N(C2CCCCC2)C(=O)N1Cc1ccccc1 ; O=C1C(c2ccccc2)C(=O)N(C2CCCCC2)C(=O)N1CCc1ccccc1]

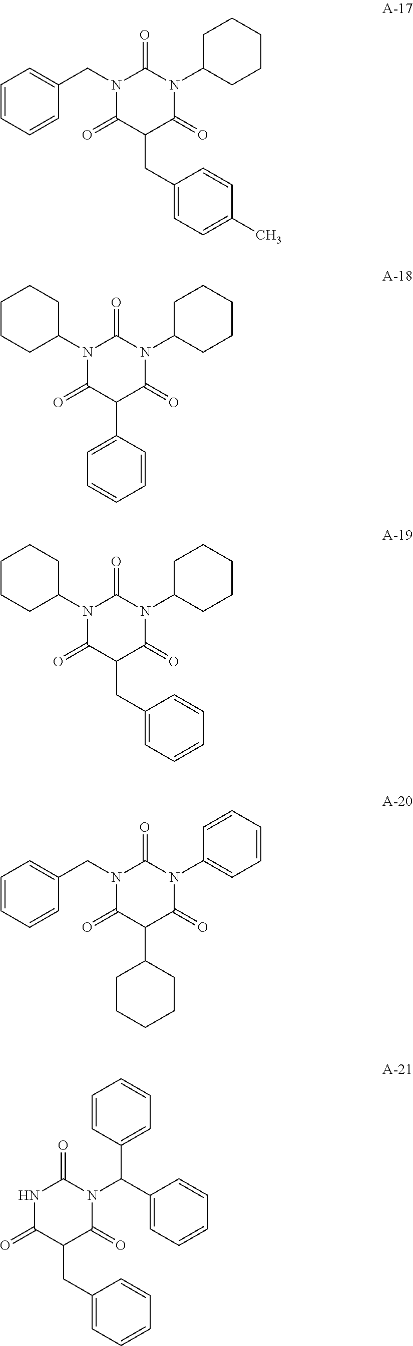 [SMILES: Cc1ccc(CC2C(=O)N(Cc3ccccc3)C(=O)N(C3CCCCC3)C2=O)cc1 ; O=C1C(c2ccccc2)C(=O)N(C2CCCCC2)C(=O)N1C1CCCCC1 ; O=C1C(Cc2ccccc2)C(=O)N(C2CCCCC2)C(=O)N1C1CCCCC1 ; O=C1C(C2CCCCC2)C(=O)N(c2ccccc2)C(=O)N1Cc1ccccc1 ; O=C1NC(=O)N(C(c2ccccc2)c2ccccc2)C(=O)C1Cc1ccccc1]

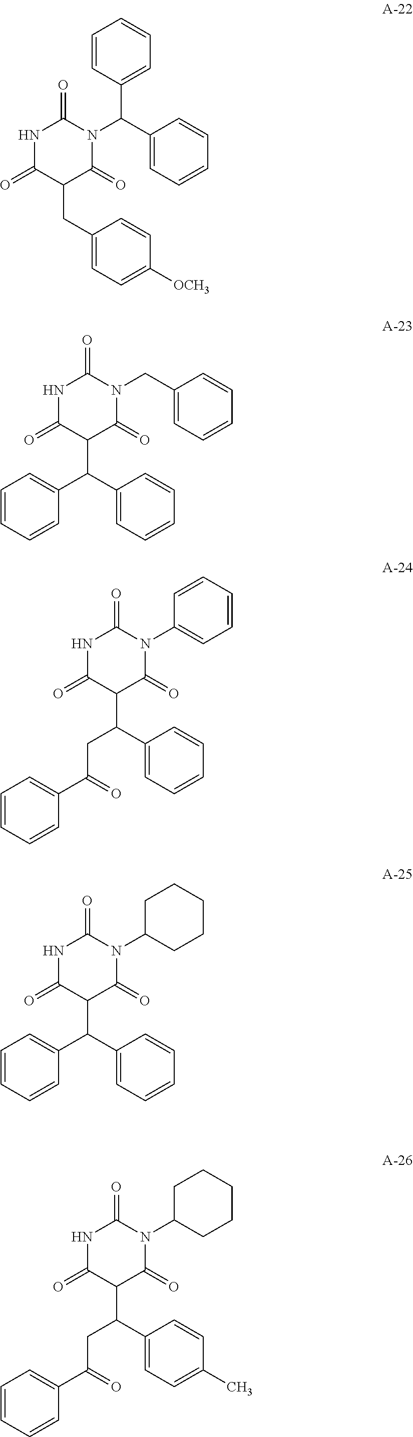 [SMILES: COc1ccc(CC2C(=O)NC(=O)N(C(c3ccccc3)c3ccccc3)C2=O)cc1 ; O=C1NC(=O)N(Cc2ccccc2)C(=O)C1C(c1ccccc1)c1ccccc1 ; O=C(CC(c1ccccc1)C1C(=O)NC(=O)N(c2ccccc2)C1=O)c1ccccc1 ; O=C1NC(=O)N(C2CCCCC2)C(=O)C1C(c1ccccc1)c1ccccc1 ; Cc1ccc(C(CC(=O)c2ccccc2)C2C(=O)NC(=O)N(C3CCCCC3)C2=O)cc1]

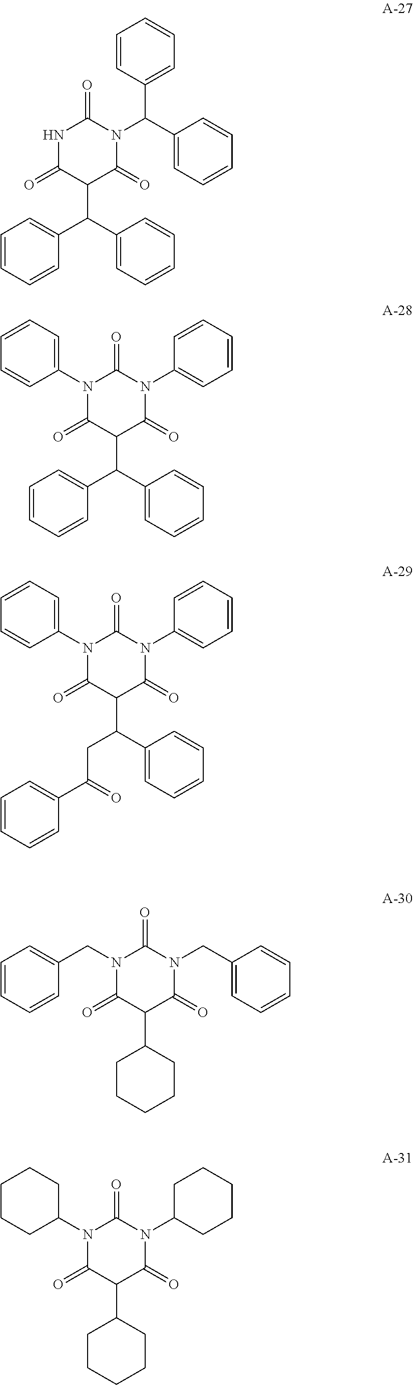

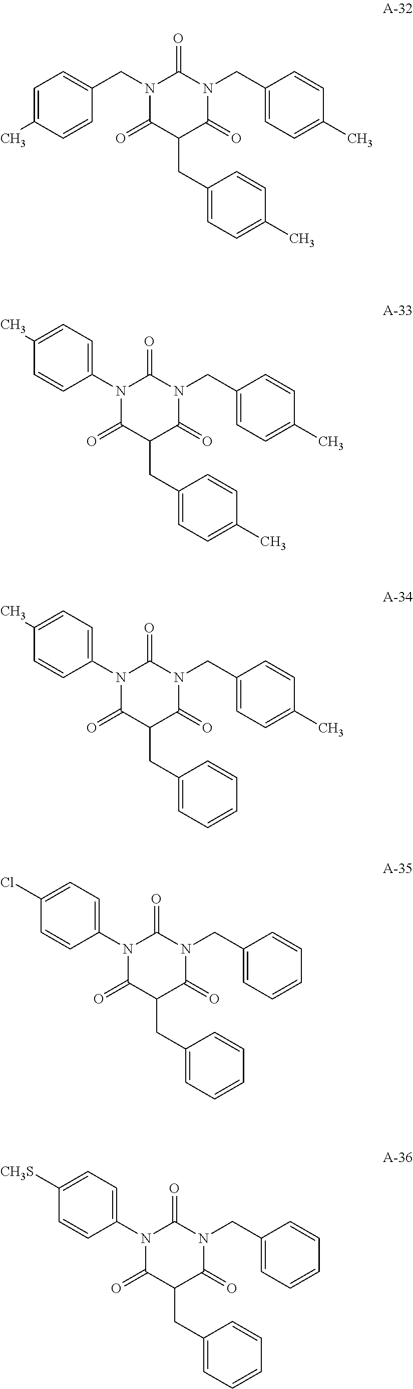

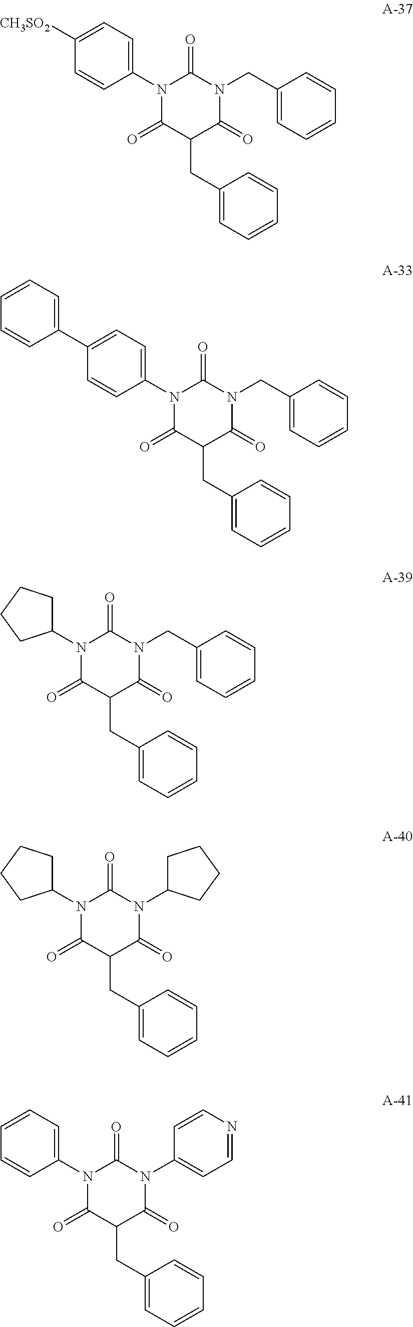

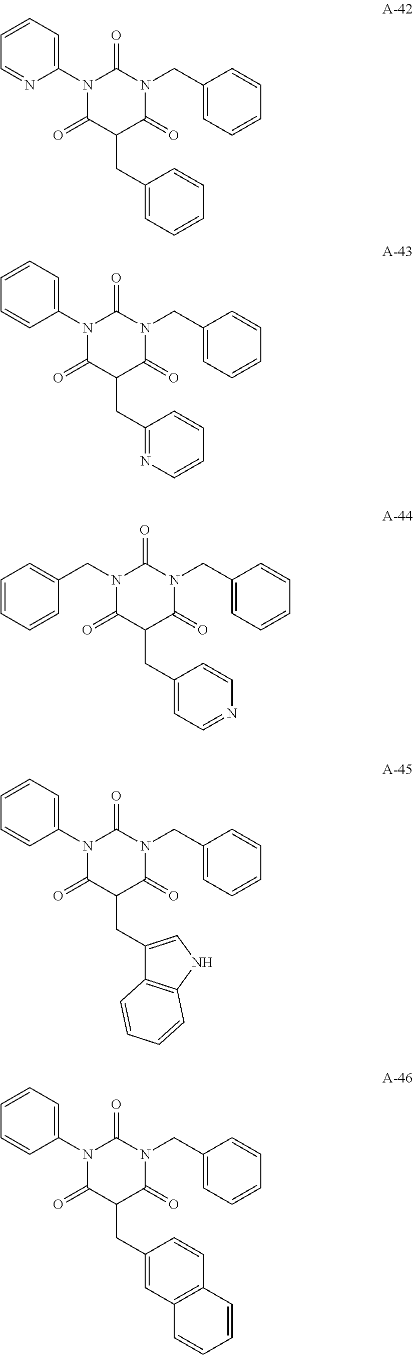 [SMILES: O=C1C(Cc2ccccc2)C(=O)N(c2ccccn2)C(=O)N1Cc1ccccc1 ; O=C1C(Cc2ccccn2)C(=O)N(c2ccccc2)C(=O)N1Cc1ccccc1 ; O=C1C(Cc2ccncc2)C(=O)N(Cc2ccccc2)C(=O)N1Cc1ccccc1 ; O=C1C(Cc2c[nH]c3ccccc23)C(=O)N(c2ccccc2)C(=O)N1Cc1ccccc1 ; O=C1C(Cc2ccc3ccccc3c2)C(=O)N(c2ccccc2)C(=O)N1Cc1ccccc1]

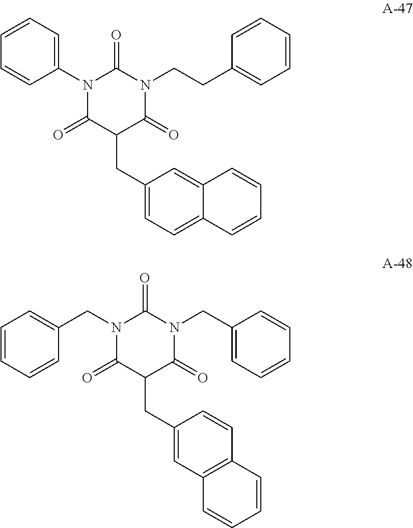 [SMILES: O=C1C(Cc2ccc3ccccc3c2)C(=O)N(c2ccccc2)C(=O)N1CCc1ccccc1 ; O=C1C(Cc2ccc3ccccc3c2)C(=O)N(Cc2ccccc2)C(=O)N1Cc1ccccc1]

It is known that the compound represented by formula (I) in the present invention can be synthesized using a barbituric acid synthesis method of subjecting a urea derivative and a malonic acid derivative to condensation. A barbituric acid which has two substituents on the nitrogen atoms can be obtained, by heating an N,N′-disubstituted urea together with malonic acid chloride or heating a mixture of N,N′-disubstituted urea, malonic acid and an activating agent, such as acetic anhydride. For example, methods can be used preferably, as described in Journal of the American Chemical Society, Vol. 61, page 1015 (1939), Journal of Medicinal Chemistry, Vol. 54, page 2409 (2011), Tetrahedron Letters, Vol. 40, page 8029 (1999), and WO 2007/150011 pamphlet, and the like.

Further, the malonic acid to be used for condensation may not be substituted or may have a substituent. The compound represented by formula (I) in the present invention can be synthesized by construction of a barbituric acid using a malonic acid having a substituent corresponding to R⁵. Further, by subjecting an unsubstituted malonic acid and a urea derivative to condensation, a barbituric acid which is not substituted at 5-position thereof is obtained. As a result, by modifying the thus-obtained compound, the compound represented by Formula (I) in the present invention may be synthesized.

The 5-position may be modified by a nucleophilic substitution reaction with a halogenated alkyl and the like, or by an addition reaction such as the Michael addition reaction. Also, a method using dehydrating condensation with an aldehyde or ketone to produce an alkylidene or arylidene compound, and then reducing a double bond, is preferably used. For example, a reduction method by zinc is described in Tetrahedron Letters, Vol. 44, page 2203 (2003), a reduction method by catalytic reduction is described in Tetrahedron Letters, Vol. 42, page 4103 (2001) and Journal of the American Chemical Society, Vol. 119, page 12849 (1997), and a reduction method by NaBH₄ is described in Tetrahedron Letters, Vol. 28, page 4173 (1987). All of them are a synthetic method which can be preferably used in the case where an aralkyl group or a cycloalkyl group is located at the 5-position.

Synthetic methods of the compound represented by Formula (I) used in the present invention are not limited to those described above.

Although the content of the compound represented by Formula (I) in cellulose acylate film is not particularly limited, the content is preferably from 0.1 to 20 parts by mass, more preferably from 0.2 to 15 parts by mass, and particularly preferably from 0.3 to 10 parts by mass, with respect to 100 parts by mass of cellulose acylate.

By setting the addition content of the compound represented by Formula (I) to be within the above range, water-vapor transmission ratio can be effectively reduced and generation of haze can be suppressed.

The scope of the present invention also includes a cellulose acetate film formed by addition of the compound represented by Formula (I) in the present invention in the form of its hydrate, solvate, or salt. It is noted that, in the present invention, the hydrate may contain an organic solvent and the solvate may contain water. That is, the term “hydrate” and the term “solvate” each include a mixed solvate containing both water and an organic solvent.

Examples of the solvent which the solvate contains include any of commonly-used organic solvents. Specifically, examples thereof include alcohols (for example, methanol, ethanol, 2-propanol, 1-butanol, 1-methoxy-2-propanol, t-butanol), esters (for example, ethyl acetate), hydrocarbons (either aliphatic or aromatic hydrocarbons, for example, toluene, hexane, heptane), ethers (for example, diethylether, tetrahydrofuran), nitriles (for example, acetonitrile), ketones (for example, acetone, 2-butanone), and the like. The solvate is preferably a solvate of alcohol, more preferably methanol, ethanol, 2-propanol, or 1-butanol. These solvents may be a reaction solvent used when synthesizing the compound represented by Formula (I) in the present invention, or a solvent used at the time of crystallization refinement after the synthesis, or a mixed solvent thereof.

Further, the solvent may contain two or more kinds of solvents at the same time, or may contain both water and a solvent (for example, water and alcohol (for example, methanol, ethanol, or t-butanol)).

The salt includes an acid addition salt formed of an inorganic acid or an organic acid. Examples of the inorganic acid include a hydrohalic acid (hydrochloric acid, or hydrobromic acid), sulfuric acid, phosphoric acid, and the like. Further, examples of the organic acid include acetic acid, trifluoroacetic acid, oxalic acid, citric acid, and further includes an alkanesulfonic acid (methanesulfonic acid), and an arylsulfonic acid (benzenesulfonic acid, 4-toluenesulfonic acid, or 1,5-naphthalenedisulfonic acid).

The salt also includes salts formed when an acidic portion existing in a parent compound is substituted with a metal ion (for example, alkali metal salts, for example, sodium or potassium salt, alkali-earth metal salt, for example, calcium or magnesium salt, ammonium salt alkali metal ion, alkali-earth metal ion, or aluminum ion), or the acidic portion is prepared together with an organic base (ethanolamine, diethanolamine, triethanolamine, morpholine, piperidine). The salt is not limited to these salts. Among these salts, a sodium salt and a potassium salt are preferable.

### <Cellulose Acylate>

In the present invention, cellulose acylate is used as a main component of the film. Herein, in the present specification, with respect to the embodiment in which a component constituting a raw material is one kind, the term “main component” means the component. On the other hand, with respect to the embodiment in which a component constituting the raw material is composed of two kinds or more component parts, the term “main component” means a component part which has the highest mass fraction of the component parts. One kind of cellulose acylate may be used, or alternatively two or more kinds thereof may be used in combination. The cellulose acylate may be a cellulose acylate having, for example, only an acetyl group as the acyl substituent thereof. Alternatively, a cellulose acylate having a plurality of different acyl substituents as the acyl substituent thereof may be used. The cellulose acylate may be a mixture of cellulose acylates that are different from one another.

The cellulose material for cellulose acylate which is used in the present invention includes cotton linter and wood pulp (hardwood pulp, softwood pulp), and cellulose acylate obtained from any of such a cellulose material are usable herein. Those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein.

In the present invention, the acyl group of the cellulose acylate may be one kind of acyl group, or two or more kinds of acyl groups. It is preferable that the cellulose acylate to be used in the present invention has an acyl group having 2 to 4 carbon atoms as a substituent. When two or more kinds of acyl groups are used, it is preferable that one kind of the acyl groups is an acetyl group and another kind of the acyl group having 2 to 4 carbon atoms is preferably propionyl group or butyryl group. By use of these cellulose acylates, a solution with a good solubility can be prepared. Especially in a non-chlorine organic solvent (for example, alcohols such as methanol and ethanol), preparation of a good solution becomes possible with these cellulose acylates. Further, preparation of a solution having a low viscosity and a good filterability becomes possible.

First, cellulose acylate to be preferably used in the present invention is described in detail.

The glucose unit having β-1,4 bonds which constitutes cellulose has free hydroxy groups at the 2-, 3-, and 6-positions thereof. The cellulose acylate is a polymeric substance (polymer) in which a part of or all of these hydroxy groups is or are acylated.

The acyl substitution degree indicates a degree of acylation of the hydroxy groups located at the 2-, 3-, and 6-positions of cellulose. When each of the hydroxy groups at the 2-, 3-, and 6-positions of all of the glucose units is acylated, the total acyl substitution degree is 3. For example, when each of the hydroxy groups only at the 6-position of all of the glucose units is acylated, the total acyl substitution degree is 1. In the same manner, even if each of the hydroxy groups at either the 6-position or the 2-position of the entire glucose unit is acylated, the total acyl substitution degree is 1.

That is to say, the acyl substitution degree indicates a degree of acylation, provided that when all of the hydroxy groups of the glucose molecule are entirely acylated, the acyl substitution degree is 3.

The details of the measurement method of the acyl substitution degree are described in Tezuka et al. (Carbohydrate, Res., 273 (1995) pp. 83 to 91). The acyl substitution degree can be determined according to the method defined in ASTM-D817-96.

When the total acyl substitution degree of the cellulose acylate to be used in the present invention is A, A is preferably from 1.5 to 3.0 (1.5≦A≦3.0), more preferably from 2.0 to 2.97, still more preferably from 2.5 to less than 2.97, and particularly preferably from 2.70 to 2.95.

When the acyl group of the cellulose acylate is only an acetyl group, if the total acetyl substitution degree is taken as B, B is preferably from 2.0 to 3.0 (2.0≦B≦3.0), more preferably from 2.0 to 2.97, still more preferably from 2.5 to less than 2.97, especially preferably from 2.55 to less than 2.97, more specially preferably from 2.60 to 2.96, and particularly preferably from 2.70 to 2.95.

The effects of the compound represented by formula (I) in the present invention are exerted particularly with respect to the cellulose acylate in which B that is the total acyl substitution degree is more than 2.50.

The acyl group having 2 or more carbon atoms in the cellulose acylate to be used in the present invention is not particularly limited, such that it may be an aliphatic acyl group or an aromatic acyl group. Examples thereof include cellulosic alkylcarbonyl esters, alkenylcarbonyl esters, aromatic carbonyl esters, and aromatic alkylcarbonyl esters (aralkylcarbonyl esters), each of which may have a substituent. Preferable examples of the acyl group having 2 or more carbon atoms include acetyl, propionyl, butanoyl, pentanoyl, heptanoyl, hexanoyl, octanoyl, decanoyl, dodecanoyl, tridecanoyl, tetradecanoyl, hexadecanoyl, octadecanoyl, isobutanoyl, pivaloyl, cyclohexane carbonyl, oleoyl, benzoyl, naphthylcarbonyl, and cinnamoyl. Among these, more preferred are acetyl, propionyl, butanoyl, dodecanoyl, octadecanoyl, pivaloyl, oleoyl, benzoyl, naphthyl carbonyl, and cinnamoyl. Particularly, an acyl group having 2 to 4 carbon atoms such as acetyl, propionyl and butanoyl is preferred. Especially, acetyl (that is, the case where the cellulose acylate is cellulose acetate) is more preferred.

In the case where an acid anhydride or an acid chloride is used as an acylating agent in acylation of the cellulose, an organic carboxylic acid solvent or a halogen solvent (for example, acetic acid or methylene chloride) is preferably used as an organic solvent which acts as a reaction solvent.

As for the catalyst, when the acylating agent is an acid anhydride, a protic catalyst, such as sulfuric acid, is preferably used. On the other hand, when the acylating agent is an acid chloride (for example, CH₃CH₂COCl), a basic compound is used as the catalyst.

A most common industrial method for the synthesis of a mixed fatty acid ester of cellulose is a method of acylating cellulose with a mixed organic acid component that includes fatty acids corresponding to an acyl group such as acetyl group (e.g. acetic acid corresponding to an acetyl group, propionic acid corresponding to a propionyl group, and valeric acid corresponding to a pentanoyl group) or their acid anhydrides.

The cellulose acylate may be produced, for example, according to the method described in JP-A-10-45804.

The cellulose acylate film of the present invention contains the cellulose acylate in the proportion of preferably from 5 to 99% by mass, more preferably from 20 to 99% by mass, and particularly preferably from 50 to 95% by mass, with respect to the total solid content of the film, from the viewpoint of water-vapor transmission ratio.

### <Other Additives>

To the cellulose acylate film of the present invention, additives, such as a retardation-controlling agent (retardation-developing agent and retardation-reducing agent), and as a plasticizer (a polycondensation ester compound (polymer), and a polyvalent ester of polyvalent alcohol, a phthalic acid ester, a phosphoric acid ester, and the like), an ultraviolet absorber, an antioxidant, and a matting agent, and a peeling promotive agent may be added.

In the present specification, when compounds are described, they may be described incorporating therein the expression“-based”, for example, like a phosphoric acid ester-based compound. In this case, this means the same as the phosphoric acid ester compound.

### (Retardation-Reducing Agent)

The polymer retardation-reducing agent is preferably at least one selected from a phosphoric acid ester polymer, a styrene polymer, an acrylic polymer and their copolymers. Of these, at least one polymer having a negative intrinsic birefringence selected from an acrylic polymer and a styrene polymer is more preferred.

Further, a low molecular weight retardation-reducing agent that is a non-phosphoric acid ester compound can be also preferably used.

The low molecular weight retardation-reducing agent that is the non-phosphoric acid ester compound is not particularly limited. Specifically, compounds described in paragraph Nos. [0066] to [0085] of JP-A-2007-272177 are preferable.

It is more preferable from the viewpoint of realizing a preferable Nz factor that the retardation-reducing agent which can be used in the present invention is an Rth reducing agent. Herein, the term “Rth” means retardation of the cellulose acylate film in the film thickness direction thereof. Examples of the Rth reducing agent include an acrylic polymer and a styrene polymer, and also a low molecular compound represented by any one of Formulae (3) to (7) described in JP-A-2007-272177.

The content of the retardation-reducing agent in the cellulose acylate film is preferably set to from 0.01 to 30 parts by mass, more preferably from 0.1 to 20 parts by mass, and particularly preferably from 0.1 to 10 parts by mass, with respect to 100 parts by mass of the cellulose acylate. When the addition amount is set to 30 parts by mass or less with respect to 100 parts by mass of the cellulose acylate, compatibility with the cellulose acylate can be improved and transparency of the cellulose acylate film can be enhanced. When two or more kinds of retardation-reducing agents are used, it is preferable that the total amount thereof is within the above-described range.

### (Retardation-Developing Agent)

The cellulose acylate film of the present invention may contain at least one kind of retardation-developing agent in order to develop a value of retardation.

The retardation-developing agent is not particularly limited, and examples thereof include a material including a stick-shaped or disc-shaped compound, and a compound that shows retardation-developing properties of the above-described non-phosphoric acid ester compounds. As for the stick-shaped or disc-shaped compound, a compound having at least two aromatic rings can be preferably used as the retardation-developing agent.

The content of the retardation-developing agent composed of a stick-shaped compound in the cellulose acylate film is preferably from 0.1 to 30 parts by mass, and more preferably from (0.5 to 20 parts by mass, with respect to 100 parts by mass of the cellulose acylate. Further, in the cellulose acylate film, the content of the disc-shaped compound that is contained in the retardation-developing agent is preferably less than 3 parts by mass, more preferably less than 2 parts by mass and particularly preferably less than 1 part by mass, with respect to 100 parts by mass of cellulose acylate.

The disc-shaped compound, when compared to the stick-shaped compound, is more excellent in the developing properties of retardation in the direction of film thickness (Rth retardation) and therefore preferably used in the case where particularly large Rth retardation is required. Two or more kinds of retardation-developing agents may be used in combination.

The retardation-developing agent preferably has a maximum absorption wavelength in the wavelength region of from 250 to 400 nm, and preferably it has substantially no absorption in the visible region.

The details of the retardation-developing agent are described on page 49 of Journal of Technical Disclosure 2001-1745.

### (Plasticizer (Hydrophobing Agent))

The cellulose acylate film of the present invention preferably contains, as a plasticizer (hydrophobing agent), at least one compound selected from the group consisting of a polyvalent ester compound of a polyvalent alcohol (hereinafter, also referred to as a polyvalent alcohol ester plasticizer), a polycondensation ester compound (hereinafter, also referred to as a polycondensation ester plasticizer) and a carbohydrate compound (hereinafter, also referred to as a carbohydrate derivative plasticizer).

It is preferable that the plasticizer is able to reduce moisture content in the cellulose acylate film while minimizing reduction in glass transition temperature (Tg) of the cellulose acylate film. When these plasticizers are used, they make it possible to suppress diffusion of additives in the cellulose acylate film to a polarizer layer under the hygrothermal conditions, whereby deterioration of polarizer properties can be improved.

Hereinafter, plasticizers used in the present invention are described in detail.

### (Polyvalent Alcohol Ester Plasticizer)

A polyvalent alcohol that is a synthetic raw material for a polyvalent alcohol ester plasticizer used in the present invention is represented by the following Formula (c).

Rα-(OH)m Formula (c)

In Formula (c), Rα represents a m-valent organic group, and m represents a positive integer of 2 or more.

Among polyvalent alcohol ester plasticizers represented by the above-described Formula (c), adonitol, arabitol, ethyleneglycol, diethyleneglycol, triethyleneglycol, tetraethyleneglycol, 1,2-propanediol, 1,3-propanediol, dipropyleneglycol, tripropyleneglycol, 1,2-butanediol, 1,3-butanediol, 1,4-butanediol, dibutyleneglycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, or xylitol, is preferably used as a raw material. Of these, triethyleneglycol, tetraethyleneglycol, dipropyleneglycol, tripropyleneglycol, sorbitol, trimethylolpropane, or xylitol are more preferred.

As the polyvalent alcohol ester plasticizer, polyvalent alcohol esters synthesized from a polyvalent alcohol having 5 or more carbon atoms, preferably a polyvalent alcohol having 5 to 20 carbon atoms and a monocarboxylic acid are preferable.

The monocarboxylic acid used for synthesis of the polyvalent alcohol ester plasticizer is not particularly limited, and it includes an aliphatic monocarboxylic acid, alicyclic monocarboxylic acid, aromatic monocarboxylic acid and the like. When the alicyclic monocarboxylic acid or the aromatic monocarboxylic acid is used, it is preferable from the viewpoint of improving water-vapor transmission properties and reservation properties.

As for the monocarboxylic acid, the following compounds are exemplified. However, the present invention is not limited thereto.

As for the aliphatic monocarboxylic acid, preferred are linear fatty acids or branched fatty acids, each of which has 1 to 32 carbon atoms. The number of carbon atom thereof is more preferably from 1 to 20, and particularly preferably from 1 to 10. Incorporation of acetic acid is preferable because compatibility with a cellulose derivative is increased. It is also preferable that acetic acid and another monocarboxylic acid are mixed to use them.

The aliphatic monocarboxylic acid is preferably at least one saturated fatty acid selected from acetic acid, propionic acid, butyric acid, valeric acid, caproic acid, enanthic acid, caprylic acid, pelargonic acid, capric acid, 2-ethylhexane carboxylic acid, undecylic acid, lauric acid, tridecylic acid, myristic acid, pentadecylic acid, palmitic acid, heptadecylic acid, stearic acid, nonadecanoic acid, arachidic acid, behenic acid, lignoceric acid, cerotic acid, heptacosanic acid, montanoic acid, melissic acid and lacceric acid; or at least one unsaturated fatty acid selected from undecylenic acid, oleic acid, sorbic acid, linoleic acid, linolenic acid and arachidonic acid.

The alicyclic monocarboxylic acid is preferably at least one selected from cyclopentane carboxylic acid, cyclohexane carboxylic acid, cyclooctane carboxylic acid, and their derivatives.

The aromatic monocarboxylic acid is preferably at least one selected from monocarboxylic acids, in which an alkyl group is introduced into the benzene ring of benzoic acid, such as benzoic acid and toluic acid, aromatic monocarboxylic acids having two or more benzene rings, such as biphenyl carboxylic acid, naphthalene carboxylic acid and tetralin carboxylic acid, and their derivatives. Especially, benzoic acid is preferred.

Although the molecular weight of the polyvalent alcohol ester plasticizer is not particularly limited, the molecular weight is preferably from 300 to 3,000, and more preferably from 350 to 1,500. Setting the molecular weight to be within the above range, the suppressing property of volatilization from the film is excellent and moisture-vapor permeability and compatibility with cellulose derivatives are improved.

The carboxylic acid used for synthesis of the polyvalent alcohol ester may be one kind or a mixture of two or more kinds thereof. Further, the hydroxy group of the polyvalent alcohol may be entirely esterified, or a part of the hydroxy groups may be remained without esterification.

Hereinafter, specific examples of the polyvalent alcohol ester plasticizer are shown. However, the present invention is not limited thereto.

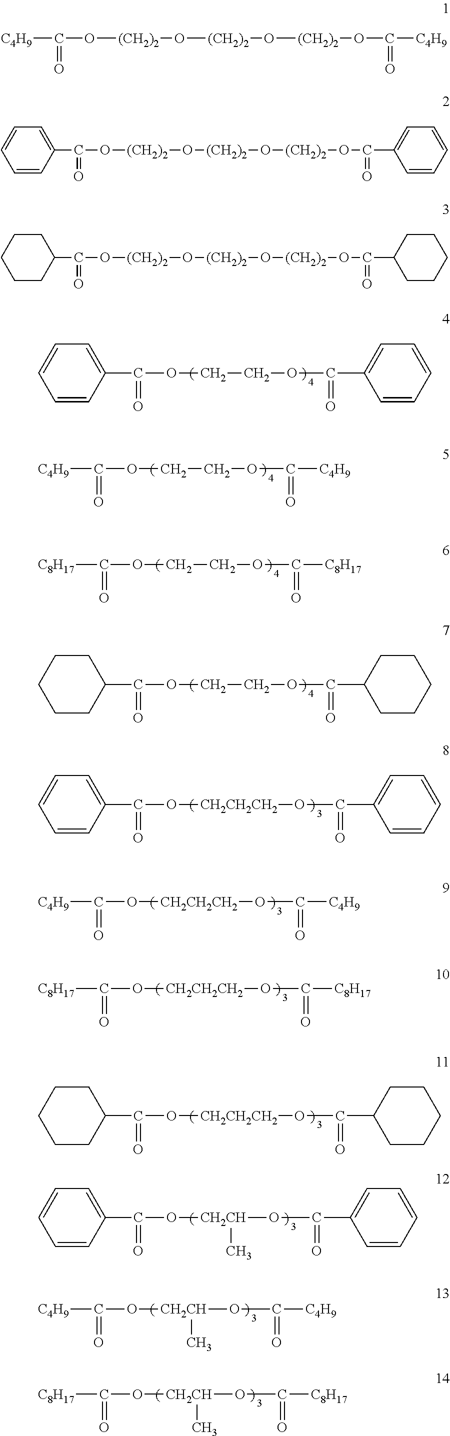

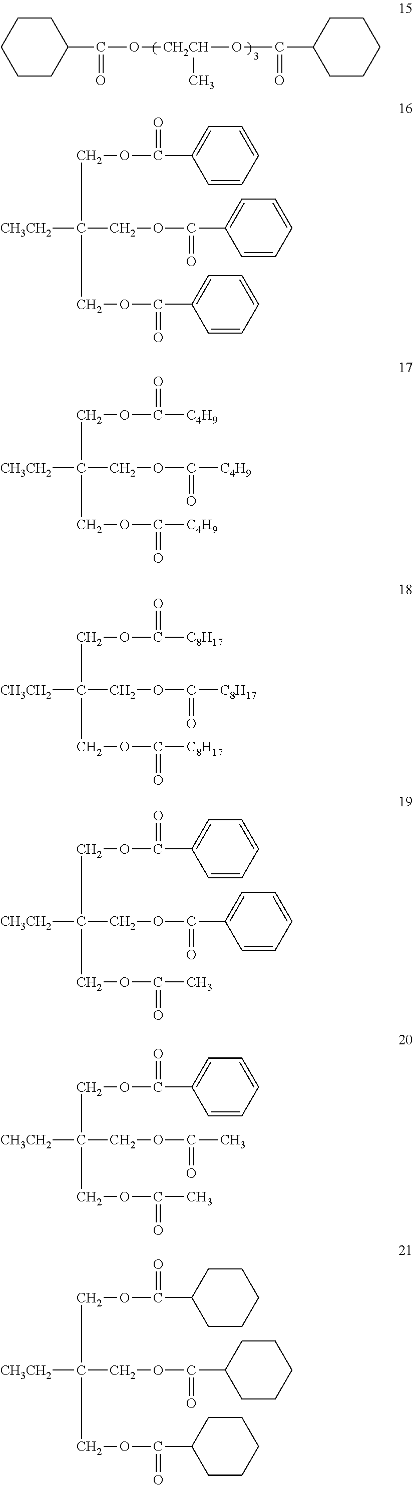

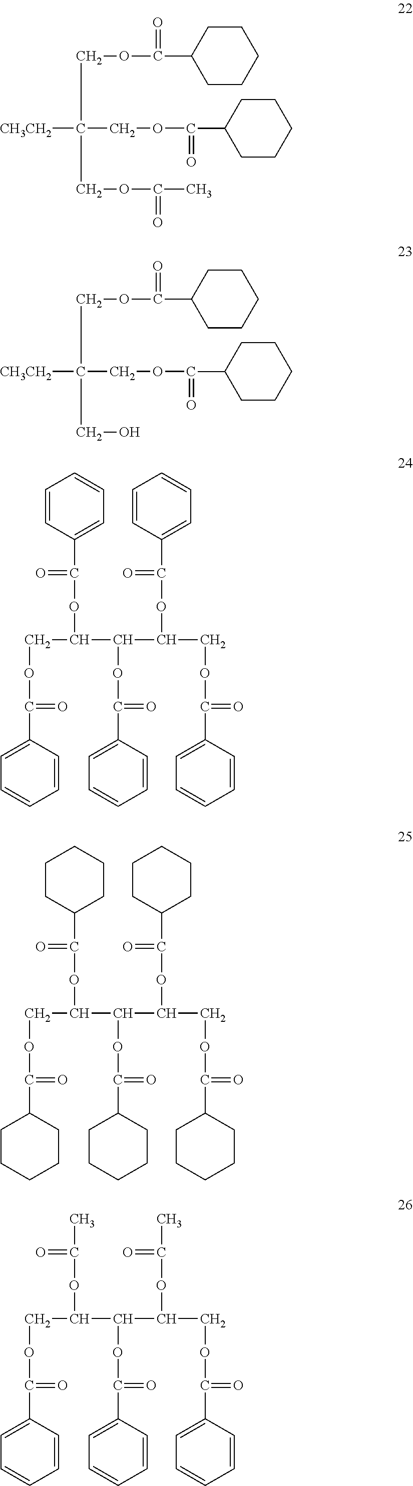

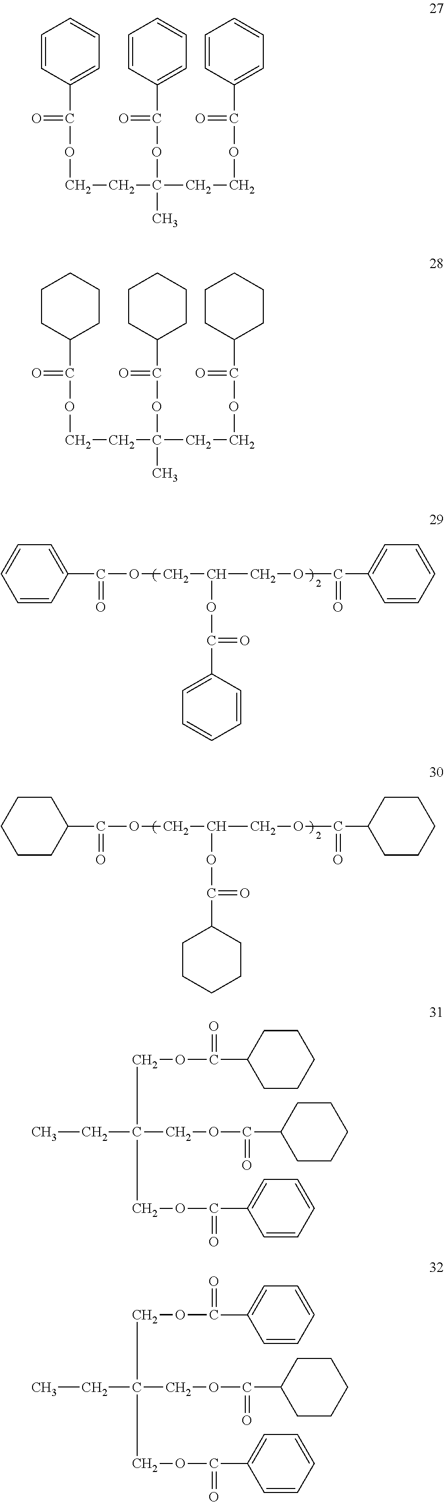

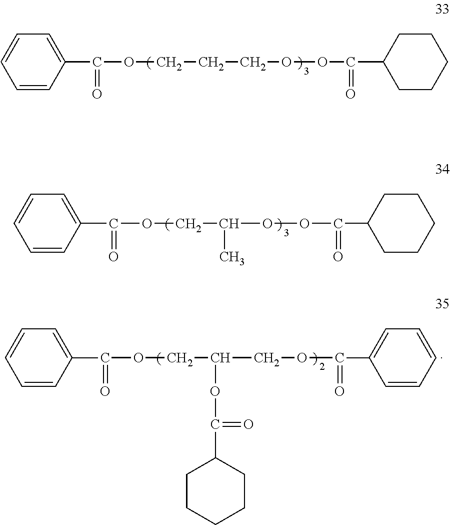

### (Polycondensation Ester Plasticizer)

The cellulose acylate film of the present invention preferably contains a polycondensation ester compound, and a polycondensation ester plasticizer is preferable as the polycondensation ester compound. By incorporating therein the polycondensation ester plasticizer, it is possible to obtain a cellulose ester film excellent in humidity stability and a polarizing plate excellent in durability.

The polycondensation ester plasticizer can be obtained by bringing at least one dicarboxylic acid represented by the following Formula (a) and at least one diol represented by the following Formula (b) into polycondensation.

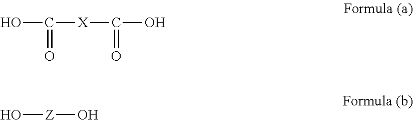

In Formulae (a) and (b), X represents a divalent aliphatic group having 2 to 18 carbon atoms or a divalent aromatic group having 6 to 18 carbon atoms, and Z represents a divalent aliphatic group having 2 to 8 carbon atoms.

Herein, the divalent aliphatic group having 2 to 18 carbon atoms in X may be either saturated or unsaturated, and may be either a divalent chain or a divalent cyclic aliphatic group (for example, cycloalkylene group and the like). Further, in the case of the divalent chain aliphatic group, it may be straight chain or branch. The carbon number of the divalent aliphatic group is more preferably from 2 to 12, and still more preferably from 2 to 6. Among these, the divalent aliphatic group having 2 to 18 carbon atoms is preferably a divalent chain and saturated aliphatic group, more preferably a chain alkylene group, and still more preferably a straight chain alkylene group. Examples of the chain aliphatic group having 2 to 18 carbon atoms include ethylene, trimethylene, tetramethylene, pentamethylene, hexamethylene, heptamethylene, octamethylene, decamethylene, dodecamethylene, propylene, 2-methyltrimethylene, 2,2-dimethyltrimethylene, cyclopentylene, and cyclohexylene.

The divalent aromatic group having 6 to 18 carbon atoms in X may be either a divalent aromatic hydrocarbon group, or a divalent aromatic heterocyclic group. The carbon number of the divalent aromatic group is preferably from 6 to 15, and still more preferably from 6 to 12. The aromatic ring of the divalent aromatic hydrocarbon group is preferably a benzene ring, a naphthalene ring, an anthracene ring, a biphenyl ring, or a terphenyl ring. Of these, a benzene ring, a naphthalene ring, or a biphenyl ring is more preferable. The aromatic heterocyclic group of the divalent aromatic heterocyclic group preferably contains at least one selected from the group consisting of an oxygen atom, a nitrogen atom and a sulfur atom as a ring-forming atom. The aromatic heterocycle is preferably a furan ring, a pyrrole ring, a thiophen ring, an imidazole ring, a pyrazole ring, a pyridine ring, a pyrazine ring, a pyridazine ring, a triazole ring, a triazine ring, an indole ring, an indazole ring, a purine ring, a thiazoline ring, a thiadiazole ring, an oxazoline ring, an oxazole ring, an oxadiazole ring, a quinoline ring, an isoquinoline ring, a phthalazine ring, a naphthyridine ring, a quinoxaline ring, a quinazoline ring, a cinnoline ring, a pteridine ring, an acridine ring, a phenanthroline ring, a phenazine ring, a tetrazole ring, a benzimidazole ring, a benzoxazole ring, a benzthiazole ring, a benzotriazole ring and a tetrazaindene ring. Among these, a pyridine ring, a triazine ring and a quinoline ring are preferable.

Z represents a divalent aliphatic group having 2 to 8 carbon atoms. The divalent aliphatic group having 2 to 8 carbon atoms may be either saturated or unsaturated, and may be either a divalent chain or a divalent cyclic aliphatic group (for example, cycloalkylene group and the like). Further, in the case of the divalent chain aliphatic group, it may be a divalent straight chain or branch. The carbon number of the divalent aliphatic group is more preferably from 2 to 6, and still more preferably from 2 to 4. Among these, the divalent aliphatic group having 2 to 8 carbon atoms is preferably a divalent chain and saturated aliphatic group, more preferably a chain alkylene group, and still more preferably a straight chain alkylene group. Examples of the chain alkylene group having 5 to 10 carbon atoms include ethylene, trimethylene, tetramethylene, pentamethylene, hexamethylene, heptamethylene, octamethylene, decamethylene, propylene, 2-methyltrimethylene, 2,2-dimethyl trimethylene.

Note that, examples of the divalent cycloalkylene group include cyclopentylene and cyclohexylene.

The aliphatic diol represented by Formula (b) is more preferably at least one selected from ethyleneglycol, 1,2-propanediol and 1,3-propanediol. From the viewpoint of preventing crystallization of the polycondensation ester plasticizer, at least one selected from ethyleneglycol and 1,2-propanediol is particularly preferable.

The ethylene glycol residue is preferably contained in the percentage of from 10 to 100% by mole, and more preferably from 20 to 100% by mole with respect to the aliphatic diol residue contained in the polycondensation ester plasticizer.

The polycondensation ester plasticizer is preferably a compound obtained from at least one dicarboxylic acid in which X is the above-described divalent aromatic group (also referred to as an aromatic dicarboxylic acid) and at least one diol in which Z is the above-described aliphatic group (also referred to as an aliphatic diol). The average carbon number of the aliphatic diol to be used is preferably from 2.5 to 8.0. Further, a polycondensation ester plasticizer obtained from a mixture of at least one aromatic dicarboxylic acid and at least one dicarboxylic acid in which X is the above-described divalent aliphatic group (also referred to as an aliphatic dicarboxylic acid), and at least one aliphatic diol having the average carbon number of 2.5 to 8.0 is also preferable.

In the description of polycondensation ester plasticizer, the average carbon number of the dicarboxylic acid or the dicarboxylic acid residue is a value obtained by dividing the total number of carbons which all dicarboxylic acids to be used or all dicarboxylic acid residues in the polycondensation ester plasticizer have, by the mole number of the dicarboxylic acids to be used, or the mole number of the dicarboxylic acid residues in the polycondensation ester plasticizer. For example, in the case where the mixture is composed of an adipic acid residue and a phthalic acid residue in the proportion of each of 50 mol % in the whole dicarboxylic acid residue, the average carbon number of dicarboxylic acid residue is 7.0. The average carbon number of diol or diol residue is also calculated in the same manner. For example, in the case where the diol residue is composed of 50 mol % ethylene glycol residue and 50 moil % 1,2-propanediol residue, the average carbon number of diol residue is 2.5.

The number average molecular weight (Mn) of the polycondensation ester plasticizer is preferably from 500 to 2,000 more preferably from 600 to 1,500, and still more preferably from 700 to 1,200. When the number average molecular weight of the polycondensation ester is 500 or more, volatility becomes lower so that a film failure and process contamination due to sublimation under the high temperature condition during stretching of the cellulose ester film can be suppressed.

Further, when the number average molecular weight of the polycondensation ester plasticizer is 2,000 or less, compatibility with a cellulose ester becomes higher so that the bleedout during film production and heat stretching can be suppressed.

The number average molecular weight of the polycondensation ester plasticizer can be measured and evaluated by gel permeation chromatography. Further, in the case of a polyesterpolyol whose terminal is not sealed, the number average molecular weight thereof can also be calculated from an amount of the hydroxy group per mass (hereinafter, also referred to as “a hydroxy value”). The hydroxy value in the present specification is obtained by acetylating the polyesterpolyol and then measuring an amount (mg) of potassium hydroxide necessary for neutralizing excessive acetic acid.

In the case where a mixture of an aromatic dicarboxylic acid and an aliphatic dicarboxylic acid is used as the dicarboxylic acid component, an average carbon number of the dicarboxylic acid component is preferably from 5.5 to 10.0, and more preferably from 5.6 to 8.

When the average carbon number of the dicarboxylic acid is set to 5.5 or more, a polarizing plate having more excellent durability can be obtained. Further, when the average carbon number of the dicarboxylic acid is set to 10.0 or less, the compatibility with the cellulose ester is more excellent so that the bleedout during film production process of the cellulose ester film can be suppressed.

The polycondensation ester obtained by using an aromatic dicarboxylic acid includes an aromatic dicarboxylic acid residue.

A ratio of the aromatic dicarboxylic acid residue with respect to the dicarboxylic acid residue of the polycondensation ester plasticizer used in the present invention is preferably 40 mol % or more, and more preferably from 40 to 100 mol %.

When the ratio of the aromatic dicarboxylic acid residue in the dicarboxylic acid residue is 40 mol % or more, a cellulose acylate film having a sufficient optical anisotropy is obtained, and a polarizing plate excellent in durability can be obtained. Also, when the ratio of the aromatic dicarboxylic acid residue in the dicarboxylic acid residue is from 40 to 100 mol %, compatibility with the cellulose acylate becomes excellent, and this makes it possible to hardly cause the bleedout during film production and even during heat stretching of the cellulose ester film.

The dicarboxylic acid residue means a partial structure of the polycondensation ester. For example, a dicarboxylic acid residue which is formed from a dicarboxylic acid of HOC(═O)—X—CO₂H is —C(═O)—X—C(═O)—.

The aromatic dicarboxylic acid which can be used for the synthesis of the polycondensation ester plasticizer is preferably at least one selected from phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid and 2,6-naphthalenedicarboxylic acid. Of these aromatic dicarboxylic acids, at least one selected from phthalic acid, terephthalic acid and 2,6-naphthalenedicarboxylic acid is preferred, and at least one selected from phthalic acid and terephthalic acid is still more preferred.

The polycondensation ester obtained by using an aliphatic dicarboxylic acid contains an aliphatic dicarboxylic acid residue.

The aliphatic dicarboxylic acid which is used for synthesis of the polycondensation ester plasticizer is preferably at least one selected from oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

An average carbon number of the aliphatic dicarboxylic acid residue is preferably 5.5 to 10.0, more preferably from 5.5 to 8.0, and still more preferably from 5.5 to 7.0. When the average carbon number of the aliphatic dicarboxylic acid residue is 10.0 or less, a loss on heating of the compound can be reduced whereby the occurrence of surface state failure which is considered to be caused by process contamination due to the bleedout during drying process of a cellulose acylate web can be prevented. Also, when the average carbon number of the aliphatic dicarboxylic acid residue is 5.5 or more, it is preferable because compatibility is excellent and deposition of the polycondensation ester plasticizer hardly occurs.

Specifically, the aliphatic dicarboxylic residue in the polycondensation ester plasticizer preferably contains a succinic acid residue. Further, in the case of using two kinds of aliphatic dicarboxylic residues in the polycondensation ester plasticizer, the aliphatic dicarboxylic residue preferably contains a succinic acid residue and an adipic acid residue.

The polycondensation ester plasticizer includes a diol residue.

In the present specification, the diol residue which is formed from the diol compound represented by Formula (b) (HO—Z—OH) is —O—Z—O—.

The polycondensation ester plasticizer preferably contains an aliphatic diol residue having an average carbon number from 2.0 to 7.0, and more preferably contains an aliphatic diol residue having an average carbon number from 2.0 to 4.0.

When the average carbon number of the aliphatic diol residue is 7.0 or less, compatibility with a cellulose acylate is improved, the bleedout hardly occurs, the loss on heating of the compound hardly increases, and occurrence of surface state failure which is considered to be caused by process contamination during drying process of a cellulose acylate web can be suppressed. Also, when the average carbon number of the aliphatic diol residue is 2.0 or more, the synthesis is easy. In the aliphatic diol residue in the polycondensation ester plasticizer, specifically, ethanediol, propanediol and cyclohexanedimethanol are preferably contained.

The terminal of the polycondensation ester plasticizer may be the diol or the carboxylic acid as it is without being sealed (that is, the terminal of the polymer chain is —OH or —CO₂H), or the so-called terminal sealing may be conducted upon further reaction of monocarboxylic acids and —OH terminal or monoalcohols and —CO₂H terminal. When the terminal of the polycondensation ester plasticizer is sealed, it is possible to obtain an effect that the state at an ordinary temperature is hardly changed to a solid form, which results in good handling. Further, a cellulose ester film having excellent humidity stability and capable of giving a durability of a polarizing plate can be obtained.

The monocarboxylic acids which are used for the sealing is preferably at least one selected from acetic acid, propionic acid, butanoic acid, and benzoic acid. The monoalcohols which are used for the sealing is preferably at least one selected from methanol, ethanol, propanol, isopropanol, butanol, and isobutanol, and most preferably methanol. When the carbon number of the monocarboxylic acids which are used at the terminal of the polycondensation ester is 7 or less, the loss on heating of the compound becomes low, and occurrence of the surface state failure is well suppressed.

In the following Table 1, the specific examples J-1 to J-44 of the polycondensation ester plasticizer are described, but the present invention is not limited thereto.

TABLE 1

| | Dicarboxylic acid | | | Diol | | | |
|---|---|---|---|---|---|---|---|
| | Aromatic | Aliphatic | Molar ratio of | | | Ratio of | |
| | dicarboxylic | dicarboxylic | dicarboxylic acids | | | diols | |
| No. | acid | acid | (mol %) | Diol 1 | Diol 2 | (mol %) | Terminal |
| J-1 | TPA | SA | 45/55 | Ethanediol | Propanediol | 45/55 | Acetyl ester group |
| J-2 | TPA | SA | 50/50 | Ethanediol | Propanediol | 45/55 | Acetyl ester group |
| J-3 | TPA | SA | 55/45 | Ethanediol | Propanediol | 45/55 | Acetyl ester group |
| J-4 | TPA | SA | 65/35 | Ethanediol | Propanediol | 45/55 | Acetyl ester group |
| J-5 | TPA | SA | 55/45 | Ethanediol | Propanediol | 25/75 | Acetyl ester group |
| J-6 | TPA | SA | 55/45 | Ethanediol | Propanediol | 10/90 | Acetyl ester group |
| J-7 | 2,6-NPA | SA | 50/50 | Ethanediol | Propanediol | 25/75 | Acetyl ester group |
| J-8 | 2,6-NPA | SA | 50/50 | Ethanediol | Propanediol | 45/55 | Acetyl ester group |
| J-9 | TPA/PA | SA | 45/5/50 | Ethanediol | Propanediol | 45/55 | Acetyl ester group |
| J-10 | TPA/PA | SA | 40/10/50 | Ethanediol | Propanediol | 45/55 | Acetyl ester group |
| J-11 | TPA | SA/AA | 50/30/20 | Ethanediol | Propanediol | 45/55 | Acetyl ester group |
| J-12 | TPA | SA/AA | 50/20/30 | Ethanediol | Propanediol | 45/55 | Acetyl ester group |
| J-13 | TPA | SA | 50/50 | Ethanediol | Propanediol | 25/75 | Acetyl ester group |
| J-14 | TPA | SA | 80/20 | Ethanediol | Propanediol | 45/55 | Acetyl ester group |
| J-15 | TPA | SA | 55/45 | Ethanediol | Cyclohexanedi- | 45/55 | Acetyl ester group |
| | | | | | methanol | | |
| J-16 | TPA | SA | 45/55 | Ethanediol | Propanediol | 45/55 | Hydroxy group |
| J-17 | TPA | SA | 50/50 | Ethanediol | Propanediol | 45/55 | Hydroxy group |
| J-18 | TPA | SA | 55/45 | Ethanediol | Propanediol | 45/55 | Hydroxy group |
| J-19 | TPA | SA | 65/35 | Ethanediol | Propanediol | 45/55 | Hydroxy group |
| J-20 | TPA | SA | 55/45 | Ethanediol | Propanediol | 25/75 | Hydroxy group |
| J-21 | TPA | SA | 55/45 | Ethanediol | Propanediol | 10/90 | Hydroxy group |
| J-22 | 2,6-NPA | SA | 50/50 | Ethanediol | Propanediol | 25/75 | Hydroxy group |
| J-23 | 2,6-NPA | SA | 50/50 | Ethanediol | Propanediol | 45/55 | Hydroxy group |
| J-24 | 2,6-NPA | SA | 45/5/50 | Ethanediol | Propanediol | 25/75 | Hydroxy group |
| J-25 | 2,6-NPA | SA | 40/10/50 | Ethanediol | Propanediol | 25/75 | Hydroxy group |
| J-26 | TPA | SA/AA | 50/30/20 | Ethanediol | Propanediol | 25/75 | Hydroxy group |
| J-27 | TPA | SA/AA | 50/20/30 | Ethanediol | Propanediol | 25/75 | Hydroxy group |
| J-28 | TPA | SA | 50/50 | Ethanediol | Propanediol | 25/75 | Hydroxy group |
| J-29 | TPA | SA | 80/20 | Ethanediol | Propanediol | 25/75 | Hydroxy group |
| J-30 | TPA | SA | 55/45 | Ethanediol | Cyclohexanedi- | 25/75 | Hydroxy group |
| | | | | | methanol | | |
| J-31 | TPA | SA | 55/45 | Ethanediol | Propanediol | 45/55 | Propionyl ester group |
| J-32 | TPA | — | 100/0 | Ethanediol | Propanediol | 50/50 | Hydroxy group |
| J-33 | TPA | — | 100/0 | Ethanediol | Propanediol | 40/60 | Acetyl ester group |
| J-34 | TPA | SA | 50/50 | Ethanediol | Propanediol | 45/55 | Benzoyl ester group |
| J-35 | TPA | SA | 55/45 | Ethanediol | Propanediol | 50/50 | Hydroxy group |
| J-36 | TPA | SA | 55/45 | Ethanediol | Propanediol | 50/50 | Hydroxy group |
| J-37 | TPA | SA | 80/20 | Ethanediol | Propanediol | 50/50 | Hydroxy group |
| J-38 | TPA | SA | 80/20 | Ethanediol | Propanediol | 50/50 | Acetyl ester group |
| J-39 | TPA | AA | 10/90 | Ethanediol | — | 100/0 | Acetyl ester group |
| J-40 | PA | AA | 25/75 | Ethanediol | — | 100/0 | Acetyl ester group |
| J-41 | PA | AA | 50/50 | Ethanediol | — | 100/0 | Acetyl ester group |
| J-42 | PA | — | 100/0 | Ethanediol | — | 100/0 | Acetyl ester group |
| J-43 | — | AA | 0/100 | Ethanediol | Propanediol | 70/30 | Acetyl ester group |
| J-44 | — | AA | 0/100 | Ethanediol | Propanediol | 50/50 | Acetyl ester group |

Herein, with respect to the abbreviations shown in the above-described Table 1, PA represents phthalic acid, TPA represents terephthalic acid, AA represents adipic acid, SA represents succinic acid, and 2,6-NPA represents 2,6-naphthalene dicarboxylic acid, respectively.

The polycondensation ester plasticizer can be synthesized with ease according to any conventional method, for example, a thermal fusing condensation method according to a polyesterification, interesterification of a dicarboxylic acid and a diol, or an interfacial condensation method of an acid chloride of their acid and glycols. Polycondensation esters are described in detail in Koichi Murai, “Plasticizers and their Theory and Applications” (by Miyuki Shobo, 1st Ed., issued on Mar. 1, 1973), and they can be used.

In this invention, as a polycondensation ester plasticizer, also usable herein are compounds described in JP-A-5-155809, JP-A-5-155810, JP-A-5-197073, JP-A-2006-259494, JP-A-7-330670, JP-A-2006-342227 and JP-A-2007-003679.

### (Carbohydrate Derivative Plasticizer)

Further, the cellulose acylate film of the present invention preferably contains a carbohydrate derivative plasticizer. Incorporating therein the carbohydrate derivative plasticizer enables achievement of an effect that a cellulose acylate film having excellent humidity stability and capable of giving a durability of a polarizing plate can be obtained.

As the carbohydrate derivative plasticizer, derivatives of carbohydrates including monosaccharides or from 2 to 10 monosaccharide units are preferred.

The monosaccharide or polysaccharide by which the carbohydrate derivative plasticizer is preferably composed is characterized in that a part of or the entire substitutable groups which are contained in the molecule thereof (for example, a hydroxy group, a carboxyl group, an amino group, and a mercapto group) are substituted by a substituent. Examples of the substituent which the carbohydrate derivative plasticizer may have include an alkyl group, an aryl group, and an acyl group, and these groups are described in detail below. Further, an ether structure formed by a hydroxy group substituted with an alkyl group or an aryl group, an ester structure formed by a hydroxy group substituted with an acyl group, and an amide structure or an imide structure formed by substitution with an amino group are exemplified.

Examples of the carbohydrates including the monosaccharides or from 2 to 10 monosaccharide units preferably include erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, belbalcose, maltohexaose, α-cyclodextrin, β-cyclodextrin, γ-cyclodextrin, δ-cyclodextrin, xylitol, and sorbitol.

Among these, ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, and sorbitol are preferred. Further, arabinose, xylose, glucose, fructose, mannose, galactose, maltose, cellobiose, sucrose, β-cyclodextrin, and γ-cyclodextrin are more preferred, and xylose, glucose, fructose, mannose, galactose, maltose, cellobiose, sucrose, xylitol, and sorbitol are particularly preferred.

Examples of the substituents which the carbohydrate derivative plasticizer has, preferably include an alkyl group (preferably an alkyl group having 1 to 22 carbon atoms, more preferably 1 to 12 carbon atoms, and particularly preferably 1 to 8 carbon atoms, for example, methyl, ethyl, propyl, hydroxyethyl, hydroxypropyl, 2-cyanoethyl and benzyl), an aryl group (preferably an aryl group having 6 to 24 carbon atoms, more preferably 6 to 18 carbon atoms, and particularly preferably 6 to 12 carbon atoms, for example, phenyl and naphthyl), and an acyl group (including an alkylcarbonyl group, an arylcarbonyl group, and a heterocycle carbonyl group, preferably an acyl group having 1 to 22 carbon atoms, more preferably 2 to 12 carbon atoms, and particularly preferably 2 to 8 carbon atoms, for example, acetyl, propionyl, butyryl, pentanoyl, hexanoyl, octanoyl, benzoyl, toluyl, phthalyl and naphthoyl). Further, preferable examples of the structure formed by substitution with an amino group include an amido structure (preferably an amide having 1 to 22 carbon atoms, more preferably 2 to 12 carbon atoms, and particularly preferably 2 to 8 carbon atoms, for example, formamide, acetamide and the like), and an imido structure (preferably an imide having 4 to 22 carbon atoms, more preferably 4 to 12 carbon atoms, and particularly preferably 4 to 8 carbon atoms, for example succinimide and phthalimide).

As the substituents which the carbohydrate derivative plasticizer has, at least one selected from an alkyl group, an aryl group and an acyl group is more preferable, and an acyl group is still more preferable.

Preferable examples of the carbohydrate derivative plasticizer include the followings. However, the present invention is not limited thereto.

At least one selected from xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, sorbitol hexapropionate, xylose tetrabutyrate, glucose pentabutyrate, fructose pentabutyrate, mannose pentabutyrate, galactose pentabutyrate, maltose octabutyrate, cellobiose octabutyrate, sucrose octabutyrate, xylitol pentabutyrate, sorbitol hexabutyrate, xylose tetrabenzoate, glucose pentabenzoate, fructose pentabenzoate, mannose pentabenzoate, galactose pentabenzoate, maltose octabenzoate, cellobiose octabenzoate, sucrose octabenzoate, xylitol pentabenzoate, and sorbitol hexabenzoate.

Among these, at least one selected from xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, sorbitol hexapropionate, xylose tetrabenzoate, glucose pentabenzoate, fructose pentabenzoate, mannose pentabenzoate, galactose pentabenzoate, maltose octabenzoate, cellobiose octabenzoate, sucrose octabenzoate, xylitol pentabenzoate, and sorbitol hexabenzoate is more preferred.

Especially, at least one selected from maltose octaacetate, cellobiose octaacetate, sucrose octaacetate, xylose tetrapropionate, glucose pentapropionate, fructose pentapropionate, mannose pentapropionate, galactose pentapropionate, maltose octapropionate, cellobiose octapropionate, sucrose octapropionate, xylose tetrabenzoate, glucose pentabenzoate, fructose pentabenzoate, mannose pentabenzoate, galactose pentabenzoate, maltose octabenzoate, cellobiose octabenzoate, sucrose octabenzoate, xylitol pentabenzoate, and sorbitol hexabenzoate is still more preferred.

The carbohydrate derivative plasticizer preferably has a pyranose structure or a furanose structure.

Of the carbohydrate derivative plasticizer used in the present invention, the following compounds are particularly preferred. However, the carbohydrate derivative plasticizer which can be used in the present invention is not limited to these compounds.

In the following structure, each of Rs independently represents an arbitrary substituent. A plurality of Rs may be the same or different from one another.

In the following Tables 2 to 5, for example, in Table 2, the carbohydrate derivative plasticizers having eight hydroxy groups (each of Rs is a hydrogen atom) are acylated with 2 kinds of acylating agents. One of the Rs introduced by the 2 kinds of acylating agents is indicated as “Substituent 1”, while another of the Rs is indicated as “Substituent 2”. The substitution degree represents the number of either of these substituents in the total eight hydroxy groups.

Total number of Rs is 5 in Table 3 and 8 in Tables 4 and 5. Herein, the term “phenylacetyl” means —C(═O)—CH₂—C₆H₅.

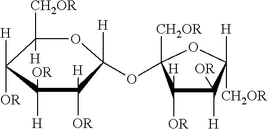

TABLE 2

| | Substituent 1 | | Substituent 2 | | |
|---|---|---|---|---|---|
| | | Substi- | | Substi- | |
| | | tution | | tution | Molecular |
| Compound | Kind | degree | Kind | degree | weight |
| K-101 | Acetyl | 7 | Benzyl | 1 | 727 |
| K-102 | Acetyl | 6 | Benzyl | 2 | 775 |
| K-103 | Acetyl | 7 | Benzoyl | 1 | 741 |
| K-104 | Acetyl | 6 | Benzoyl | 2 | 802 |
| K-105 | Benzyl | 2 | None | 0 | 523 |
| K-106 | Benzyl | 3 | None | 0 | 613 |
| K-107 | Benzyl | 4 | None | 0 | 702 |
| K-108 | Acetyl | 7 | Phenylacetyl | 1 | 771 |
| K-109 | Acetyl | 6 | Phenylacetyl | 2 | 847 |
| K-110 | Benzoyl | 1 | None | 0 | 446 |
| K-111 | Benzoyl | 2 | None | 0 | 551 |
| K-112 | Benzoyl | 3 | None | 0 | 655 |
| K-113 | Benzoyl | 4 | None | 0 | 759 |
| K-114 | Benzoyl | 5 | None | 0 | 863 |
| K-115 | Benzoyl | 6 | None | 0 | 967 |
| K-116 | Benzoyl | 7 | None | 0 | 1071 |
| K-117 | Benzoyl | 8 | None | 0 | 1175 |

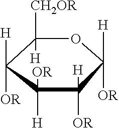

TABLE 3

| | Substituent 1 | | Substituent 2 | | |
|---|---|---|---|---|---|
| | | Substi- | | Substi- | |
| | | tution | | tution | Molecular |
| Compound | Kind | degree | Kind | degree | weight |
| K-201 | Acetyl | 4 | Benzoyl | 1 | 468 |
| K-202 | Acetyl | 3 | Benzoyl | 2 | 514 |
| K-203 | Acetyl | 2 | Benzoyl | 3 | 577 |
| K-204 | Acetyl | 4 | Benzyl | 1 | 454 |
| K-205 | Acetyl | 3 | Benzyl | 2 | 489 |
| K-206 | Acetyl | 2 | Benzyl | 3 | 535 |
| K-207 | Acetyl | 4 | Phenylacetyl | 1 | 466 |
| K-208 | Acetyl | 3 | Phenylacetyl | 2 | 543 |
| K-209 | Acetyl | 2 | Phenylacetyl | 3 | 619 |
| K-210 | Phenylacetyl | 1 | None | 0 | 298 |
| K-211 | Phenylacetyl | 2 | None | 0 | 416 |
| K-212 | Phenylacetyl | 3 | None | 0 | 535 |
| K-213 | Phenylacetyl | 4 | None | 0 | 654 |
| K-214 | Acetyl | 1 | Benzoyl | 4 | 639 |
| K-215 | Acetyl | 0 | Benzoyl | 5 | 701 |

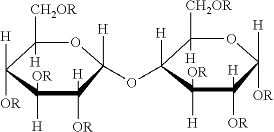

TABLE 4

| | Substituent 1 | | Substituent 2 | | |
|---|---|---|---|---|---|
| | | Substi- | | Substi- | |
| | | tution | | tution | Molecular |
| Compound | Kind | degree | Kind | degree | weight |
| K-301 | Acetyl | 6 | Benzoyl | 2 | 803 |
| K-302 | Acetyl | 6 | Benzyl | 2 | 775 |
| K-303 | Acetyl | 6 | Phenylacetyl | 2 | 831 |
| K-304 | Benzoyl | 2 | None | 0 | 551 |
| K-305 | Benzyl | 2 | None | 0 | 522 |
| K-306 | Phenylacetyl | 2 | None | 0 | 579 |

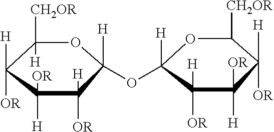

TABLE 5

| | Substituent 1 | | Substituent 2 | | |
|---|---|---|---|---|---|
| | | Substi- | | Substi- | |
| | | tution | | tution | Molecular |
| Compound | Kind | degree | Kind | degree | weight |
| K-401 | Acetyl | 6 | Benzoyl | 2 | 803 |
| K-402 | Acetyl | 6 | Benzyl | 2 | 775 |
| K-403 | Acetyl | 6 | Phenylacetyl | 2 | 831 |
| K-404 | Benzoyl | 2 | None | 0 | 551 |
| K-405 | Benzyl | 2 | None | 0 | 523 |
| K-406 | Phenyl ester | 2 | None | 0 | 579 |

The carbohydrate derivative plasticizer is available as a marketed product from Tokyo Chemical Industry Co., Ltd., Sigma-Aldrich Corporation and the like. Alternatively, the carbohydrate derivative plasticizer can be synthesized by subjecting a commercially available carbohydrate to an esterification reaction (for example, a method described in JP-A-8-245678).

The content of the plasticizer in the cellulose acylate film of the present invention is preferably from 1 to 20 parts by mass with respect to 100 parts by mass of the cellulose acylate. By adjusting the content of the plasticizer with respect to 100 parts by mass of the cellulose acylate to 1 part by mass or more, an effect of improvement in a durability of a polarizing plate can be easily achieved. While, on the other hand, by adjusting the content to 20 parts by mass or less, the generation of bleedout is suppressed. The content of the plasticizer in the cellulose acylate film is more preferably from 2 to 15 parts by mass, and particularly preferably from 5 to 15 parts by mass with respect to 100 parts by mass of the cellulose acylate.

It is noted that two or more kinds of these polarizers may be added. Also in the case of addition of two or more kinds of these polarizers, the specific example and the preferable range of the addition amount are the same as the foregoing.

### (Degradation Inhibitor)

To the cellulose acylate film of the present invention, degradation inhibitors (for example, antioxidant, peroxide decomposer, radical inhibitor, metal deactivator, acid scavenger, or amine) may be added. Further, an ultraviolet absorber is one of the degradation inhibitors. These degradation inhibitors and the like are described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

Further, any of the commercially available stabilizers described in Kobunshi Tenkazai (Macromolecular Additives in English) Handbook (CMC Publishing Co., Ltd.), pages 21-69 can be preferably used.

### (Antioxidant)

The cellulose acylate film of the present invention preferably contains an antioxidant. By containing the antioxidant therein, the compound represented by Formula (I) used in the present invention acts effectively, so that a better effect of improvement in a durability of the polarizing plate is obtained.

Examples of the antioxidant include a phenol-based and hydroquinone-based antioxidant, such as 2,6-di-t-butyl-4-methylphenol, 4,4′-thiobis-(6-t-butyl-3-methylphenol), 1,1′-bis(4-hydroxyphenyl)cyclohexane, 2,2′-methylenebis(4-ethyl-6-t-butylphenol), 2,5-di-t-butylhydroquinone and pentaerythrityl-tetrakis[3-(3,5-di-t-butyl-4-hydroxyphenyl)propionate].

A phosphorus-based antioxidant, such as tris(4-methoxy-3,5-diphenyl)phosphite, tris(nonylphenyl)phosphite, tris(2,4-di-t-butylphenyl)phosphite, bis (2,6-di-t-butyl-4-methylphenyl)pentaerythritol diphosphite, and bis(2,4-di-t-butylphenyl)pentaerythritol diphosphite; or a hydroxylamine-based antioxidant, such as N,N-dioctadecylhydroxylamine and N,N-dibenzylhydroxylamine is also preferably used. As the hydroxylamine-based antioxidant, compounds described in paragraph Nos. 0005 to 0020 and 0022 to 0026 of JP-A-8-62767 can be also preferably used.

Further, reductones represented by the following Formula (A) or (B) is preferable as the antioxidant that can be used in the present invention.

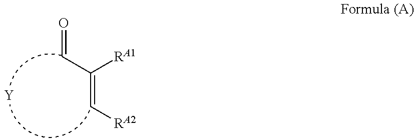

In Formula (A), R^{A1} and R^{A2} each independently represent a hydroxy group, an amino group, an acylamino group, an alkylsulfonylamino group, an arylsulfonylamino group, an alkoxycarbonylamino group, a mercapto group, or an alkylthio group. Y is composed of a carbon atom, and an oxygen atom and/or a nitrogen atom; and represents a group of nonmetallic atoms for forming a 5- or 6-membered ring with —C(═O)—C(R^{A1})═C(R^{A2})—.

R^{A1} and R^{A2} each are preferably a hydroxy group, an amino group, an alkylsulfonylamino group, or an arylsulfonylamino group; more preferably a hydroxy group or an amino group; and further preferably a hydroxy group.

It is preferable that Y has at least one —O— bond and furthermore Y is composed of —C(R^{A3})(R^{A4})—, —C(R^{A5})═, —C(═O)—, —N(Ra)— and —N═, either alone or in combination of two or more kinds. Herein, R^{A3} to R^{A5} and Ra each independently are preferably a hydrogen atom, an alkyl group having 1 to 10 carbon atoms which may have a substituent, an aryl group having 6 to 15 carbon atoms which may have a substituent, a hydroxy group, or a carboxyl group.

Examples of the above-described 5- to 6-membered ring formed through Y include a cyclopentenone ring (2-cyclopentene-1-on ring, the formed compound results in reductic acid), a furanone ring [2(5H)-furanone ring], a dihydropyranone ring [3,4-dihydro-2H-pyrane-4-on ring (2,3-dihydro-4H-pyrone ring), 3,6-dihydro-2H-pyrane-2-on ring, 3,6-dihydro-2H-pyrane-6-on ring (5,6-dihydro-2-pyrone ring)], and 3,4-dihydro-2H-pyrone ring. A cyclopentenone ring, a furanone ring and dihydropyrone ring are preferable. A furanone ring and dihydropyrone ring are more preferable. A furanone ring is particularly preferable.

These rings may form a condensed ring and the condensed ring may be either of a saturated ring and an unsaturated ring.

The reductones represented by the above-described Formula (A) is preferably a compound represented by the following Formula (A1), and more preferably a compound represented by the following Formula (A2).

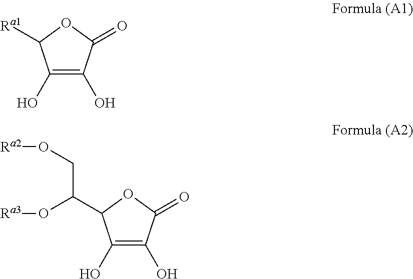

In Formula (A1), R^{a1} represents a hydrogen atom, an alkyl group, an aryl group, or a heterocyclic group. These groups may have a substituent.

R^{a1} is preferably an alkyl group which may have a substituent, and more preferably —CH(OR^{a3})CH₂OR^{a2}. In this case, the compound represented by Formula (A1) results in a compound represented by the above-described Formula (A2).

In Formula (A2), R^{a2} and R^{a3} each independently represent a hydrogen atom, an alkyl group, an acyl group, or an alkoxycarbonyl group, and R^{a2} and R^{a3} may be combined to form a ring. As the ring to be formed, a 1,3-dioxolan ring is preferable and further the ring may have a substituent. The compound having a dioxolan ring can be synthesized by acetalization or ketalization due to a reaction of ascorbic acid and ketones or aldehydes. The ketones and the aldehydes as a raw material can be used without any particular limitation.

One of particularly preferable combinations of substituents is expressed by a compound in which R^{a2} is an acyl group and R^{a3} is a hydrogen atom. The acyl group may be either an aliphatic acyl group or an aromatic acyl group. In the case of the aliphatic acyl group, the carbon number thereof is preferably 2 to 30, more preferably 4 to 24, and still more preferably 8 to 18. In the case of the aromatic acyl group, the carbon number thereof is preferably 7 to 24, more preferably 7 to 22, and still more preferably 7 to 18. Preferred examples of the acyl group include butanoyl, hexanoyl, 2-ethylhexanoyl, decanoyl, lauroyl, myristoyl, palmitoyl, stearoyl, palmitoleyl, myristoleyl, oleoyl, benzoyl, 4-methylbenzoyl, and 2-ethylbenzoyl.

A compound represented by the following Formula (B) is preferable as well as the compound represented by Formula (A) in the present invention.

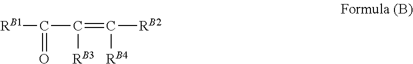

In Formula (B), R^{B1} and R^{B2} each independently represent a hydrogen atom, an alkyl group, an alkenyl group, a cycloalkyl group, an aryl group, an acyl group, a carboxy group, an amino group, an alkoxy group, an alkoxycarbonyl group, or a heterocyclic group. R^{B3} and R^{B4} each independently represent a hydroxy group, an amino group, an acylamino group, an alkylsulfonylamino group, an arylsulfonylamino group, an alkoxycarbonylamino group, or a mercapto group.

The alkyl group represented by R^{B1} and R^{B2} is preferably an alkyl group having 1 to 10 carbon atoms. The alkyl group is preferably methyl, ethyl or t-butyl.

The alkyl group represented by R^{B1} and R^{B2} is preferably an alkyl group having 1 to 10 carbon atoms.

The alkenyl group represented by R^{B1} and R^{B2} is preferably an alkenyl group having 2 to 10 carbon atoms. The alkenyl group is preferably vinyl or allyl, and more preferably vinyl.

The cycloalkyl group represented by R^{B1} and R^{B2} is preferably an cycloalkyl group having 3 to 10 carbon atoms. The cycloalkyl group is preferably cyclopropyl, cyclopentyl or cyclohexyl.

These alkyl group, alkenyl group and cycloalkyl group each may have a substituent. Preferred examples of the substituent include at least one kind of substituent selected from the group consisting of a hydroxy group, a carboxyl group and a sulfo group.

When the alkenyl group is vinyl, a vinyl group substituted with a carboxyl group is also preferable.

The aryl group represented by R^{B1} and R^{B2} is preferably an aryl group having 6 to 12 carbon atoms. The aryl group may have a substituent, and preferred examples of the substituent include at least one kind of substituent selected from the group consisting of an alkyl group, a hydroxy group, a carboxyl group, a sulfo group, a halogen atom, a nitro group and a cyano group.

The acyl group represented by R^{B1} and R^{B2} is preferably formyl, acetyl, isobutyryl, and benzoyl.

The amino group represented by R^{B1} and R^{B2} includes an amino group, an alkylamino group and an arylamino group. The amino group is preferably amino, methylamino, dimethylamino, ethylamino, diethylamino, dipropylamino, phenylamino, or N-methyl-N-phenylamino.

The alkoxy group represented by R^{B1} and R^{B2} is preferably an alkoxy group having 1 to 10 carbon atoms. The alkoxy group is preferably methoxy, or ethoxy.

The alkoxycarbonyl group represented by R^{B1} and R^{B2} is preferably methoxycarbonyl.

For the heterocyclic group in R^{B1} and R^{B2}, the ring-constituting hetero atom is preferably an oxygen atom, a sulfur atom and a nitrogen atom and the ring structure is preferably a 5-membered ring or a 6-membered ring. The heterocyclic group may be an aromatic heterocyclic group, or a saturated heterocyclic group, or may form a condensed ring.

The heterocycle of the heterocyclic group is preferably a pyridine ring, a pyrimidine ring, a pyrrole ring, a furan ring, a thiophene ring, a pyrazole ring, a piperidine ring, a piperazine ring, and a morpholine ring.

R^{B1} and R^{B2} each are more preferably an alkyl group having 1 to 6 carbon atoms or an aryl group having 6 to 12 carbon atoms.

The amino group represented by R^{B3} and R^{B4} includes an amino group, an alkylamino group and an arylamino group. The amino group is preferably an amino group, or an alkylamino group such as methylamino, ethylamino, n-butylamino and hydroxyethyl amino.

The acylamino group represented by R^{B3} and R^{B4} each are preferably acetylamino or benzoylamino.

The alkylsulfonylamino group represented by R^{B3} and R^{B4} each are preferably methyl sulfonylamino.

The arylsulfonylamino group represented by R^{B3} and R^{B4} each are preferably benzenesulfonylamino and p-toluenesulfonylamino.

The alkoxycarbonylamino group represented by R^{B3} and R^{B4} each are preferably methoxycarbonylamino.

R^{B3} and R^{B4} each are more preferably a hydroxy group, an amino group, an alkylsulfonylamino group, and an arylsulfonylamino group.

The antioxidant that can be used in the present invention is more preferably reductones. Specific examples thereof include compounds exemplified in paragraph Nos. 0014 to 0034 of JP-A-6-27599, compounds exemplified in paragraph Nos. 0012 to 0020 of JP-A-6-110163, and compounds exemplified in paragraph Nos. 0022 to 0031 of JP-A-8-114899.

Among these, a myristic acid ester of L-ascorbic acid, a palmitic acid ester of L-ascorbic acid, and a stearic acid ester of L-ascorbic acid are particularly preferable.

The timing of adding an antioxidant to a cellulose acylate film is not particularly limited, as long as the antioxidant is already added at the time when the film is prepared. For example, the antioxidant may be added during the stage of mixing a cellulose acylate and a solvent, or after a mixed solvent of a cellulose acylate and a solvent has been prepared.

The content of the antioxidant in the cellulose acylate film is preferably from 0.0001 to 5.0 parts by mass with respect to 100 parts by mass of cellulose acylate. By controlling the content of the antioxidant to such a range, a sufficient antioxidant effect and a durability of the polarizing plate can be obtained. The content of the antioxidant in the cellulose acylate film is more preferably from 0.001 to 1.0 parts by mass, and still more preferably from 0.01 parts by mass to 0.5 parts by mass, with respect to 100 parts by mass of cellulose acylate.

### (Radical Scavenger)

The cellulose acylate film of the present invention is preferably contains a radical scavenger. By containing therein the radical scavenger, the decomposition of the compound represented by Formula (I) is suppressed, so that better durability of the polarizer can be obtained.

The radical scavenger usable in the present invention is preferably a compound (HALS) represented by the following Formula (H).

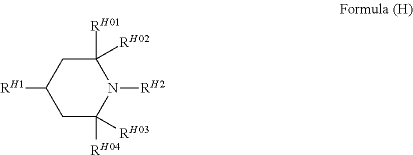

In Formula (H), R^{H1} and R^{H2} each independently designate a hydrogen atom or a substituent; R^{H01} to R^{H04} each independently designate an alkyl group.

The substituent represented by R^{H1} is not particularly limited, but preferably an alkyl group or a substituent which is linked to the piperidine ring via a nitrogen atom or an oxygen atom. The substituent which is linked to the piperidine ring via a nitrogen atom or an oxygen atom is preferably an amino group, an acylamino group, a hydroxy group, an alkoxy group, an aryloxy group or an acyloxy group. These groups may have a substituent.

The substituent represented by R^{H1} is preferably an amino group having an alkyl group, an aryl group or a heterocyclic group; a hydroxy group, an alkoxy group or an acyloxy group.

The substituent represented by R^{H2} is not particularly limited, but preferably an alkyl group (having preferably 1 to 20 carbon atoms, more preferably 1 to 12 carbon atoms, and still more preferably 1 to 8 carbon atoms, such as methyl, ethyl, isopropyl, t-butyl, n-octyl, 2-ethylhexyl, n-decyl, and an n-hexadecyl), an alkenyl group (having preferably 2 to 20 carbon atoms, more preferably 2 to 12 carbon atoms, and still more preferably 2 to 8 carbon atoms, such as vinyl, allyl, 2-butenyl and 3-pentenyl), an alkynyl group (having preferably 2 to 20 carbon atoms, more preferably 2 to 12 carbon atoms, and still more preferably 2 to 8 carbon atoms, such as propargyl and 3-pentynyl), a cycloalkyl group (having preferably 3 to 20 carbon atoms, more preferably 3 to 12, and still more preferably 3 to 8 carbon atoms, such as cyclopropyl, cyclopentyl and a cyclohexyl), an aryl group (having preferably 6 to 30 carbon atoms, more preferably 6 to 20 carbon atoms, and still more preferably 6 to 12 carbon atoms, such as phenyl, biphenyl and naphthyl), an amino group (including an amino group, an alkylamino group and an arylamino group, having preferably 0 to 20 carbon atoms, more preferably 0 to 10 carbon atoms, and still more preferably 0 to 6 carbon atoms, such as amino, methylamino, dimethylamino, diethylamino, phenylamino, N-methyl-N-phenylamino, and dibenzylamino), an alkoxy group (having preferably 1 to 20 carbon atoms, more preferably 1 to 12 carbon atoms, and still more preferably 1 to 8 carbon atoms, such as methoxy, ethoxy, and butoxy), a cycloalkyloxy group (a cycloalkyl ring of the cycloalkyloxy group is preferably a 3- to 8-membered ring having 3 to 20 carbon atoms, and cyclopropyloxy, cyclopentyloxy, and cyclohexyloxy are preferable as a cycloalkyloxy group), an acyl group (including an alkylcarbonyl group, and an arylcarbonyl group, preferably an acyl group having 2 to 20 carbon atoms, more preferably 2 to 16 carbon atoms, and still more preferably 2 to 8 carbon atoms, such as acetyl, propionyl, 2-ethylhexanoyl and benzoyl), a hydroxy group, or an oxy radical group (—O.).

R^{H01} to R^{H04} each are preferably an alkyl group having 1 to 6 carbon atoms, and more preferably ethyl or methyl. It is further preferable that all of R^{H01} to R^{H04} are methyl.

Preferred specific examples of the compound represented by the above-described Formula (H) include at least one kind of compound selected from the group consisting of 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-salicyloyloxy-2,2,6,6-tetramethylpiperidine, 4-methacryloyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethylpiperidine-4-ylmaleinate, bis(2,2,6,6-tetramethylpiperidine-4-yl)adipate, bis(2,2,6,6-tetramethylpiperidine-4-yl)sebacate, bis(1,2,3,6-tetramethyl-2,6-diethyl-piperidine-4-yl)sebacate, bis(1-allyl-2,2,6,6-tetramethyl-piperidine-4-yl)phthalate, 1-acetyl-4-acetoxy-2,2,6,6-tetramethylpiperidine, trimellitic acid-tris(2,2,6,6-tetramethylpiperidine-4-yl)ester, 1-acryloyl-4-benzyloxy-2,2,6,6-tetramethylpiperidine,

dibutylmalonic acid-bis(1,2,2,6,6-pentamethyl-piperidine-4-yl)ester, dibenzylmalonic acid-bis(1,2,3,6-tetramethyl-2,6-diethyl-piperidine-4-yl)ester, dimethyl-bis(2,2,2,6,6-tetramethylpiperidine-4-yloxy)-silane, tris(1-propyl-2,2,6,6-tetramethylpiperidine-4-yl)-phosphite, tris(1-propyl-2,2,6,6-tetramethylpiperidine-4-yl)-phosphate, N,N′-bis(2,2,6,6-tetramethylpiperidine-4-yl)-hexamethylene-1,6-diamine, tetrakis(2,2,6,6-tetramethylpiperidine-4-yl)-1,2,3,4-butanetetracarboxylate, tetrakis(1,2,2,6,6-pentamethylpiperidine-4-yl)-1,2,3,4-butanetetracarboxylate, N,N′-bis-(2,2,6,6-tetramethylpiperidine-4-yl)-hexamethylene-1,6-diacetamide, 1-acetyl-4-(N-cyclohexylacetamide)-2,2,6,6-tetramethyl-piperidine, 4-benzylamino-2,2,6,6-tetramethylpiperidine, N,N′-bis-(2,2,6,6-tetramethylpiperidine-4-yl)-N,N′-dibutyl-adipamide, N,N′-bis(2,2,6,6-tetramethylpiperidine-4-yl)-N,N′-dicyclohexyl-(2-hydroxy)propylenediamine, N,N′-bis-(2,2,6,6-tetramethylpiperidine-4-yl)-p-xylylene-diamine, 4-bis(2-hydroxyethyl)amino-1,2,2,6,6-pentamethylpiperidine, 4-methacrylamide-1,2,2,6,6-pentamethylpiperidine and α-cyano-β-methyl-β-[N-(2,2,6,6-tetramethylpiperidine-4-yl)]-amino-methyl acrylate ester.

Further, the examples thereof that can be suitably used include, but not limited to, a high molecular weight HALS to which a plurality of piperidine rings are linked via triazine structure, such as N,N′,N″,N″′-tetrakis-[4,6-bis-[butyl-(N-methyl-2,2,6,6-tetramethylpiperidine-4-yl)amino]-triazin-2-yl]-4,7-diazadecane-1,10-diamine, a polycondensate of dibutylamine, 1,3,5-triazine-N,N′-bis(2,2,6,6-tetramethyl-4-piperidyl)-1,6-hexamethylenediamine and N-(2,2,6,6-tetramethyl-4-piperidyl)butylamine (CHIMASSORB 2020 FDL, manufactured by BASF), a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}] (CHIMASSORB 944FDL, manufactured by BASF), a polycondensate of 1,6-hexanediamine-N,N′-bis(2,2,6,6-tetramethyl-4-piperidyl) and morpholine-2,4,6-trichloro-1,3,5-triazine, and poly[(6-morpholino-s-triazine-2,4-diyl) [(2,2,6,6-tetramethyl-4-piperidyl)imino]-hexamethylene[(2,2,6,6-tetramethyl-4-piperidyl)imino]];

and a high molecular weight HALS to which a piperidine ring is linked via ester linkage, such as a condensate of dimethyl succinate and 4-hydroxy-2,2,6,6-tetramethyl-1-piperidineethanol, and a mixed esterified product of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane.

Among them, preferred are selected from a polycondensate of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino} and a condensate of dimethyl succinate and 4-hydroxy-2,2,6,6-tetramethyl-1-piperidineethanol. The number average molecular weight thereof is preferably 2,000 to 5,000.

Suitable examples of the radical scavenger include a compound represented by the following Structure (Ha) (trade name: Sunlizer HA-622, manufactured by SORT CO., LTD.) and a compound represented by the following Structure (Hβ).

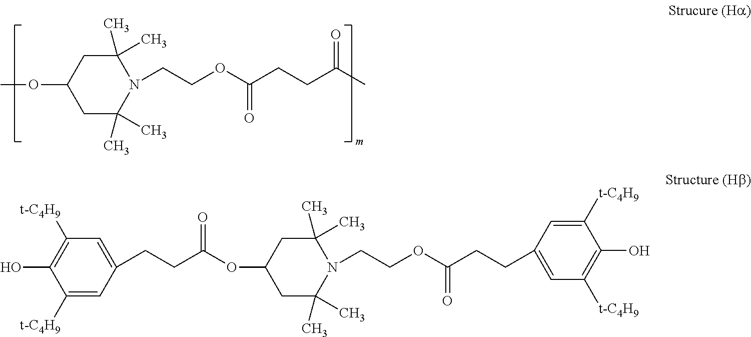

In Structure (Hα), m is from 2 to 30.

The compound represented by Structure (Hα) or (Hβ) is commercially available as CHIMASSORB 2020 FDL (trade name, CAS-No. 192268-64-7), CHIMASSORB 944 FDL (trade name, CAS-No. 71878-19-8) and TINUVIN 770 DF (trade name, CAS-No. 52829-07-9) manufactured by BASF (former Ciba Specialty Chemicals Inc.), and Cyasorb UV-3346 (trade name, CAS-No. 82541-48-7) and Cyasorb UV-3529 (trade name, CAS-No. 193098-40-7) manufactured by SUN CHEMICAL COMPANY LTD.

Also, the compound represented by the following Formula (H1) can be particularly preferably used in the cellulose acylate film of the present invention for the reason that the compound has a low basicity and impart a low adverse effect on polarization performance.

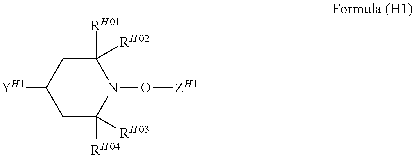

In Formula (H1), Z^{H1} represents an alkyl group, a cycloalkyl group, or an aryl group Y^{H1} represents a hydrogen atom or a substituent. R^{H01} to R^{H04} have the same meanings as those of R^{H01} to R^{H04} in Formula (H), and preferred ranges thereof are also the same, respectively.

Z^{H1} is preferably an alkyl group or a cycloalkyl group, each of which may have a substituent; more preferably an unsubstituted alkyl group having a branched structure, or a cycloalkyl group or an alkyl group which is substituted with an aryl group; and still more preferably a cycloalkyl group. There is no particular limitation on the substituent with which Z^{H1} is substituted.

The alkyl group in Z^{H1} has preferably 1 to 20 carbon atoms, further preferably 1 to 14 carbon atoms. The cycloalkyl group in Z^{H1} has preferably 3 to 20 carbon atoms, further preferably 3 to 14 carbon atoms. The aryl group in Z^{H1} has preferably 6 to 20 carbon atoms, further preferably 6 to 14 carbon atoms.

Y^{H1} is preferably a substituent. Although the substituent in Y^{H1} is not particularly limited, the substituent is preferably a substituent which is linked via a nitrogen atom or an oxygen atom to the piperidine ring; more preferably an amino group, a hydroxy group, an alkoxy group (having preferably 1 to 20 carbon atoms, more preferably 1 to 14 carbon atoms), an aryloxy group (having preferably 6 to 20 carbon atoms, more preferably 6 to 12 carbon atoms) or an acyloxy group (having preferably 2 to 20 carbon atoms, more preferably 2 to 14 carbon atoms), each of which may have a substituent; and further preferably an amino group, a hydroxy group, an alkoxy group having 1 to 10 carbon atoms or an acyloxy group having 2 to 10 carbon atoms, each of which is substituted with an alkyl group having 1 to 10 carbon atoms, an aryl group having 6 to 12 carbon atoms or a heterocyclic group.

The compound represented by Formula (H1) is especially characterized in that the nitrogen (N) in the piperidine ring especially has an ether linkage with an alkyl group or an aryl group which may have a substituent represented by Z^{H1}. The compound having a piperidine structure represented by Formula (H1) which contains the structure “N—O—Z^{H1}” is referred to as “NOZ^{H1} type” in the present specification.

Besides, a compound in which only a hydrogen is directly linked to the nitrogen (N) of the piperidine ring is referred to as “NH type”, and a compound in which only a methyl group is directly linked to the nitrogen (N) is referred to as “NCH₃ type”. NH type and NCH₃ type are strongly basic as compared with NOZ^{H1} type. In the present invention, the polarizer performance degradation at the time of having used a polarizing plate incorporating therein the cellulose acylate film of the present invention for a long time under the hygrothermal conditions can be effectively suppressed by using a weakly basic NOZ^{H1} type compound.

The NOZ^{H1} type compound represented by Formula (H1) is not limited so long as the compound has a desired piperidine structure. However, a compound represented by the following Formula (H1-1) or (H1-2) is preferred.

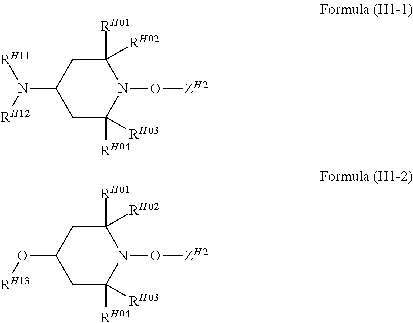

In Formulae (H1-1) and (H1-2), R^{H01} to R^{H04} have the same meanings as those of R^{H01} to R^{H04} in Formula (H), and preferred ranges thereof are also the same, respectively. Z^{H2} represents an alkyl group or an aryl group each of which may have a substituent. R^{H11} and R^{H12} each independently represent an alkyl group, an aryl group, an acyl group, or a heterocyclic group, R^{H13} represents a hydrogen atom, an alkyl group, an acyl group, or an aryl group.

The preferred range of Z^{H2} is the same as that of Z^{H1} in Formula (H1).

R^{H11} is more preferably a hydrogen atom or an alkyl group, still more preferably a hydrogen atom or an alkyl group having 1 to 6 carbon atoms, and particularly preferably a propyl group or a butyl group.

R^{H12} is more preferably an alkyl group or a heterocyclic group, particularly preferably an alkyl group having 1 to 6 carbon atoms or a heterocyclic group having 1 to 2 nitrogen atoms in its ring, and more particularly preferably triazine.

R^{H13} is preferably a hydrogen atom, an alkyl group having 1 to 12 carbon atoms, or an acyl group having 1 to 12 carbon atoms; and particularly preferably an acyl group having 1 to 12 carbon atoms.

The substituent represented by R^{H11} to R^{H13} may be substituted, for example, with a substituent of Formula (H1) from which Y^{H1} is eliminated.

The compound represented by Formula (H1-1) or (H1-2) is preferably a compound represented by any one of Formulae (H1-a) to (H1-c).

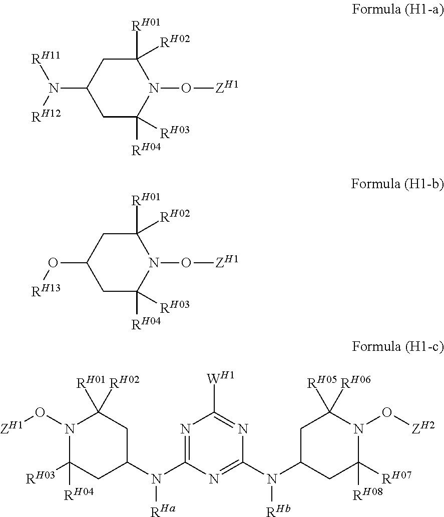

In Formulae (H1-a) to (H1-c), R^{H11}, R^{H12}, R^{H13}, Z^{H1} and Z^{H2} each have the same meanings as those of R^{H11}, R^{H12}, R^{H13}, Z^{H1} and Z^{H2}, and preferred ranges thereof are also the same, respectively. R^{H01} to R^{H04} have the same meanings as those of R^{H01} to R^{H04} in Formula (H), and preferred ranges thereof are also the same, respectively.

In Formula (H1-c), R^{HO5} to R^{H08} each independently represent an alkyl group. R^{Ha} and R^{Hb} each independently represent a hydrogen atom, an alkyl group, an aryl group or a heterocyclic group. W^{H1} represents a substituent.

Hereinafter, preferable examples of the compound represented by formula (H) are shown. However, the present invention is not limited thereto.

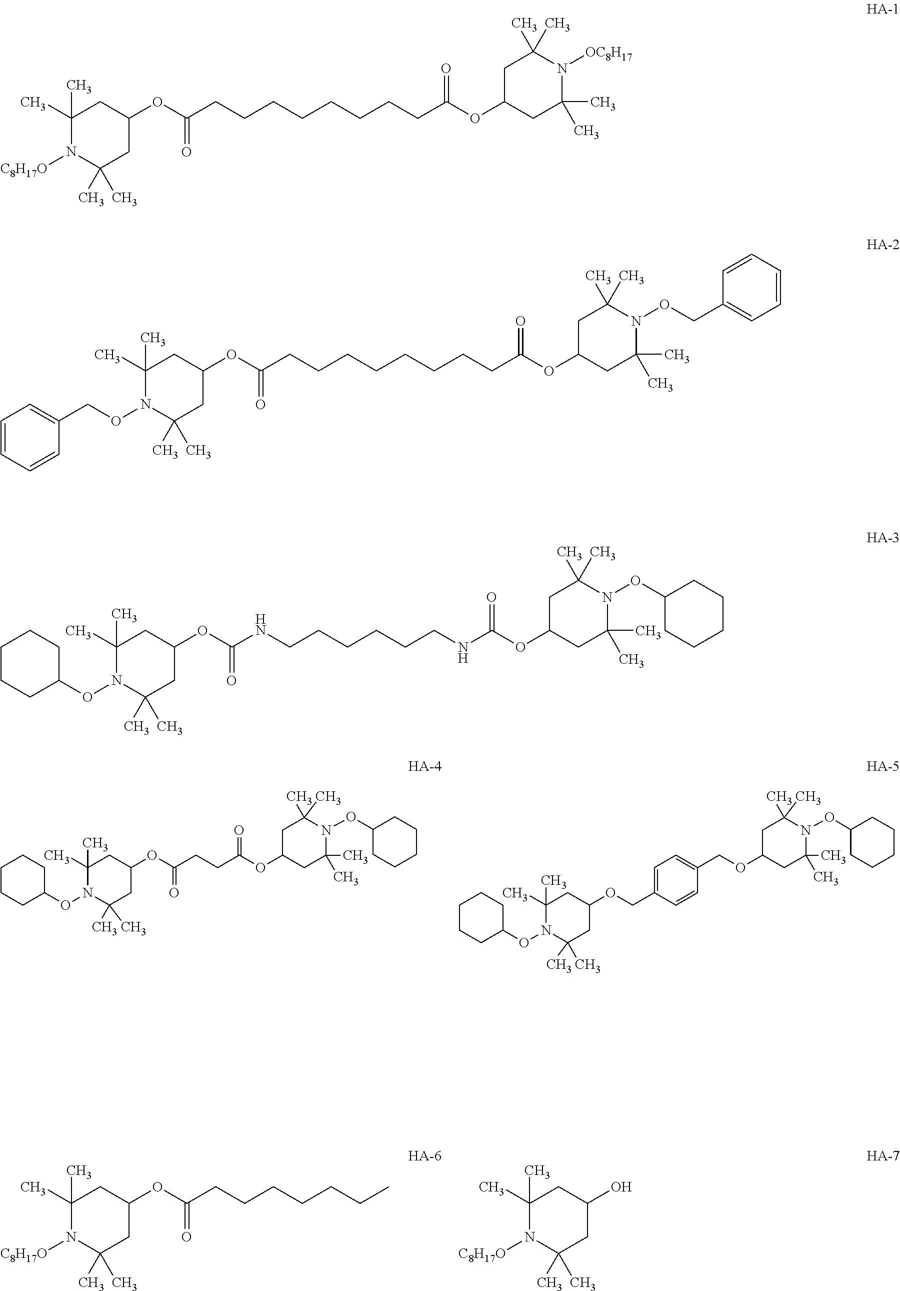

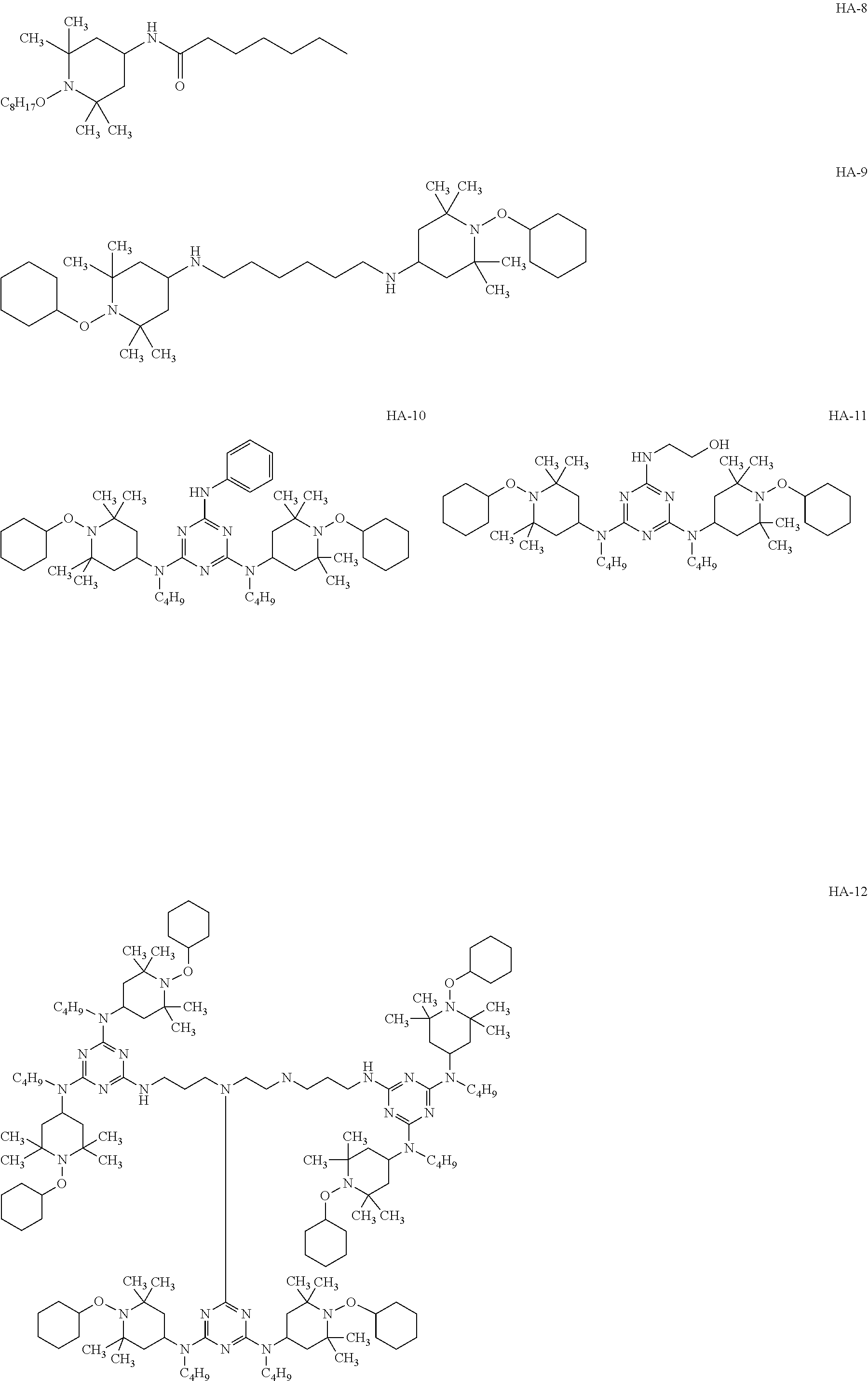

The above-described compound HA-1 (trade name “TINUVIN 123” manufactured by BASF. CAS-No. 129757-67-1) the above-described compound HA-11 (trade name “TINUVIN 152” manufactured by BASF, CAS-No. 191743-75-6) and the above-described compound HA-12 (trade name “FLAMESTAB NOR 116 FF” manufactured by BASF, CAS-No. 191680-81-6) are commercially available.

Meanwhile, although the compound represented by Formula (H) is commercially available as described above, the compound may be prepared by a synthesis. The synthetic method of the compound represented by Formula (H) is not particularly limited, and the compound may be synthesized by any common organic synthetic method. Further, any methods using distillation, recrystallization, reprecipitation, a filtering agent and an adsorbent may be suitably used as a purification method. Further, the compound represented by Formula (H) is commercially obtained not only alone but also in a mixture at a low price. In the present invention, however, the compound represented by Formula (H) can be used regardless of a preparation method, a composition, a melting point, an acid value and the like, as long as it acts as a radical scavenger.

For the compound represented by Formula (H), its molecular weight is not limited. However, from the viewpoint of suppression of volatilization from a cellulose acylate film, the compound is better off with such a certain level of high molecule as the following molecular weight. By adjustment to a moderate molecular weight, a film which has an excellent compatibility with cellulose acylate and a high transparency can be obtained.

Accordingly, the compound represented by Formula (H) has a molecular weight of preferably 300 to 100,000, more preferably 500 to 50,000, and particularly preferably 700 to 30,000.

The timing of addition of the compound represented by Formula (H) to the cellulose acylate film is not particularly limited, as long as it is added at the time of film production. For example, the compound may be added during the stage of mixing cellulose acylate and a solvent, or may be added after preparation of a mixed solvent of cellulose acylate and a solvent.

The content of the compound represented by Formula (H) in the cellulose acylate film is preferably from 0.0001 to 5.0 parts by mass with respect to 100 parts by mass of cellulose acylate. By controlling the content of the compound represented by Formula (H) in the cellulose acylate film to such a range, a sufficient antioxidant effect and a durability of the polarizer can be obtained. The content of the compound represented by Formula (H) in the cellulose acylate film is more preferably from 0.001 to 2.0 parts by mass, and still more preferably from 0.01 to 1.0 part by mass, with respect to 100 parts by mass of cellulose acylate.

### (Ultraviolet Absorber)

In the present invention, an ultraviolet absorber may be added to the cellulose acylate solution from the viewpoint of preventing deterioration of a polarizing plate, a liquid crystal or the like. As the ultraviolet absorber, it is preferable to use those which have excellent absorption capacity of ultraviolet at the wavelength of 370 nm or less and further which exhibit a low absorption of visible light having the wavelength of 400 nm or longer from the viewpoint of good properties for display. The ultraviolet absorber which is preferably used in the present invention is at least one selected from a hindered phenol compound, a hydroxybenzophenone compound, a benzotriazole compound, a salicylic acid ester compound, a benzophenone compound, a cyano acrylate compound and a nickel complex salt compound.

The hindered phenol compound is not particularly limited. The hindered phenol compound is preferably at least one selected from 2,6-di-t-butyl-p-cresol, pentaerythrityl-tetrakis[3-(3,5-di-t-butyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene, and tris-(3,5-di-t-butyl-4-hydroxybenzyl)isocyanurate.

The benzotriazole compound is not particularly limited. The benzotriazole compound is preferably at least one selected from 2-(2′-hydroxy-5′-methylphenyl)benzotriazole, 2,2-methylenebis[4-(1,1,3,3-tetramethylbutyl)-6-(2H-benzotriazole-2-yl)phenol], (2,4-bis-(n-octylthio)-6-(4-hydroxy-3,5-di-t-butylanilino)-1,3,5-triazine, triethyleneglycol-bis[3-(3-t-butyl-5-methyl-4-hydroxyphenyl)propionate], N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene, 2-(2′-hydroxy-3′,5′-di-t-butylphenyl)-5-chlorobenzotriazole, 2-(2′-hydroxy-3′,5′-di-t-amylphenyl)-5-chlorobenzotriazole, 2,6-di-t-butyl-p-cresol, and pentaerythrityl-tetrakis[3-(3,5-di-t-butyl-4-hydroxyphenyl)propionate, 2-(3,5-di-t-amyl-2-hydroxyphenyl)benzotriazole, and 2-(2H-benzotriazole-2-yl)-6-(1-methyl-1-phenylethyl)-4-(1,1,3,3-tetramethylbutyl)phenol].

As these compounds, a commercial product of TINUVIN-series such as TINUVIN 99-2, TINUVIN 109, TINUVIN 171, TINUVIN 320, TINUVIN 326, TINUVIN 327, TINUVIN 328, TINUVIN 329, TINUVIN 343, TINUVIN 900, TINUVIN 928, TINUVIN P and TINUVIN PS manufactured by BASF are exemplified and they can be preferably used.

The content of the ultraviolet absorber in the cellulose acylate film is preferably from 1 ppm to 10%, more preferably from 1 ppm to 5.0% and still more preferably from 10 ppm to 3.0%, on the mass basis.

### (Other Additives Functioning as Degradation Inhibitor)

As a degradation inhibitor for a cellulose acylate, an additive which is known as a peroxide decomposer, a radical inhibitor, or a metal deactivator may be used. Examples thereof include compounds described in paragraph Nos. [0074] to [0081] and [0082] to [0117] of JP-A-2006-251746.

Further, amines are also known as a degradation inhibitor. Examples thereof include compounds described in paragraph Nos. [0009] to [0080] of JP-A-5-194789, aliphatic amines such as tri-n-octylamine, triisooctylamine, tris(2-ethylhexyl)amine, N,N-dimethyldodecylamine and the like.

Further, polyvalent amines having 2 or more amino groups are also preferably used. As the polyvalent amine, those having 2 or more primary or secondary amino groups are preferable. Examples of the compound having 2 or more amino groups include a nitrogen-containing heterocyclic compound (compounds having a pyrazolidine ring, piperazine ring or the like), a polyamine-based compound (chain-like or ring-like polyamines, for example, diethylenetriamine, tetraethylenepentamine, N,N′-bis(aminoethyl)-1,3-propanediamine, N,N,N′,N″,N″-pentakis(2-hydroxypropyl)diethylenetriamine, polyethyleneimine, modified polyethyleneimine, and a compound containing cyclam as a basic skeleton) and the like.

Specific examples of such a polyvalent amine include diethylenetriamine, triethylenetetramine, tetraethylenepentamine, pentaethylenehexamine, dipropylenetriamine, tripropylenetetramine, aminoethylethanolamine, polyethyleneimine, ethylene oxide-modified polyethyleneimine, propylene oxide-modified polyethyleneimine, polyallylamine, polyvinylamine, N′,N′-tetrakis(2-hydroxyethyl)ethylenediamine, N,N,N′,N′-tetrakis(2-hydroxypropyl)ethylenediamine, and N,N,N′,N″,N″-pentakis(2-hydroxypropyl)diethylenetriamine. In addition, examples of the commercially available product include EPOMIN (registered trade mark) SP-006, SP-012, SP-018, and PP-061, manufactured by Nippon Shokubai Co., Ltd.

The content of the degradation inhibitor in the cellulose acylate film is preferably from 1 ppm to 10%, more preferably from 1 ppm to 5.0%, and still more preferably from 10 ppm to 5,000 ppm, with respect to 100 parts by mass of the cellulose acylate.

### (Matting Agent)

A matting agent may be added to the cellulose acylate film of the present invention from the viewpoint of film lubricity (slipping property) and stable production. The matting agent may be either a matting agent composed of an inorganic compound or a matting agent composed of an organic compound.

The matting agent composed of the inorganic compound is preferably at least one selected from silicon-containing inorganic compounds (e.g., silicon dioxide, calcined calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin-antimony oxide, calcium carbonate, talc, clay, calcined kaolin, and calcium phosphate. Further, at least one selected from silicon-containing inorganic compounds and zirconium oxide is more preferred. Silicon dioxide is particularly preferably used from the viewpoint of more reducing haze of the cellulose acylate film.

As fine particles of silicon dioxide, for example, commercial products which have trade names such as Aerosil R972, R974, R812, 200, 300, R202, OX50, TT600 (all by Nippon Aerosil) are usable. As fine particles of zirconium oxide, for example, commercial products which have trade names such as Aerosil R976 and R811 (both by Nippon Aerosil) are usable.

The matting agent composed of the organic compound is not particularly limited. However, the matting agent composed of the organic compound is preferably at least one selected from silicone resins, fluororesins, and acrylic resins. Among these, silicone resins are more preferred. Of the silicone resins, those having a three-dimensional network structure are particularly preferred. For example, it is possible to use commercially available products having trade names of Tospearl 103, Tospearl 105, Tospearl 108, Tospearl 120, Tospearl 145, Tospearl 3120, Tospearl 240 (all manufactured by Toshiba Silicone Co., Ltd.) and the like.

The timing of addition of these matting agents to the cellulose acylate film is not particularly limited, as long as these are added at the time of film production. For example, the additive may be added in the stage where a cellulose acylate is mixed with a solvent; or after preparing a mixture solution from a cellulose acylate and a solvent, the additive may be added thereto.

Further, the additive may be added to and mixed with a dope just before casting of the dope. The mixing is preferably conducted by screw kneading provided on-line. Specifically, a static mixer like an in-line mixer is preferred. As the in-line mixer, for example, a static mixer, SWJ (Toray's static intratubular mixer, Hi-Mixer, manufactured by Toray Engineering Co., Ltd.) and the like are preferred.

Regarding the in-line addition, a method described in JP-A-2003-053752 can be used for the purpose of preventing concentration unevenness and particle aggregation. Further, a method described in JP-A-2003-014933 also can be used for providing a phase difference film which has a small trouble of additive bleeding and is free from a trouble of interlayer peeling and which has good lubricity and excellent transparency.

The content of the matting agent in the cellulose acylate film is particularly preferably from 0.05 to 1.0 part by mass. By controlling the content to such values, the haze of the cellulose acylate film is suppressed so as not to become large. In the case where the cellulose acylate film is implemented in a liquid crystal display, such controlled content contributes to suppression of disadvantage such as a reduction in contrast and generation of bright spot. Further, friction and abrasion resistance can be achieved. From these viewpoints, the matting agent is preferably incorporated in the proportion of from 0.05 to 1.0% by mass in the cellulose acylate film.

### (Peeling Agent)

A peeling agent may be added to the cellulose acylate film of the present invention. For examples of the peeling agent, compounds described in paragraph Nos. [0048] to [0081] of JP-A-2006-45497, compounds described in paragraph Nos. [0077] to [0086] of JP-A-2002-322294, compounds described in paragraph Nos. [0030] to [0056] of JP-A-2012-72348, and the like can be preferably used.

### (Organic Acid)

An organic acid may be added to the cellulose acylate film of the present invention.

The organic acid includes compounds described in paragraph Nos. [0079] to [0082] of JP-A-2002-322294. Examples thereof include citric acid, oxalic acid, adipic acid, succinic acid, malic acid, and tartaric acid.

Further, as the organic acid, amino acids are also preferable. Examples thereof include asparagine, asparagine acid, adenine, alanine, f-alanine, arginine, isoleucine, glycine, glutamine, glutamine acid, serine, tyrosine, tryptophan, threonine, norleucine, valine, phenyl alanine, mechionine, lysine, leucine and the like.

The organic acid may be used as a free acid and includes an alkali metal salt, an alkali-earth metal salt, and a salt of a heavy metal including a transitional metal. Among metals of each salt, as the alkali metal, lithium, potassium, sodium and the like can be exemplified and as the alkali-earth metal, calcium, magnecium, barium, strontium and the like can be exemplified. As the heavy metals including a transitional metal, aluminum, zinc, tin, nickel, iron, lead, copper, silver and the like can be exemplified. Further, a salt of substituted or unsubstituted amines having the carbon number of 5 or less is also preferable. As the amines which form a salt, for example, ammonium, methylamine, ethylamine, propylamine, butylamine, dimethylamine, trimethylamine, triethylamine, hydroxyethylamine, bis(hydroxyethyl)amine, tris(hydroxyethyl)amine and the like can be exemplified. Preferable metals are sodium for the alkali metal, and calcium and magnecium for the alkali-earth metal. Each of the alkali metal and the alkali-earth metal may be used alone, or in combination of 2 or more kinds. Further, the alkali metal and the alkali-earth metal may be used in combination thereof.

### (Polyvalent Carboxylic Acid Derivative)

A polyvalent carboxylic acid derivative may be added to the cellulose acylate film of the present invention.

As the polyvalent carboxylic acid derivative, an ester compound and an amide compound are preferable.

The carboxylic acid component is a polyvalent carboxylic acid and the carboxylic acid may be either an aliphatic or aromatic carboxylic acid. However, the aliphatic carboxylic acid is preferable. The aliphatic carboxylic acid which is a saturated or unsaturated, straight chain-like, branched chain-like or ring-like carboxylic acid is preferable. The aliphatic carboxylic acid may have a substituent. Examples of the substituent include an alkyl group, an alkenyl group, an aryl group, a hydroxy group, an amino group, an alkoxy group, an alkenyloxy group, an acyloxy group, and an acylamino group.

Examples of the aromatic carboxylic acid include phthalic acid, terephthalic acid, isophthalic acid, 1,3,5-benzene tricarboxylic acid and the like. Examples of the aliphatic carboxylic acid include oxalic acid, malonic acid, succinic acid, glutaric acid, adipic acid, and sebacic acid. Examples of the aliphatic carboxylic acid having a substituent include malic acid, citric acid and tartaric acid.

As for the polyvalent carboxylic acid ester, a group of the alcoholic component, which binds to the oxygen atom of —C(═O)—O— acting as an ester functional group, is preferably a substituted or unsubstituted alkyl group [for example, methyl, ethyl, isopropyl, t-butyl, 2-ethylhexyl, —CH₂CH₂O—(CH₂CH₂)ₙ—C₂H₅ and the like], an alkenyl group (for example, vinyl, allyl, 2-methyl-2-propenyl, 2-butenyl, oleyl and the like). The total carbon number of the alcoholic component (the group which binds to the oxygen atom) is preferably from 1 to 200, more preferably from 1 to 100, and still more preferably from 1 to 50. The substituent which the alkyl group and the alkenyl group may have is preferably an alkoxy group, an alkenyloxy group, a hydroxy group, and acyloxy group, and more preferably an alkoxy group. As the alkoxy group and the alkenyloxy group, a group containing a (poly)oxyalkylene group is preferable. In particular, as the (poly)oxyalkylene group, a poly(oxyethylene) group, (poly)oxypropylene group, and (poly)oxybutylene group are preferable.

Further, the alcohol which is a raw material for the alcoholic component may be either univalent or polyvalent. Examples of the polyalcohol include ethylene glycol, propylene glycol, glycerin, and pentaerythritol. The group in which these hydroxy group portion (—OH) has been modified to a polyoxyalkyleneoxy group [for example, —(OCH₂CH₂)n-OH, —(OC₃H₆)nOH] is also preferable.

As for the polycarboxylic acid amide, the amine compound of the amide component may be either a primary amine or a secondary amine, which is not limited in particular. As the substituent substituted at the nitrogen atom of —C(═O)—N< which acts as an amide functional group, an alkyl group [for example, methyl, ethyl, isopropyl, t-butyl, 2-ethylhexyl, —CH₂CH₂O—(CH₂CH₂)n-C₂H₅ and the like], and an alkenyl group (for example, vinyl, allyl, 2-methyl-2-propenyl, 2-butenyl and the like) are preferable. The total carbon number of the amine compound of the amine component is preferably from 1 to 200, more preferably from 1 to 100, and still more preferably from 1 to 50. The substituent which the alkyl group and the alkenyl group may have is preferably an alkoxy group, an alkenyloxy group, a hydroxy group, an acyloxy group, an amino group, and an acylamino group, and more preferably an alkoxy group. As the alkoxy group and the alkenyloxy group, a group containing a (poly)oxyalkylene group is preferable. In particular, as the (poly)oxyalkylene group, a poly(oxyethylene) group, (poly)oxypropylene group, and (poly)oxybutylene group are preferable. Further, such polyoxyalkylene partial structure which contains a branched polyoxyalkylene group through glycerin is also preferable.

Further, the amine compound which is a raw material for the amine component may be either univalent or polyvalent.

Among polyvalent carboxylic acid derivatives, an organic acid monoglyceride having an unreacted and releasable carboxyl group is particularly preferable. Examples of the marketed products thereof include POEM K-37V (glycerin citrate/oleate ester) manufactured by Riken Vitamin Co., Ltd., and STEP SS (glycerin stearate/palmitate/succinate ester) manufactured by Kao Corporation.

### (Surfactant)

A surfactant may be added to the cellulose acylate film of the present invention.

As for the surfactant, compounds described in paragraph Nos. [0050] to [0051] of JP-A-2006-45497, and compounds described in paragraph Nos. [0127] to [0128] of JP-A-2002-322294 may be preferably used. Specific examples of the nonionic surfactant include polyoxyethylene alkyl ether, polyoxyethylene alkyl phenyl ether, polyoxyethylene/polyoxypropylene glycol, polyvalent alcohol aliphatic acid partial ester, polyoxyethylene polyvalent alcohol aliphatic acid partial ester, polyoxyethylene aliphatic acid ester, polyglycerin aliphatic acid ester, aliphatic acid diethanolamide, triethanolamine aliphatic acid partial ester, and polyether amine. Further, examples of the marketed product thereof include NYMEEN L-202, STAFOAM DO, and STAFOAM DL (manufactured by NOF CORPORATION).

### (Chelating Agent)

The cellulose acylate film of the present invention may contain a chelating agent.

The chelating agent is a compound which is able to coordinate (chelate) with a multivalent metal ion including: a metal ion such as an iron ion and the like; and an alkali-earth metal ion such as a calcium ion and the like. Any of such a wide variety of chelating agents as represented by an aminopolycarboxylic acid, an aminopolyphosphonic acid, an alkylphosphonic acid, and a phosphonocarboxylic acid may be used. As for the chelating agent, it is possible to use compounds described in each of the publications of JP-B-6-8956 (“JP-B” means examined Japanese patent publication), JP-A-11-190892, JP-A-2000-18038, JP-A-2010-158640, JP-A-2006-328203, JP-A-2005-68246, and JP-A-2006-306969.

Specifically, examples thereof include ethylenediaminetetraacetic acid, hydroxyethylethylenediaminetriacetic acid, diethylenetriaminepentaacetic acid, nitrilotriacetic acid, triethylenetetraminehexaacetic acid, cyclohexanediaminetetraacetic acid, hydroxyethyliminodiacetic acid, ethyleneglycol bis(2-aminoethylether)tetraacetic acid, 1,3-diaminopropane tetraacetic acid, phosphonic acid, 1-hydroxyethylidene-1,1-diphosphonic acid, nitrilo-N,N,N-trimethylene phosphonic acid, ethylenediamine-N,N,N,N-tetramethylene phosphonic acid, ethylenediamine-di(o-hydroxyphenylacetic acid), DL-alanine-N,N-diacetic acid, aspartic acid-N,N-diacetic acid, glutamic acid-N,N-diacetic acid, serine-N,N-diacetic acid, polyacrylic acid, an isoamylene/maleic acid copolymer, an acrylic acid/maleic acid copolymer, an acrylic acid/methacrylic acid copolymer, silicic acid, gluconic acid, hydroxybenzylimino diacetic acid, and imino diacetic acid. Marketed products of these compounds are available from Chelest Corporation, Nagase ChemteX Corporation, Dojindo, and the like.

Further, an oil-soluble chelating agent is also preferably used. As for the marketed product thereof, TECHRUN DO (Nagase ChemteX Corporation), CHELEST MZ-2 and CHELEST MZ-8 (Chelest Corporation) may be used.

### <Physical Properties of Cellulose Acylate Film>

### (Elastic Modulus)

The range of the elastic modulus of the cellulose acylate film of the present invention, although it is not particularly limited, is preferably from 1.0 GPa to 7.0 GPa, and more preferably from 2.0 GPa to 6.5 GPa, from the viewpoint of production suitability and handling properties. The compound represented by Formula (I) in the present invention acts such that the film is hydrophobized by addition of the compound to a cellulose acylate, thereby improving elastic modulus. That is, addition of the compound represented by Formula (I) in the present invention has an advantage also from the viewpoint of elastic modulus.

### (Photoelastic Coefficient)

The absolute value of photoelastic coefficient of the cellulose acylate film of the present invention is preferably 8.0×10⁻¹² m²/N or less, more preferably 6×10⁻¹² m/N or less, and still more preferably 5×10⁻¹² m²/N or less. Lessening the photoelastic coefficient of the resin film enables suppression of generation of unevenness under the hygrothermal conditions upon mounting of the resin film into a liquid crystal display as a polarizing plate protective film. The photoelastic coefficient is measured and calculated in accordance with the following method, unless it is explicitly stated otherwise.

The lower limit of the photoelastic coefficient is not particularly limited. However, it is practical to be 0.1×10⁻¹² m²/N or more.

### —Calculation Method of Photoelastic Coefficient—

A film is cut into a specimen of 3.5 cm×12 cm and Re in a in-plane direction of the film is measured under each load of non-load, 250 g, 500 g, 1,000 g and 1,500 g using an ellipsometer (M 150 [trade name], manufactured by JASCO Corporation), and by calculation based on the slope of a straight line of Re change to stress, the photoelastic coefficient is measured.

### (Moisture Content)

The moisture content of the cellulose acylate film can be evaluated by measurement of equilibrium moisture content under the constant temperature and humidity. The equilibrium moisture content is obtained by the following method. That is, the moisture content of a sample which has reached equilibrium after leaving it for 24 hours at the above-described temperature and humidity is measured in accordance with Karl Fischer Method, and the obtained moisture content (g) is divided by the sample mass (g) to obtain the equilibrium moisture content.

The moisture content of the cellulose acylate film of the present invention under the conditions of 25° C. and relative humidity of 80% is preferably 5% by mass or less, more preferably 4% by mass or less, and still more preferably less than 3% by mass. Lessening the moisture content of the cellulose acylate film enables suppression of deterioration of the quality of display in black under the hygrothermal conditions upon mounting of the cellulose acylate film into a liquid crystal display as a polarizing plate protective film. The lower limit of the moisture content is not particularly limited.

However, it is practical to be 0.1% by mass or greater.

### (Water-Vapor Transmission Ratio)

The water-vapor transmission ratio of the cellulose acylate film can be measured and evaluated by the following method. That is, the mass of water-vapor which passes through the sample for 24 hours in the atmosphere of temperature: 40° C. and relative humidity: 90% RH is measured in accordance with the water-vapor transmission ratio test (cup method) prescribed in JIS Z0208, and the obtained value is converted to a value per m² of the sample area to evaluate the water-vapor transmission ratio.

The water-vapor transmission ratio of the cellulose acylate film of the present invention is preferably from 500 to 2,000 g/m²·day, more preferably from 900 to 1,300 g/m²·day, and particularly preferably from 1,000 to 1,200 g/m²·day.

### (Haze)

The cellulose acylate film of the present invention may have a haze of preferably 1% or less, more preferably 0.7% or less, most preferably 0.5% or less. When the haze is lowered to the above-described upper limit or less, the cellulose acylate film has advantages in that transparency of the film is more increased and thus the film becomes more usable as an optical film. The lower limit of the haze is not particularly limited. However, it is practical to be 0.001% by mass or greater.

With respect to the cellulose acylate film, the haze of the film specimens of 40 mm×80 mm in size is measured in an environment at 25° C. and 60% relative humidity, using a haze meter (HGM-2DP, Suga Test Instruments Co., Ltd.), in compliance with JIS K-7136.

### (Film Thickness)

The average film thickness of the cellulose acylate film of the present invention is preferably from 10 to 100 μm, more preferably from 15 to 80 μm, and still more preferably from 20 to 70 p.m. Setting the average film thickness to 15 μm or greater is preferable, because handling properties during production of a web film are improved. While, on the other hand, when the average film thickness is set to 70 μm or less, the response to humidity change becomes easy and the improving effects of the present invention is exhibited more effectively.

Further, in the case where the cellulose acylate film of the present invention has a multi-layered structure of three or more multi-layers, the film thickness of the core layer is preferably from 3 to 70 μm, and more preferably from 5 to 60 p.m. In the case where the cellulose acylate film of the present invention has a multi-layered structure of three or more multi-layers, each of the film thicknesses of the surface layers (skin layer A and skin layer B) on both sides of film is more preferably from 0.5 to 20 μm, more preferably from 0.5 to 10 μm, and particularly preferably from 0.5 to 3 μm.

### (Film Width)

The film width of the cellulose acylate film of the present invention is preferably from 700 to 3,000 mm, more preferably from 1,000 to 2,800 mm, and particularly preferably from 1,100 to 2,500 mm.

### <Production Method of Cellulose Acylate Film>

The method of producing the cellulose acylate film in the present invention is not limited in particular. It is noted that the film is preferably produced by a melt cast method or a solvent cast method, and more preferably by a solvent cast method (solvent-casting method). The cellulose acylate film of the present invention is preferably produced by a solvent-casting method. Examples of production of cellulose acylate film using a solvent-casting method are given in publications such as U.S. Pat. Nos. 2,336,310, 2,367,603, 2,492,078, 2,492,977, 2,492,978, 2,607,704, 2,739,069 and 2,739,070, British Patents 640731, 736892, JP-B-45-4554, JP-B-49-5614, and JP-A-60-176834, JP-A-60-203430, JP-A-62-115035, and they are referred to herein. The cellulose acylate film may be stretched. Regarding the method and condition for stretching treatment, for example, referred to are publications such as JP-A-62-115035, JP-A-4-152125, JP-A-4-284211, JP-A-4-298310 and JP-A-11-48271.

### (Casting Methods)

Solvent casting methods may include a method for uniformly extruding a prepared dope from a pressure die onto a metal support, a doctor blade method for adjusting, with a blade, the film thickness of a dope once cast on a metal support, a reverse roll coater method for adjusting it with a reverse rotating roll, and the like, and the method of using a pressure die is preferred. The pressure die includes a coat hanger type or a T die type, and any of them may be preferably used. In addition to these methods exemplified herein, various methods of film production by casting a cellulose triacylate solution, which are conventionally known, may be employed. When each of conditions is set in consideration of the difference in the boiling points and the like of solvents used, film-forming by casting can be conducted similar to conventional methods.

### Co-Casting

In formation of the cellulose acylate film of the present invention, a multi-layer casting method, such as a co-casting method (multilayer simultaneous casting), a sequential casting method, and a coating method, is preferable. Especially, a co-casting method is particularly preferred, from the viewpoints of stable production and reduction of production cost.

In the case where two or more cellulose acylate film are produced according to a co-casting method, first a cellulose acetate solution (dope) for each layer is prepared. Subsequently, the dope for each layer is simultaneously casted on a casting support (a band or a drum) by extruding the dope from a casting Gieser which has a function of simultaneously extruding the casting dope for each layer from different slits or the like, and then the casted dope is stripped off from the support at just the right time and dried to form a film. In FIG. 2, the cross-sectional view shows a state in which casting is performed by simultaneously extruding three layers formed of a dope 1 for two surface layers and a dope 2 for core layer on a casting support 4, using a co-casting Giesser 3.

### Sequential Casting Method

The sequential casting method is a casting method in which first a casting dope for first layer is extruded out and cast onto a casting support through a casting Giesser, then after it is dried or not dried, a casting dope for second layer is extruded through the casting Giesser and cast onto the first layer, and if needed, three or more layers are sequentially formed by casting and laminating dopes in the same manner as the above, and then at a suitable time, the resultant laminate is peeled away from the support and dried to form a film.

### Coating Method

The coating method is generally a method, in which a core layer is formed in film-state by means of the solvent-casting method, then a coating solution for a surface layer is prepared, and then using a suitable coater, the coating solution is applied onto the core layer first on one surface thereof and next on the other surface thereof, or alternatively simultaneously on both surfaces thereof, and dried, to form a multi-layered film.

As the running support for casting (metal support) for use in production of the cellulose acylate film, it is possible to use a dram whose surface is mirror-finished by chromium plating, or a stainless belt (may be called as a band) whose surface is mirror-finished by surface polish. One or at least two pressure dies may be used by arranging it or them above the metal support. In the case where two or more pressure dies are arranged, a casting amount of the dope may be divided into portions which are suitable for the individual dies. The casting dope may be fed to the die at a suitable proportion from a plurality of precision metering gear pumps. The temperature of the dope (resin solution) to be used for casting is preferably from −10° C. to 55° C., and more preferably from 25° C. to 50° C. In this case, the solution temperature may be the same throughout the entire process, or may be different in different stages of the process.

Further, the material of the above metal support, although it is not particularly limited, is more preferably made of SUS (for example, SUS 316).

### (Peeling)

In the production of the cellulose acylate film of the present invention, a step of peeling off the above-described dope film from the metal support is preferably included.

### (Stretching Treatment)

In the production of the cellulose acylate film of the present invention, a stretching step after film formation is preferably included. The stretching direction of the cellulose acylate film may be any of a film conveying direction and an orthogonal direction (width direction) to the film conveying direction. However, the orthogonal direction (width direction) to the film conveying direction is preferred from the viewpoint of the subsequent polarizing plate-manufacturing process using the film.

A method of stretching the film in the width direction is described, for example, in JP-A-62-115035, JP-A-4-152125, JP-A-4-284211, JP-A-4-298310, JP-A-1-48271, and the like. In the case of stretching in the longitudinal direction, the film is stretched when the film winding speed is set to be faster than the film peeling-off speed, for example, by adjusting a speed of the film-conveying roller. In the case of stretching in the width direction, the film may be stretched by conveying the film while holding the width of the film with a tenter, and extending the width of the tenter gradually. After drying the film, the film may be also stretched by using a stretching machine (preferably uniaxial stretching by using a long stretching machine).

In the case where the cellulose acylate film of the present invention is used as a protective film for a polarizer, the transmission axis of the polarizer and the in-plane slow axis of the resin film of the present invention are required to be arranged parallel to one another, in order to suppress the light leakage when viewed from oblique directions to the polarizing plate. The transmission axis of the roll film-shaped polarizer that is produced continuously is generally parallel to the width direction of the roll film, and thus, in order to continuously sticking the above roll film-shaped polarizer together with a protective film composed of the roll film-shaped cellulose acylate film, the in-plane slow axis of the roll film-shaped protective film is required to be parallel to the width direction of the film. Accordingly, the film is preferably stretched to a larger extent in the width direction. The stretching treatment may be conducted in the course of the film production process, or the original film obtained by rewinding the produced film may be subjected to a stretching treatment.

The stretching in the width direction is preferably from 5 to 100%, more preferably from 5 to 80%, and particularly preferably from 5 to 40%. Meanwhile, non-stretching means that stretching is 0%. The stretching treatment may be conducted in the course of the film production process, or the original film obtained by rewinding the produced film may be subjected to a stretching treatment. In the former case, stretching may be conducted in the condition where a certain amount of a residual solvent is contained, and when the residual solvent amount, i.e. (mass of residual volatile substance/mass of film after heat treatment)×100(%), is from 0.05 to 50%, the stretching is preferably conducted. It is particularly preferable to conduct the stretching of from 5 to 80% in the condition where the residual solvent amount is from 0.05 to 5%. It is noted that the stretching of 0% is defined as an unstretching.

### (Drying)

It is preferable, from the viewpoint of enhancing the retardation, that the method of producing the cellulose acylate film of the present invention includes a step of drying the cellulose acylate film and a step of stretching the thus-dried cellulose acylate film of the present invention at a temperature which is equal to or higher than the glass transition temperature (Tg) −10° C.

Drying of the dope provided on the metal support that is included in the production of the cellulose acylate film of the present invention, generally includes: a method of blowing a hot air from a surface side of the metal support (dram or belt), that is to say, from the surface of a web provided on the metal support; a method of blowing a hot air from a back side of the dram or belt; a back-side liquid heat transfer method in which a temperature-modulated liquid is brought into contact with the back side opposite to the casting side of the dram or belt, thereby heating the dram or belt through heat transfer to control a surface temperature; and the like. Among these, the back-side liquid heat transfer method is preferred. The surface temperature of the metal support before casting is conducted is not particularly limited as long as it is not higher than the boiling point of a solvent which is used for a dope. In order to accelerate drying and to make the dope lose fluidity on the metal support, the surface temperature is preferably set to a temperature which is lower by 1 to 10° C. than the boiling point of the solvent having the lowest boiling point among the solvents to be used for the dope. However, this shall not apply in the case where the casting dope is cooled and then peeled off without drying.

The adjustment of the film thickness may be achieved by adjusting a concentration of the solid contained in the dope, a slit space of the die nozzle, an extrusion pressure from a die, a speed of the metal support, or the like, so as to be a desired thickness.

The thus-obtained cellulose acylate film is preferably wound at the degree of from 100 to 10,000 m, more preferably from 500 to 7,000 m, and still more preferably from 1,000 to 6,000 m, in length per roll. At the time of winding, at least one end thereof is preferably subjected to knurling. The width of knurling is preferably from 3 mm to 50 mm and more preferably from 5 mm to 30 mm. The height thereof is preferably from 0.5 to 500 μm and more preferably from 1 to 200 μm. This may be either one-way press or two-way press.

When the cellulose acylate film of the present invention is used as an optical compensation film for a large screen liquid crystal display, molding the film so as to be, for example, 1,470 mm or more in width is preferred. Further, when the cellulose acylate film of the present invention is used as the polarizing plate protective film, the cellulose acylate film of the present invention may be a film piece that is cut to a size capable of being mounted as it is in a liquid crystal display, as well as a cellulose acylate film that is manufactured in a long shape by continuous production and wound in a roll shape. The cellulose acylate film in a roll shape of the latter aspect is stored or conveyed as it is, and is used by cutting to a desired size when the film is mounted in a liquid crystal display, or when the film and a polarizer or the like are stuck together in practice. Alternatively, the polarizing plate protective film is used by cutting to a desired size when the film is mounted in a liquid crystal display in practice after sticking the film in a long shape as it is with a polarizer or the like composed of a polyvinyl alcohol film or the like manufactured similarly in a long shape. As an aspect of the optical compensation film or polarizing plate protective film which is wound in a roll shape, an aspect of a film which is wound in a roll shape and has a roll length of 2,500 m or more, is exemplified.

### <<Functional Layer>>

When the cellulose acylate film of the present invention is used as a polarizing plate protective film, functional layers for arbitrary purposes may be optionally disposed on the polarizing plate protective film. Examples of the functional layer include a hard coat layer, an antireflection layer, a light scattering layer, an antifouling layer, an antistatic layer, and the like. These layers providing a plurality of functions may be combined by one layer.

As an example, the hard coat layer is described below.

### <<Hard Coat Layer>>

The hard coat layer, optionally disposed on the cellulose acylate film of the present invention used as a polarizing plate protective film, is a layer for imparting hardness or scratch resistance to the cellulose acylate film of the present invention. It is possible to form a hard coat layer exhibiting high adhesive property with respect to the cellulose acylate film in cooperation with the compound represented by Formula (I) in the present invention, for example, by applying a coating composition for forming the hard coat layer on the cellulose acylate film and curing it. Filler and additive may be added to the hard coat layer, to thereby make the hard coat layer itself have additional mechanical, electrical, optical, and physical properties, and chemical properties such as water repellency or oil repellency. The thickness of the hard coat layer is preferably 0.1 to 6 μm, more preferably from 3 to 6 μm. Having such a thin hard coat layer of which the thickness falls within the range, the optical film can have improved physical properties in point of brittleness reduction, curling prevention and the like, and can attain other advantages of weight saving and production cost cutting.

Preferably, the hard coat layer is formed by curing a curable composition for forming the hard coat layer. Preferably, the curable composition is prepared as a liquid coating composition. One example of the coating composition contains a monomer or an oligomer for matrix formation binder, other polymers, and organic solvent. Curing the coating composition after being applied can form the intended hard coat layer. The curing reaction includes crosslinking or polymerization.

### (Monomer or Oligomer for Matrix Formation Binder)

Examples of monomer or oligomer for matrix formation binder usable include ionizing radiation-curable polyfunctional monomers and polyfunctional oligomers. The polyfunctional monomers and the polyfunctional oligomers are preferably crosslinkable or polymerizable ones. The functional group in the ionizing radiation-curable polyfunctional monomers and polyfunctional oligomers is preferably one polymerizable through exposure to light, electron beam or radiation; and above all, especially preferred is a photopolymerizing functional group.

Examples of the photopolymerizing functional group include unsaturated polymerizing functional group, such as a (meth)acryloyl group, a vinyl group, a styryl group, and an allyl group; a ring-opening polymerizing functional group, such as those in epoxy compounds. Above all, preferred is a (meth)acryloyl group.

Specific examples of the photopolymerizing polyfunctional monomer having a photopolymerizing functional group include:

(meth)acrylic diesters of alkylene glycols, such as neopentylglycol di(meth)acrylate, 1,6-hexanediol di(meth)acrylate, and propyleneglycol di(meth)acrylate;

(meth)acrylic diesters of polyoxyalkyleneglycols, such as triethyleneglycol di(meth)acrylate, dipropyleneglycol di(meth)acrylate, polyethyleneglycol di(meth)acrylate, and polypropyleneglycol di(meth)acrylate;

(meth)acrylic diesters of polyalcohols, such as pentaerythritol di(meth)acrylate;

(meth)acrylic diesters of ethylene oxide or propylene oxide adducts, such as 2,2-bis{4-(acryloxy.diethoxy)phenyl}propane, and 2,2-bis{4-(acryloxy.polypropoxy)phenyl}propane.

Further, urethane (meth)acrylates, polyester (meth)acrylates, isocyanuric (meth)acrylates, and epoxy (meth)acrylates are also preferred, for use as the photopolymerizing polyfunctional monomer.

Of the above, more preferred are esters of polyalcohols and (meth)acrylic acids, and even more preferred are polyfunctional monomers having at least three (meth)acryloyl groups in one molecule.

Specific examples thereof include (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol tri(meth)acrylate, tripentaerythritol hexa(meth)acrylate, trimethlylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol tri(meth)acrylate, 1,2,3-cyclohexane tetrameth(meth)acrylate, polyester polyacrylate, and caprolactone-modified tris((meth)acryloxyethyl)isocyanurate.

In this description, “(meth)acrylate”, “(meth)acrylic acid” and “(meth)acryloyl” mean “acrylate or methacrylate”, “acrylic acid or methacrylic acid” and “acryloyl or methacryloyl”, respectively.

Further, examples include resins having at least 3 (meth)acryloyl groups, for example, polyester resins having a relatively low molecular weight, as well as polyether resins, acrylic resins, epoxy resins, urethane resins, alkyd resins, spiroacetal resins, polybutadiene resins, polythiol polyene resins, oligomers or prepolymers of polyfunctional compounds, such as polyalcohols.

As specific example of the polyfunctional acrylate-based compounds having at least 3 (meth)acryloyl groups, referred to is the description in paragraph No. [0096] of JP-A-2007-256844, and the like.

As urethane (meth)acrylates, for example, there may be mentioned urethane (meth)acrylate-based compounds obtained by reacting a hydroxy group-containing compounds, such as alcohol, polyol and/or hydroxy group-containing (meth)acrylate, with isocyanates, followed by optionally esterifying the polyurethane compound obtained through the reaction with (meth)acrylic acid.

As specific examples of those compounds, referred to is the description in paragraph No. [0017] and the like of JP-A-2007-256844, and the like.

Use of isocyanuric (meth)acrylates is preferred as reducing the curling of the formed film. Such isocyanuric (meth)acrylates include isocyanuric diacrylates and isocyanuric triacrylates; and as examples of those compounds, referred to is the description in paragraph No. [0018] to [0021] and the like of JP-A-2007-256844, and the like.

An epoxy-based compound may further be used in the hard coat layer for reducing the shrinkage of the layer through curing. As the epoxy-based compound (epoxy group-having monomers) usable are monomers having at least 2 epoxy groups in one molecule. Examples of those monomers include epoxy-based monomers described in JP-A-2004-264563, JP-A-2004-264564, JP-A-2005-37737, JP-A-2005-37738, JP-A-2005-140862, JP-A-2005-140863, and JP-A-2002-322430. Also preferred is use of compounds having both epoxy-based and acrylic-based functional groups, such as glycidyl (meth)acrylate.

### (Polymer Compound)

The hard coat layer may contain a polymer compound. Adding a polymer compound to the layer is preferred, as capable of reducing the curing shrinkage of the layer and capable of facilitating the viscosity control of the coating liquid that takes an interest in the dispersion stability (coagulability) of resin particles. Other advantages of the polymer compound are that the polarity of the solidified matter in the drying step may be controlled to change the coagulation behavior of resin particles and that the drying unevenness in the drying step can be reduced.

The polymer compound is a compound which is already in the form of a polymer when it is added to the coating liquid. As the polymer compound of the type, preferred for use are, for example, cellulose esters (e.g., cellulose triacetate, cellulose diacetate, cellulose propionate, cellulose acetate propionate, cellulose acetate butyrate, and cellulose nitrate); and resins, such as urethanes, polyesters, (meth)acrylates (e.g., methyl methacrylate/methyl (meth)acrylate copolymer, methyl methacrylate/ethyl (meth)acrylate copolymer, methyl methacrylate/butyl (meth)acrylate copolymer, methyl methacrylate/styrene copolymer, methyl methacrylate/(meth)acrylic acid copolymer, and poly(methyl methacrylate)); and polystyrene.

### (Curable Composition)

One example of the curable composition usable for forming the hard coat layer is a curable composition containing a (meth)acrylate-based compound. Preferably, the curable composition contains a photoradical polymerization initiator or a thermal radical polymerization initiator, along with the (meth)acrylate-based compound, and if desired, may further contain a filler, a coating aid, and any of other additives. The curable composition may be cured through polymerization to be attained by exposure to ionizing radiation or to heat, in the presence of the photoradical polymerization initiator or the thermal radical polymerization initiator. Further, ionizing radiation curing and thermal curing may be combined. As the photoradical and/or thermal radical polymerization initiators, usable are commercial products. Such photoradical and/or thermal radical polymerization initiators are described in, for example, “Newest UV Curing Technology”, p. 159 (issued by Kazuhiro Takausu, published by Technical Information Society of Japan, 1991), and Ciba Specialty Chemicals' catalogues.

Another example of the curable composition that can be used in forming the hard coat layer is a curable composition containing an epoxy-based compound. Preferably, the curable composition contains an optical acid generator capable of generating a cation by the action of light applied thereto, along with the epoxy-based compound therein, and may optionally contain a filler, a coating aid, and any of other additives. The curable composition may be cured through polymerization to be attained by exposure to light, in the presence of an optical acid generator. Examples of the optical acid generator include ionic compounds, such as triarylsulfonium salts, diaryliodonium salts; and nonionic compounds, such as sulfonic acid nitrobenzyl ester. Further, various types of arbitrary optical acid generators, such as the compounds described in “Imaging Organic Material” (edited by Organic Electronics Material Society of Japan, published by Bunshin Publishing, 1997) may be used.

A (meth)acrylate-based compound and an epoxy-based compound may be combined for use. In such a case, preferably, a photoradical polymerization initiator or a thermal radical polymerization initiator is combined with an optical cationic polymerization initiator, as the initiator.

The curable composition which is particularly suitable for the formation of the hard coat layer is a composition containing a (meth)acrylate-based compound, as used in Examples to be described below.

The curable composition is preferably prepared as a coating liquid. The coating liquid can be prepared, by dissolving and/or dispersing the above-mentioned ingredients in an organic solvent.

### (Property of Hard Coat Layer)

The hard coat layer formed on the cellulose acylate film of an optical film of the present invention has a high adhesion to the cellulose acylate film. In particular, in the hard coat layer formed from the above-mentioned suitable curable composition on the cellulose acylate film containing the compound represented by Formula (I), the curable composition, together with the compound represented by Formula (I), is formed with a more increased adhesion to the cellulose acylate film. Accordingly, the optical film of the present invention having the foregoing cellulose acylate film and hard coat layer maintains adhesion between the cellulose acylate film and the hard coat layer even under the irradiation to light or the like, and therefore has an excellent light durability.

It is preferable that the hard coat layer is excellent in abrasion resistance. Specifically, it is preferable that when the layer is tested in a pencil hardness test (JIS-S6006) that is an index of abrasion resistance, the layer attains at least 3H.

### <<Polarizing Plate>>

The polarizing plate of the present invention has a polarizer and a cellulose acylate film of the present invention at at least one side of the polarizer.

The polarizing plate of the present invention preferably has a polarizer and the cellulose acylate film of the present invention provided on one side or both sides of the polarizer. Examples of the polarizer include an iodine-based polarizer, a dye-based polarizer using a dichroic dye, and a polyene-based polarizer. Ordinarily the iodine-based polarizer and the dye-based polarizer may be produced, with using a polyvinyl alcohol-based film. When the cellulose acylate film of the present invention is used as a polarizing plate protective film, the production method of the polarizing plate is not particularly limited and may be produced in accordance with an ordinary manner. For example, there is a method of subjecting the cellulose acylate film of the present invention to an alkali treatment, and besides preparing a polarizer by immersing a polyvinyl alcohol film in an iodine solution and stretching the film, and then sticking the thus-treated cellulose acylate film and both sides of the polarizer together with a completely-saponified polyvinyl alcohol aqueous solution. In place of the alkali treatment, an easy adhesion processing as described in JP-A-6-94915 and JP-A-6-118232 may be used. Examples of the adhesive that is used for sticking the processed surface of the cellulose acylate film and the polarizer together include polyvinyl alcohol-based adhesives, such as polyvinyl alcohol, and polyvinyl butyral, and vinyl-based latexes derived from, such as butyl acrylate.

The cellulose acylate film of the present invention and the polarizer are preferably stuck together such that a transmission axis of the polarizer and a slow axis of the cellulose acylate film of the present invention are substantially bisected at right angles, parallel or at 45°. It is preferable that a transmission axis of the polarizer and a slow axis of the cellulose acylate film of the present invention in the liquid crystal display of the present invention are stuck together so as to be substantially bisected at a right angle. Herein, the expression “substantially bisected at right angle or parallel” includes a range of error which is acceptable in the technical field of the present invention. For example, the foregoing expression means to be within the range less than ±10° from the strict angle with respect to the pallelism and the orthogonal intersection. The range of error from the strict angle is preferably 5° or less, and more preferably 3° or less.

The expression “a transmission axis of the polarizer and a slow axis of the cellulose acylate film is parallel” means that the angle between the direction of principal refractive index nix of the cellulose acylate film and the direction of the transmission axis of the polarizer is within the range of ±10°. This angle range is preferably within ±5°, more preferably ±3°, still more preferably ±1°, and most preferably ±0.5°. It is noted that when this angle is 0°, the direction of principal refractive index nx of the cellulose acylate film and the direction of the transmission axis of the polarizer does not bisect, so that they are completely parallel to one another.

Further, the expression “a transmission axis of the polarizer and a slow axis of the cellulose acylate film is bisected at right angle” means that the direction of principal refractive index nx of the cellulose acylate film and the direction of the transmission axis of the polarizer are crossed at the angle of 90°±10°. This angle is preferably 90°±5°, more preferably 90°±3° still more preferably 90°±1°, and most preferably 90°±0.5°. Setting of the angle to the above range at the time of sticking them together enables further reduction in light leakage under the condition of polarizing plate crossed-Nicols. The measurement of the slow axis can be performed by any of various arbitrary methods and can be performed, for example, using a birefringence meter (KOBRA DH, manufactured by Oji Scientific Instruments).

The aspect of the polarizing plate of the present invention includes a film piece that is cut to a size capable of being mounted as it is in a liquid crystal display, as well as a film that is manufactured in a long shape by continuous production and wound in a roll shape (for example, an aspect having the roll length of 2,500 m or longer and an aspect having the roll length of 3,900 m or longer). When intended for the large-screen liquid crystal display, the width of the polarizing plate is preferably set to 1,470 mm or longer. The specific configuration of the polarizing plate of the present invention is not particularly limited, and arbitrary configuration may be used. For example, the configuration shown in FIG. 6 of JP-A-2008-262161 may be used.

### <<Display>>

The cellulose acylate film of the present invention is used preferably for application to a display, using the polarizer. The display of the present invention has a liquid cell and the polarizing plate of the present invention.

Examples of such an application to a display include an antireflection usage of a liquid crystal display or an organic electroluminescent display.

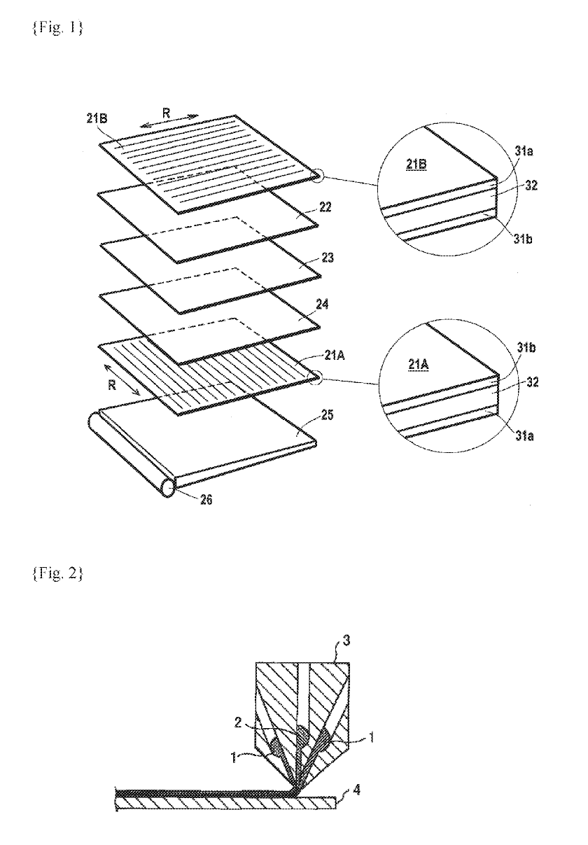

The liquid crystal display of the present invention is preferably an IPS, OCB, or VA mode liquid crystal display, which has a liquid crystal cell, and a pair of polarizing plates, which are layered on both sides of the liquid crystal cell and at least one of the pair of polarizing plates is the polarizing plate of the present invention. An internal configuration of a typical liquid crystal display is shown in FIG. 1. The specific configuration of the liquid crystal display of the present invention is not particularly limited, and an arbitrary configuration can be adopted. Further, the configuration shown in FIG. 2 of JP-A-2008-262161 may be preferably adopted.

### EXAMPLES

The present invention will be described in more detail based on the following examples, but the invention is not intended to be limited thereto.

### [Synthesis of Compound Represented by Formula (I)]

The compound represented by Formula (I) in the present invention was synthesized as follows.

Synthesis Examples of typical compounds are shown below.

### Synthesis Example 1

Exemplified compound (A-1) was synthesized by the following reaction scheme.

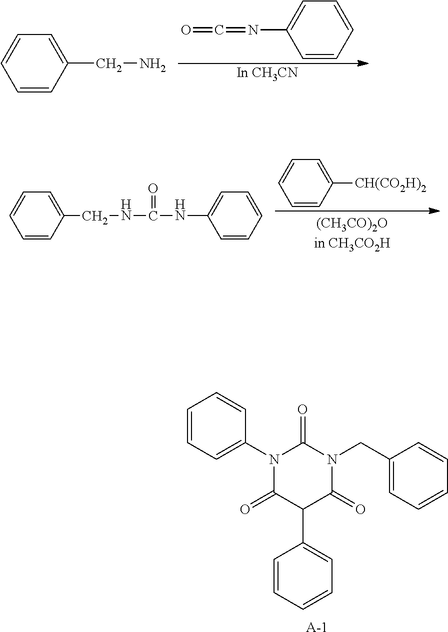

### 1) Synthesis of Intermediate N-benzyl-N′-phenyl urea

To a 5 L-glass flask equipped with a thermometer, a reflux condenser tube, and an agitator, 321 g of benzyl amine and 2 L of acetonitrile were added and 358 g of phenyl isocyanate was dripped thereto with stirring at the rate by which an inner temperature of the reaction liquid was able to be kept at 40° C. or less while cooling the 5 L-glass flask in a water bath. After stirring for 2 hours as it was, 2 L of water was added to the reaction solution and the precipitated crystals were taken out by suction filtration and then washed with 1 L of water three times. By drying the obtained crystals at 80° C. under reduced pressure, 610 g of intermediate N-benzyl-N′-phenyl urea was obtained.

The structure of the obtained compound was confirmed by ¹H-NMR spectrum.

¹H-NMR (300 MHz, DMSO-d₆); δ: 8.52 (s, 1H), 7.45-7.18 (m, 9H), 6.89 (t, 1H), 6.59 (s, 1H), 4.30 (d, 2H)

### 2) Synthesis of Exemplified Compound (A-1)

To a 300 ml glass flask equipped with a thermometer, a reflux condenser tube, and an agitator, 5.0 g of N-benzyl-N′-phenyl urea, 8.16 g of phenyl malonic acid, 10 mL of acetic acid and 15 mL of acetic anhydride were added and heated with stirring so that an inner temperature became 60° C. and the stirring was continued for 1.5 hours as it was. After that, the reaction solution was cooled down to room temperature and then 100 mL of diisopropyl ether was added thereto. The reaction solution was cooled in an ice water bath and was stirred for 1 hour, and then the precipitated crystals were taken out by suction filtration and then washed with cooled-down diisopropyl ether and then dried. Thus, 4.2 g of Exemplified compound (A-1) was obtained.

The structure of the obtained compound was confirmed by ¹H-NMR spectrum.

¹H-NMR (300 MHz, CDCl₃), δ: 7.50-7.10 (m, 15H), 5.13 (dd, 2H), 4.80 (s, 1H)

Melting point: 160° C.

Exemplified compound (A-3) can be synthesized by, for example, the following reaction schemes.

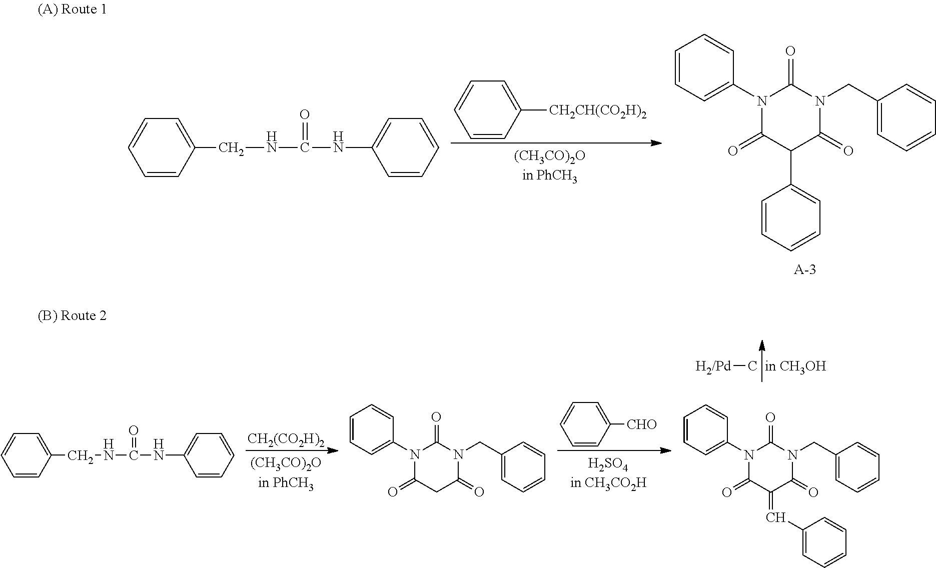

### Synthesis Example 2

### (A) Synthesis of Exemplified Compound (A-3) by Route 1

To a 300 mL glass flask equipped with a thermometer, a reflux condenser tube, and an agitator, 5.0 g of intermediate N-benzyl-N′-phenyl urea synthesized in Synthesis Example 1, 6.4 g of benzyl malonic acid, 10 mL of toluene and 15 mL of acetic anhydride were added and heated with stirring so that an inner temperature became 75° C. and the stirring was continued at 75° C. for 2 hours as it was. After that, the reaction solution was cooled down to 50° C. and then 50 mL of 1 mol/L sodium hydroxide aqueous solution was added thereto. An organic phase was disposed. Then, while cooling an aqueous phase in an ice water bath and stirring, 10 mL of 6 M hydrochloric acid was dripped to the aqueous phase. After further stirring at 0° C. for 1 hour, the precipitated crystals were taken out by suction filtration and then washed with water and then dried. Thus, 7.5 g of Exemplified compound (A-3) was obtained.

The structure of the obtained compound was confirmed by ¹H-NMR spectrum.

¹H-NMR (300 MHz, CDCl₃), δ: 7.55-7.20 (m, 9H), 7.13 (t, 2H), 6.96 (d, 2H), 6.84 (br, 2H), 4.96 (s, 2H), 3.94 (t, 1H), 3.55 (m, 2H)

### Synthesis Example 3

### (B) Synthesis of Exemplified Compound (A-3) by Route 2

Exemplified compound (A-3) was synthesized as follows.

### 1) Synthesis of Intermediate 1-benzyl-3-phenylburbituric acid

To a 300 mL glass flask equipped with a thermometer, a reflux condenser tube, and an agitator, 5.0 g of N-benzyl-N′-phenyl urea synthesized in Synthesis Example 1, 2.5 g of malonic acid, 20 mL of toluene and 5.6 g of acetic anhydride were added and heated with stirring so that an inner temperature became 80° C. and the stirring was continued at 80° C. for 3 hours as it was. After that, the reaction solution was cooled down to 50° C. and then 15 mL of water was added thereto for liquid separation. An aqueous phase was disposed. Then, 5 mL of isopropanol was dripped to an organic phase while stirring at room temperature. After further stirring was continued at 10° C. or less for 0.5 hour, the precipitated crystals were taken out by suction filtration and then washed with a cooled-down isopropanol and then dried. Thus, 4.6 g of intermediate 1-benzyl-3-phenylburbituric acid was obtained.

The structure of the obtained compound was confirmed by ¹H-NMR spectrum.

¹H-NMR (300 MHz, CDCl₃), δ: 7.52-7.16 (n, 10H), 5.10 (s, 2H), 3.86 (s, 2H)

### 2) Synthesis of Intermediate 1-benzyl-5-benzylidene-3-phenylburbituric acid

To a 300 mL glass flask equipped with a thermometer, a reflux condenser tube, and an agitator, 4.0 g of 1-benzyl-3-phenyl burbitric acid, 1.6 g of benzaldehyde, and 40 mL of acetic acid were added. A droplet of sulfuric acid was added thereto and then the reaction liquid was heated with stirring so that an inner temperature became 100° C. and the stirring was continued at 100° C. for 3 hours as it was. After that, the reaction solution was cooled down to 50° C. and then a mixed solution of 39 mL of isopropanol and 17 mL of water was added thereto and then was stirred at 10° C. or less for 1 hour. Then, the precipitated crystals were taken out by suction filtration and then washed with methanol. Thus, 3.9 g of intermediate 1-benzyl-5-benzylidene-3-phenylburbituric acid was obtained.

The structure of the obtained compound was confirmed by ¹H-NMR spectrum.

¹H-NMR (300 MHz, CDCl₃), δ: 8.70 (s, 1H), 8.10 (d, 2H), 7.58-7.20 (m, 13H), 5.20 (s, 2H)

### 3) Synthesis of Exemplified Compound (A-3)

To a 50 mL autoclave, 3.5 g of 1-benzyl-5-benzylidene-3-phenylburbituric acid, and 8 mL of methanol were added. Then, as a catalyst, 0.1 g of 10% palladium carbon Pd—C (10%) was added thereto and was filled with H₂ with stirring and was heated so that an inner temperature became 50° C. and the stirring was continued at 50° C. for 3 hours as it was. Thereafter, Pd—C was separated by filtration and the reaction solution was cooled down to 5° C. and further 4 mL of water was added thereto. After stirring at 5° C. for 1 hour, the precipitated crystals were collected by suction filtration and then washed with a mixed solvent of methanol/water=1/1 and then dried. Thus, 3.0 g of Exemplified compound (A-3) was obtained.

The structure of the obtained compound was confirmed by ¹H-NMR spectrum, IR spectrum and Mass spectrum.

It was confirmed that the structure of the obtained compound was identical with the obtained compound of Synthesis Example 2 by ¹H-NMR spectrum.

### Synthesis Example 4

### Synthesis of Exemplified Compound (A-2)

Exemplified compound (A-2) was synthesized in the same manner as Synthesis Example 2, except that N-benzyl-N′-phenylurea was replaced with N,N′-diphenylurea.

¹H-NMR (300 MHz, DMSO-d₆), δ: 7.40-7.08 (in, 15H), 4.32 (t, 1H), 3.41 (d, 2H)

Melting point: 139° C.

### Synthesis Example 5

### Synthesis of Exemplified Compound (A-4)

Exemplified compound (A-4) was synthesized in the same manner as Synthesis Example 1, except that N-benzyl-N′-phenylurea was replaced with N,N′-dibenzylurea.

¹H-NMR (300 MHz, DMSO-d₆), δ: 7.31-7.27 (m, 15H), 5.29 (s, 1H), 4.99 (s, 4H)

Melting point: 88° C.

### Synthesis Example 6

### Synthesis of Exemplified Compound (A-5)

Exemplified compound (A-5) was synthesized in the same manner as Synthesis Example 2, except that N-benzyl-N′-phenylurea was replaced with N,N′-dibenzylurea.

¹H-NMR (300 MHz, DMSO-d₆), δ: 7.25-7.06 (m, 13H), 6.92 (d, 2H), 4.85 (m, 4H), 4.31 (t, 1H), 3.35 (d, 2H)

Melting point: 113° C.

### Synthesis Example 7

### Synthesis of Exemplified Compound (A-19)

Exemplified compound (A-19) was synthesized in the same manner as Synthesis Example 2, except that N-benzyl-N′-phenylurea was replaced with N,N′-dicyclohexylurea.

¹H-NMR (300 MHz, DMSO-d₆), δ: 7.22 (m, 3H), 7.01 (m, 2H), 4.36 (m, 2H), 3.92 (t, 1H), 3.26 (d, 2H), 2.11-1.92 (m, 4H), 1.78-1.00 (m, 16H)

### Synthesis Example 8

### Synthesis of Exemplified Compound (A-6)

Exemplified compound (A-6) was synthesized in the same manner as Synthesis Example 1, except that N-benzyl-N′-phenylurea was replaced with N-phenyl-N′-phenethylurea.

### Synthesis Example 9

### Synthesis of Exemplified Compounds (A-14) and (A-21)

Exemplified compounds (A-14) and (A-21) were synthesized in the same manner as Synthesis Example 2, except that N-benzyl-N′-phenylurea was replaced with N-benzyl-N′-cyclohexylurea or N-diphenylmethylurea.

The compounds used in Examples other than the compounds mentioned above were synthesized according to the method similar to the above-described method, the method described in the literatures mentioned above, or a method similar to these method.

### Example 1

In the following manner, a cellulose acylate film was prepared and an optical film coloration over time thereof was evaluated in terms of light resistance.

### (Preparation of Cellulose Acylate)

Cellulose acylate having 2.87 of total acetyl substitution degree (B) was prepared. In this preparation, sulfuric acid (7.8 parts by mass with respect to 100 parts by mass of cellulose) was added as a catalyst, and a carboxylic acid used as a source of an acyl substituent was added, and the mixture was subjected to acylation reaction at 40° C. Further, after acylation, ripening was conducted at 40° C. Further, a low molecular component part of the cellulose acylate was washed and removed with acetone.

### (Preparation of Dope Liquid for Surface Layer at the Air Side)

### Preparation of Cellulose Acylate Solution

The following composition was poured into a mixing tank, and each of components was dissolved by stirring to prepare a cellulose acylate solution.

Composition of cellulose acylate solution

| | |
|---|---|
| Cellulose acetate having 2.87 of total acetyl | 100.0 parts by mass |
| substitution degree (B) and 370 of polymerization | |
| degree | |
| MONOPET (registered trademark) SB | 9.0 parts by mass |
| (plasticizer) manufactured by Dai-Ichi | |
| Kogyo Seiyaku Co., Ltd. | |
| SAIB-100 (plasticizer) manufactured by | 3.0 parts by mass |
| Eastman Chemical Company | |
| Methylene chloride (first solvent) | 353.9 parts by mass |
| Methanol (second solvent) | 89.6 parts by mass |
| n-Butanol (third solvent) | 4.5 parts by mass |

MONOPET (registered trademark) SB manufactured by Dai-Ichi Kogyo Seiyaku Co., Ltd. is a benzoic acid sucrose ester, and the SAIB-100 manufactured by Eastman Chemical Company is an acetic acid/isobutyric acid sucrose ester.

### Preparation of Matting Agent Solution

The following composition was poured into a dispersing machine, and each of components was dissolved by stirring to prepare a matting agent solution.

Composition of matting agent solution

| | |
|---|---|
| Silica particles having an average particle | 2.0 parts by mass |
| size of 20 nm (AEROSIL R972, manufactured by | |
| Nippon Aerosil Co., Ltd) | |
| Methylene chloride (first solvent) | 69.3 parts by mass |
| Methanol (second solvent) | 17.5 parts by mass |
| n-Butanol (third solvent) | 0.9 parts by mass |
| Cellulose acylate solution | 0.9 parts by mass |

### Preparation of Ultraviolet Absorber Solution

The following composition was poured into a mixing tank, and each of components was dissolved by heating and stirring to prepare an ultraviolet absorber solution.

Composition of ultraviolet absorber solution

| | |
|---|---|
| Following ultraviolet absorber (UV-1) | 20.0 parts by mass |
| Methylene chloride (first solvent) | 61.0 parts by mass |
| Methanol (second solvent) | 15.4 parts by mass |
| n-Butanol (third solvent) | 0.8 parts by mass |
| Cellulose acylate solution | 12.8 parts by mass |

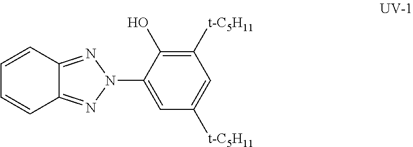

1.3 parts by mass of the above-mentioned matting agent solution and 3.4 parts by mass of the ultraviolet absorber solution were filtered respectively, and then mixed using an in-line mixer. In addition, 95.3 parts by mass of the cellulose acylate solution was added and mixed using the in-line mixer, to prepare the solution for surface layer.

### (Preparation of Dope Liquid for Base Layer)

### Preparation of Cellulose Acylate Solution

The following composition was poured into a mixing tank, and each of components was dissolved by stirring to prepare a dope liquid for base layer.

Composition of cellulose acylate solution

| | |
|---|---|
| Cellulose acetate having 2.87 of total acetyl | 100.0 parts by mass |
| substitution degree (B) and 370 of polymerization | |
| degree | |
| MONOPET (registered trademark) SB | 9.0 parts by mass |
| (plasticizer) manufactured by Dai-Ichi | |
| Kogyo Seiyaku Co., Ltd. | |
| SAIB-100 (plasticizer) manufactured by | 3.0 parts by mass |
| Eastman Chemical Company | |
| Exemplified compound (A-1) | 4.0 parts by mass |
| Following ultraviolet absorber (UV-1) | 2.0 parts by mass |
| Methylene chloride (first solvent) | 297.7 parts by mass |
| Methanol (second solvent) | 75.4 parts by mass |
| n-Butanol (third solvent) | 3.8 parts by mass |

### (Casting)

The dope liquid for base layer prepared as the above and, at both sides thereof, the dope liquid for surface layer at the air side was casted uniformly on a casting stainless support (support temperature: −9° C.) from a casting nozzle using a dram casting apparatus so that three layers of these dope liquids were casted at the same time. Then, the formed film was peel off on the condition that the amount of a residual solvent in the dope of each layer was about 70% by mass, and then both ends of the film in the width direction were fixed with a pin tenter, and then the film was dried while stretching 1.28 times (28%) in the width direction on the condition that the amount of a residual solvent was from 3 to 5% by mass. After that, the film was further dried by letting it transport between rolls of the heat treatment apparatus to obtain the cellulose acylate film 101 of the present invention. The thickness of the obtained cellulose acylate film 101 was 60 μm, and the width thereof was 1,480 mm.

The cellulose acylate films 102 to 117 of the present invention and comparative cellulose acylate films c10 to c13 were produced respectively in the same manner as the cellulose acylate film 101, except that Exemplified compound A-1 in the above-described cellulose acylate film 101 was changed so as to conform to the kind and addition amount of the compounds shown in Tables 6 and 7.

Further, the cellulose acylate film 131 of the present invention was obtained in the same manner as the above-described cellulose acylate film 101, except that the casting and the drying were carried out so that the film thickness and the width of the cellulose acylate film to be obtained became respectively 40 μm and 1,480 mm. The cellulose acylate films 132 to 135 of the present invention and the comparative cellulose acylate film c21 were produced respectively in the same manner as the cellulose acylate film 131, except that Exemplified compound A-1 in the cellulose acylate film 131 was changed so as to conform to the kind of the compounds shown in Table 6 and 7.

Further, the cellulose acylate film 141 of the present invention was obtained in the same manner as the above-described cellulose acylate film 101, except that the casting and the drying were carried out so that the film thickness and the width of the cellulose acylate film to be obtained became respectively 25 μm and 1,480 mm. The cellulose acylate films 142 to 145 of the present invention and the comparative cellulose acylate film c22 were produced respectively in the same manner as the cellulose acylate film 141, except that Exemplified compound A-1 in the cellulose acylate film 141 was changed so as to conform to the kind of the compounds shown in Table 6 and 7.

The cellulose acylate film 201 of the present invention was produced in the same manner as the cellulose acylate film 101, except that 12 parts by mass of the following polycondensation polymer (A) which was a polycondensation ester-based plasticizer was added in place of the MONOPET (registered trademark) SB and SAIB-100. The cellulose acylate films 202 to 205 of the present invention and comparative cellulose acylate films c30 to c33 were produced respectively in the same manner as the cellulose acylate film 201, except that Exemplified compound A-1 in the cellulose acylate film 201 was changed so as to conform to the kind of the compound shown in Table 7.

Polycondensation polymer (A): polyester obtained from adipic acid and ethane diol (the end thereof is a hydroxy group) (number-average molecular weight=1,000)

Further, cellulose acylate film 301 of the present invention was obtained in the same manner as the cellulose acylate film 101, except that 100 parts by mass of cellulose acetate having the total acetyl substitution degree (B) of 2.77 was added in place of cellulose acetate having the total acetyl substitution degree (B) of 2.87 in the cellulose acylate film 101. The cellulose acylate films 302, 311 to 312 of the present invention and the comparative cellulose acylate films c40 and c42 were produced respectively in the same manner as the cellulose acylate film 301, except that the kind of the exemplified compound and the plasticizer to be added to the cellulose acylate film 301 were changed as shown in Table 7 described below.

Further, cellulose acylate film 303 of the present invention was obtained in the same manner as the cellulose acylate film 101, except that 100 parts by mass of cellulose acetate having the total acetyl substitution degree (B) of 2.93 was added in place of cellulose acetate having the total acetyl substitution degree (B) of 2.87 in the above-described cellulose acylate film 101. The cellulose acylate films 304, 313 to 314 of the present invention and the comparative cellulose acylate films c41 and c43 were produced respectively in the same manner as the cellulose acylate film 303, except that the kind of the exemplified compound and the plasticizer to be added to the cellulose acylate film 303 were changed as shown in Table 7 described below.

In each of the cellulose acylate films, evaluation of the optical film coloration was carried out.

The obtained results are shown together with the results of Example 2 in Tables 6 and 7 described below.

Hereinafter, these cellulose acylate films are also referred to as a polarizing plate protective film.

### (Evaluation of Optical Film Coloration Over Time)

To each cellulose acylate film prepared as described above, light irradiation was carried out for 120 hours under the conditions of irradiance: 150 W/m², black panel temperature: 63° C. and relative humidity: 50% using a super xenone weathermeter (trade name: SX75, manufactured by Suga Test Instruments Co., Ltd.). Then, the hue b* of each film was measured using a spectrophotometer UV3150 manufactured by Shimadzu Corporation. As the hue b* value increases in the negative direction, the transmitted light becomes more bluish, while as the hue b* value increases in the positive direction, a yellow color increases.

Further, an absolute value of change in b*of each cellulose acylate film before and after the above-described light irradiation was expressed by Δb* and was used as an index of the optical film coloration over time.

The thus-obtained cellulose acylate films were evaluated according to the following criteria.

A:Δb* was 0.05 or less.
B:Δb* was more than 0.05 and 0.10 or less.
C:Δb* was more than 0.10 and 0.15 or less.
D:Δb* was more than 0.15.

The obtained results are shown together in Tables 6 and 7 described below.

### Example 2

A polarizing plate was prepared as described below using the cellulose acylate film prepared in Example 1 to evaluate a durability of the polarizing plate. Further, an optical film having a hard coat layer was prepared to evaluate lightfast adhesion property.

### (Saponification Treatment of Polarizing Plate Protective Film)

The polarizing plate protective film composed of the cellulose acylate film 101 produced in Example 1 was soaked in a 2.3 mol/L sodium hydroxide aqueous solution at 55° C. for 3 minutes. The film was then washed in a water-washing bath tank at room temperature and neutralized with 0.05 mol/L sulfuric acid at 30° C. The film was again washed in a water-washing bath tank at room temperature and further dried by warm air at 100° C. Each polarizing plate protective film was subjected to saponification treatment in such manner.

### (Preparation of Polarizing Plate)

A polarizer was prepared by adsorbing iodine onto a stretched polyvinyl alcohol film.

The polarizing plate protective film 101 having been produced in Example 1 and subjected to the above-described saponification treatment was stuck to one side of the polarizer, with a polyvinyl alcohol-based adhesive. A commercially-available cellulose triacetate film (FUJITAC TD80 UF, manufactured by Fujifilm Corporation) was subjected to the same saponification treatment. Together with a polyvinyl alcohol-based adhesive, the above-described commercially-available cellulose triacetate film after the saponification treatment was stuck to the side of the polarizer which is opposite to the side to which the saponified polarizing plate protective film 101 has been stuck.

At this time, the transmission axis of the polarizer and the slow axis of the polarizing plate protective film prepared in Example 1 and having been subjected to a saponification treatment were disposed so that they were parallel to one another. Further, the transmission axis of the polarizer and the slow axis of the commercially-available cellulose triacetate film having been subjected to a saponification treatment were disposed so that they were perpendicular to one another.

Thus, the polarizing plate 101 of the present invention was produced.

Also with respect to each of the polarizing plate protective films 102 to 117, 131 to 135, 141 to 145, 201 to 205, 301 to 304, 311 to 314 of the present invention and the comparative polarizing plate protective films c10 to c13, c21, c22, c30 to c33 and c40 to c43 the saponification treatment and the preparation of polarizing plate were conducted in the same manner as the above described, whereby each of polarizing plates 102 to 117, 131 to 135, 141 to 145, 201 to 205, 301 to 304, 311 to 314 of the present invention and comparative polarizing plates c10 to c13, c21, c22, c30 to c33 and c40 to c43 was produced.

### (Evaluation of Durability of Polarizing Plate)

In the present invention, the orthogonal transmissivity CT of the polarizing plate was measured at the wavelength of 410 nm or 510 nm by the following method using an automatic polarizing film measurement device VAP-7070 manufactured by JASCO Corporation.

Two samples (5 cm×5 cm) having the polarizing plate of the present invention attached on a glass through an adhesive were prepared. In this case, the polarizing plate was attached so that the polarizing plate protective film of the present invention was positioned in the side opposite to the substrate (air interface). Measurement of the orthogonal transmissivity was carried out by setting the glass side of the sample so that it faces toward a light source. Two samples are measured respectively and an average of the measured values is designated as the orthogonal transmissivity CT.

Then, after each polarizing plate was subjected to storage over time under the conditions depending on a film thickness of the film, the orthogonal transmissivity CT was measured in the same manner. A change of the orthogonal transmissivity CT between before and after storage over time was measured. Then, a rate of change was calculated from (amount of change of orthogonal transmissivity CT between before and after storage over time/orthogonal transmissivity CT before storage over time)×100. The rate of change was evaluated in accordance with the following criteria in terms of a durability of the polarizing plate.

The relative humidity under the environment with no humidity conditioning was in the range of from 0 to 20% RH.

### —Condition of Storage Over Time—

Samples 101 to 117, 201 to 205, 301 to 304, 311 to 314, c10 to c13, c30 to c33 and c40 to c43: 168 hours and 336 hours under the circumstance of 80° C. and relative humidity: 90% Samples 131 to 135 and c21: 120 hours and 240 hours under the circumstance of 80° C. and relative humidity: 90% Samples 141 to 145 and c22: 500 hours and 1,000 hours under the circumstance of 60° C. and relative humidity: 95%
A: The change of the orthogonal transmissivity CT before and after storage over time was less than 0.6%.
B: The change of the orthogonal transmissivity CT before and after storage over time was from 0.6 to 1.0%.
C: The change of the orthogonal transmissivity CT before and after storage over time was more than 1.0%.

Among the obtained results, the evaluation results in the longest period of time of each of the conditions of storage over time are summarized in Tables 6 and 7 below.

(Preparation of Optical Film with Hard Coat Layer)

Components described in the following table were mixed, followed by filtration by a polypropylene filter having a pore diameter of 30 μm to prepare the coating liquid for a hard coat layer.

Composition of hard coat layer solution

| | |
|---|---|
| Monomer pentaerythritol triacrylate/pentaerythritol | 53.5 parts by mass |
| tetraacrylate (mixing mass ratio: 3/2) | |
| UV initiator Irgacure ™ 907 (manufactured | 1.5 parts by mass |
| by BASF) | |
| Ethyl acetate | 45 parts by mass |

On each cellulose acylate film prepared in Example 1, the coating liquid for a hard coat layer was coated by a microgravure coating method under the condition of transportation velocity of 30 m/min. After drying at 60° C. for 150 seconds, the coated layer was cured by irradiating an ultraviolet thereon at an luminance of 400 mW/cm² and an irradiation dose of 150 mJ/cm² by using an air cooled metal halide lamp (manufactured by Eye Graphics Co., Ltd.) of 160 W/cm under nitrogen purge (an oxygen concentration of 0.5% or less) to form a hard coat layer (thickness 6 μm).

By forming the hard coat layer on each cellulose acylate film in this way, cellulose acylate films with a hard coat layer were each prepared.

It is noted that, in the following Tables 6 and 7, a unilaminate optical film Nos. and an optical film Nos. with a hard coat layer corresponding to the unilaminate optical film are shown by putting the common film Nos. to them.

### (Evaluation of Lightfast Adhesion Property)

First, the polarizing plate protective films having a hard coat layer of Examples and Comparative Examples thus manufactured were irradiated with light for 96 hours under the environment of 60° C. and 50% RH using a super xenon weather meter SX75 manufactured by Suga Test Instruments Co., Ltd.

Subsequently, each of the polarizing plate protective films having a hard coat layer was humidity-controlled under the condition of 25° C. and 60% RH for 2 hours. On the surface of a side having a hard coat layer, 11 horizontal cuts and 11 vertical cuts were made on a grid at each of 1 mm intervals using a cutter knife, with respect to 1 cm square of the polarizing plate protective film with the hard coat layer, whereby a total of 100 square lattices of 1 mm×1 mm was incised. Further, a polyester adhesive tape (No. 31B) manufactured by Nitto Denko Corporation was attached on the surface thereof. After 30 minutes, the tape was rapidly peeled off in a vertical direction, and the number of peeled lattices was counted for evaluation based on four criteria below. The same adhesion evaluation tests were performed three times to obtain an average.

A: Peeling was identified on 10 or less of 100 lattices.
B: Peeling was identified on 11 to 20 of 100 lattices.
C: Peeling was identified on 21 to 30 of 100 lattices.
D: Peeling was identified on 31 or more of 100 lattices.

The obtained results are shown together in Tables 6 and 7 described below.

It is noted that, in Tables 6 and 7, MONOPET SB is MONOPET (registered trademark) SB (a plasticizer), manufactured by Dai-Ichi Kogyo Seiyaku Co., Ltd. and SAIB is SAIB-100 (a plasticizer), manufactured by Eastman Chemical Company.

TABLE 6

| | Cellulose | | | | | | | | | |
|---|---|---|---|---|---|---|---|---|---|---|
| | acylate | Film | Additives | | | | | Dura- | | |
| | Total acetyl | thick- | | | | Addi- | Color- | bility of | Lightfast adhesion | |
| | subsitution | ness | Com- | Addition | | tion | ation | polarizing | property | |
| No. | degree (B) | (μm) | pound | amount a) | Plasticizer | amount a) | over time | plate | (hard coat layer) | Remarks |
| 101 | 2.87 | 60 | A-1 | 4 | MONOPET | 9.0/3 0 | B | A | B | Present |
| | | | | | SB/SAIB | | | | | invention |
| 102 | 2.87 | 60 | A-2 | 4 | MONOPET | 9 0/3.0 | B | A | A | Present |
| | | | | | SB/SAIB | | | | | invention |
| 103 | 2.87 | 60 | A-3 | 4 | MONOPET | 9.0/3.0 | A | A | B | Present |
| | | | | | SB/SAIB | | | | | invention |
| 104 | 2.87 | 60 | A-4 | 4 | MONOPET | 9.0/3.0 | B | A | A | Present |
| | | | | | SB/SAIB | | | | | invention |
| 105 | 2.87 | 60 | A-5 | 4 | MONOPET | 9.0/3.0 | A | A | A | Present |
| | | | | | SB/SAIB | | | | | invention |
| 106 | 2.87 | 60 | A-6 | 4 | MONOPET | 9.0/3.0 | A | A | A | Present |
| | | | | | SB/SAIB | | | | | invention |
| 107 | 2.87 | 60 | A-14 | 4 | MONOPET | 9.0/3.0 | A | A | B | Present |
| | | | | | SB/SAIB | | | | | invention |
| 108 | 2.87 | 60 | A-19 | 4 | MONOPET | 9.0/3.0 | A | A | A | Present |
| | | | | | SB/SAIB | | | | | invention |
| 109 | 2.87 | 60 | A-21 | 4 | MONOPET | 9.0/3.0 | A | A | B | Present |
| | | | | | SB/SAIB | | | | | invention |
| 110 | 2.87 | 60 | A-1 | 2 | MONOPET | 9.0/3.0 | B | A | B | Present |
| | | | | | SB/SAIB | | | | | invention |
| 111 | 2.87 | 60 | A-1 | 1 | MONOPET | 9.0/3.0 | A | B | A | Present |
| | | | | | SB/SAIB | | | | | invention |
| 112 | 2.87 | 60 | A-2 | 2 | MONOPET | 9.0/3.0 | A | A | A | Present |
| | | | | | SB/SAIB | | | | | invention |
| 113 | 2.87 | 60 | A-2 | 1 | MONOPET | 9.0/3.0 | A | B | A | Present |
| | | | | | SB/SAIB | | | | | invention |
| 114 | 2.87 | 60 | A-3 | 2 | MONOPET | 9.0/3.0 | A | A | A | Present |
| | | | | | SB/SAIB | | | | | invention |
| 115 | 2.87 | 60 | A-3 | 6 | MONOPET | 9.0/3.0 | A | A | A | Present |
| | | | | | SB/SAIB | | | | | invention |
| 116 | 2.87 | 60 | A-5 | 2 | MONOPET | 9.0/3.0 | A | A | A | Present |
| | | | | | SB/SAIB | | | | | invention |
| 117 | 2.87 | 60 | A-5 | 6 | MONOPET | 9.0/3.0 | A | A | A | Present |
| | | | | | SB/SAIB | | | | | invention |
| 131 | 2.87 | 40 | A-1 | 4 | MONOPET | 9.0/3.0 | B | A | B | Present |
| | | | | | SB/SAIB | | | | | invention |
| 132 | 2.87 | 40 | A-2 | 4 | MONOPET | 9.0/3.0 | B | A | A | Present |
| | | | | | SB/SAIB | | | | | invention |
| 133 | 2.87 | 40 | A-3 | 4 | MONOPET | 9.0/3.0 | A | A | B | Present |
| | | | | | SB/SATB | | | | | invention |
| 134 | 2.87 | 40 | A-4 | 4 | MONOPET | 9.0/3.0 | B | A | A | Present |
| | | | | | SB/SAIB | | | | | invention |
| 135 | 2.87 | 40 | A-5 | 4 | MONOPET | 9.0/3.0 | A | A | A | Present |
| | | | | | SB/SAIB | | | | | invention |
| 141 | 2.87 | 25 | A-1 | 4 | MONOPET | 9.0/3.0 | B | A | B | Present |
| | | | | | SB/SAIB | | | | | invention |
| 142 | 2.87 | 25 | A-2 | 4 | MONOPET | 9.0/3.0 | A | B | A | Present |
| | | | | | SB/SATB | | | | | invention |
| 143 | 2.87 | 25 | A-3 | 4 | MONOPET | 9.0/3.0 | A | A | B | Present |
| | | | | | SB/SAIB | | | | | invention |
| 144 | 2.87 | 25 | A-4 | 4 | MONOPET | 9.0/3.0 | B | A | A | Present |
| | | | | | SB/SAIB | | | | | invention |
| 145 | 2.87 | 25 | A-5 | 4 | MONOPET | 9.0/3.0 | A | B | A | Present |
| | | | | | SB/SAIB | | | | | invention |

TABLE 7

| | Cellulose | | | | | | | | | |
|---|---|---|---|---|---|---|---|---|---|---|
| | acylate | Film | Additives | | | | | Dura- | | |
| | Total acetyl | thick- | | | | Addi- | Color- | bility of | Lightfast | |
| | subsitution | ness | Com- | Addition | | tion | ation | polarizing | property | |
| No. | degree (B) | (μm) | pound | amount a) | Plasticizer | amount a) | over time | plate | (hard coat layer) | Remarks |
| 201 | 2.87 | 60 | A-1 | 4 | Polycondensation | 12 | B | A | B | Present |
| | | | | | polymer (A) | | | | | invention |
| 202 | 2.87 | 60 | A-2 | 4 | Polycondensation | 12 | B | A | A | Present |
| | | | | | polymer (A) | | | | | invention |
| 203 | 2.87 | 60 | A-3 | 4 | Polycondensation | 12 | A | A | B | Present |
| | | | | | polymer (A) | | | | | invention |
| 204 | 2.87 | 60 | A-4 | 4 | Polycondensation | 12 | B | A | A | Present |
| | | | | | polymer (A) | | | | | invention |
| 205 | 2.87 | 60 | A-5 | 4 | Polycondensation | 12 | A | A | A | Present |
| | | | | | polymer (A) | | | | | invention |
| 301 | 2.77 | 60 | A-1 | 4 | MONOPET | 9.0/3.0 | B | A | B | Present |
| | | | | | SB/SAIB | | | | | invention |
| 302 | 2.77 | 60 | A-3 | 4 | MONOPET | 9.0/3.0 | A | A | B | Present |
| | | | | | SB/SAIB | | | | | invention |
| 303 | 2.93 | 60 | A-2 | 4 | MONOPET | 9.0/3 0 | B | A | A | Present |
| | | | | | SB/SAIB | | | | | invention |
| 304 | 2.93 | 60 | A-4 | 4 | MONOPET | 9.0/3.0 | B | A | A | Present |
| | | | | | SB/SAIB | | | | | invention |
| 311 | 2.77 | 60 | A-2 | 4 | Polycondensation | 12 | B | A | A | Present |
| | | | | | polymer (A) | | | | | invention |
| 312 | 2.77 | 60 | A-5 | 4 | Polycondensation | 12 | A | A | A | Present |
| | | | | | polymer (A) | | | | | invention |
| 313 | 2.93 | 60 | A-1 | 4 | Polycondensation | 12 | B | A | B | Present |
| | | | | | polymer (A) | | | | | invention |
| 314 | 2.93 | 60 | A-3 | 4 | Polycondensation | 12 | A | A | B | Present |
| | | | | | polymer (A) | | | | | invention |
| c10 | 2.87 | 60 | H-A | 4 | MONOPET | 9.0/3.0 | D | A | D | Comparative |
| | | | | | SB/SAIB | | | | | Example |
| c11 | 2.87 | 60 | H-1 | 4 | MONOPET | 9.0/3.0 | D | A | D | Comparative |
| | | | | | SB/SAIB | | | | | Example |
| c12 | 2.87 | 60 | H-2 | 4 | MONOPET | 9.0/3.0 | D | A | D | Comparative |
| | | | | | SB/SAIB | | | | | Example |
| c13 | 2.87 | 60 | None | — | MONOPET | 9.0/3.0 | A | C | A | Comparative |
| | | | | | SB/SAIB | | | | | Example |
| c21 | 2.87 | 60 | None | — | MONOPET | 9.0/3.0 | A | C | A | Comparative |
| | | | | | SB/SAIB | | | | | Example |
| c22 | 2.87 | 25 | None | — | MONOPET | 9.0/3.0 | A | C | A | Comparative |
| | | | | | SB/SAIB | | | | | Example |
| c30 | 2.87 | 60 | H-A | 4 | Polycondensation | 12 | D | A | D | Comparative |
| | | | | | polymer (A) | | | | | Example |
| c31 | 2.87 | 60 | H-1 | 4 | Polycondensation | 12 | D | A | D | Comparative |
| | | | | | polymer (A) | | | | | Example |
| c32 | 2.87 | 60 | H-2 | 4 | Polycondensation | 12 | D | A | D | Comparative |
| | | | | | polymer (A) | | | | | Example |
| c33 | 2.87 | 60 | None | — | Polycondensation | 12 | A | C | A | Comparative |
| | | | | | polymer (A) | | | | | Example |
| c40 | 2.77 | 60 | None | — | MONOPET | 9.0/3.0 | A | C | A | Comparative |
| | | | | | SB/SAIB | | | | | Example |
| c41 | 2.93 | 60 | None | — | MONOPET | 9.0/3.0 | A | C | A | Comparative |
| | | | | | SB/SAIB | | | | | Example |
| c42 | 2.77 | 60 | None | — | Polycondensation | 12 | A | C | A | Comparative |
| | | | | | polymer (A) | | | | | Example |
| c43 | 2.93 | 60 | None | — | Polycondensation | 12 | A | C | A | Comparative |
| | | | | | polymer (A) | | | | | Example |

a): part(s) by mass with respect to 100 parts by mass of cellulose acylate.

Herein, H-A, H-1 and H-2 in Tables 6 and 7 are the following compounds.

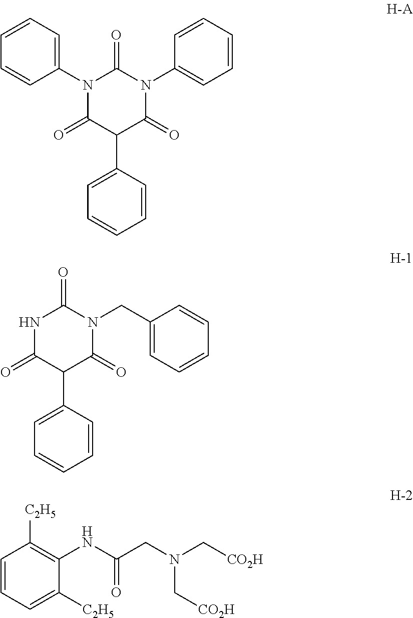 [SMILES: O=C1C(c2ccccc2)C(=O)N(c2ccccc2)C(=O)N1c1ccccc1 ; O=C1NC(=O)N(Cc2ccccc2)C(=O)C1c1ccccc1 ; CCc1cccc(CC)c1NC(=O)CN(CC(=O)O)CC(=O)O]

From the results of the above-described Tables 6 and 7, each of the polarizing plates using a polarizing plate protective film of the cellulose acylate film of the present invention containing the compound represented by Formula (I) in the present invention exhibited an excellent durability of the polarizing plate over time regardless of a total acetyl substitution degree (B), so that deterioration of the polarizer was able to be effectively suppressed. Further, in each of the cellulose acylate films of the present invention, optical coloration over time and lowering of lightfast adhesion property to the hard coat layer were suppressed. Further, it was confirmed that these performances were able to be maintained even in the case where the film thickness of the cellulose acylate film was lowered.

In contrast, each of the polarizing plate protective films c10 to c12 and c30 to c32 of the cellulose acylate films containing H-A, H-1 or H-2 of the above-described comparative compounds exhibited inferior suppression of the optical coloration over time compared to the polarizing plate protective film of the present invention, so that a balance between suppression of the optical coloration over time and a durability of the polarizing plate when the cellulose acylate films was formed into a polarizing plate was not achieved. Further, each of the cellulose acylate films c10 to c12 and c30 to c32 with a hard coat layer in which the hard layer, in which the hard coat layer was coated on the polarizing plate protective films to which the comparative compounds were added, exhibited inferior lightfast adhesion property to the hard coat layer compared to the polarizing plate protective film of the present invention, so that a balance between the lightfast adhesion property and a durability of the polarizing plate when the cellulose acylate film was formed into a polarizing plate was not achieved.

Each of the polarizing plate protective films c13, c21, c22, c33 and c40 to c43 of the comparative cellulose acylate films containing neither the compound represented by Formula (I) in the present invention nor the comparative compound exhibited inferior durability of the polarizing plate when the cellulose acylate film was formed into a polarizing plate, when compared to the polarizing plate protective film of the cellulose acylate film of the present invention.

As a result, application of the polarizing plate using the cellulose acylate film of the present invention allows preparation of a liquid crystal display exhibiting such excellent performances as shown above.

### Example 3

### Evaluation of Metal Corrosiveness of Compound

Evaluation of metal corrosiveness of the compound represented by Formula (I) in the present invention was carried out as follows.

### (Evaluation Relating to Metal Corrosiveness)

In a pressure tight container, 20 g of a solution in which each compound had been dissolved in a concentration of 1% by mass with respect to a mixed solvent to be used in preparation of a dope for the base layer was weighed and a 0.5 cm-thick test specimen of SUS316 cut into the size of 2 cm width×3 cm length was soaked therein. The pressure tight container was closed tightly and after being kept for 70 hours at 90° C., the lid of the pressure tight container was opened, and the corrosiveness of the test specimen and change of the organic acid solution due to corrosion were observed to evaluate them according to the following criteria.

A: There was no change in smoothness of the test specimen surface, and the solution was colorless or pale yellow, and no insoluble matter was found.
B: A change in smoothness of the test specimen surface was small, but the solution was yellowed.
C: The test specimen surface was textured, and the solution was brownish-red and turbid.

The obtained results are shown in Table 8 described below.

TABLE 8

| | Result of evaluation of | |
|---|---|---|
| Kind | metal corrosiveness | Remarks |
| A-1 | A | Present invention |
| A-2 | A | Present invention |
| A-3 | A | Present invention |
| A-4 | A | Present invention |
| A-5 | A | Present invention |
| A-6 | A | Present invention |
| A-14 | A | Present invention |
| A-19 | A | Present invention |
| A-21 | A | Present invention |
| H-1 | A | Comparative Example |
| H-2 | B | Comparative Example |
| None | B | Comparative Example |

From the results of the above Table 8, in contrast to the compound represented by Formula (I) in the present invention, which has an excellent inhibitory effect on the metal corrosiveness, the comparative organic acid H-12 is insufficient for inhibitory effect on the metal corrosiveness, and therefore there are concerns of deterioration of the production equipment and contamination of impurities due to the corrosion into the film.

In this way, from the results of Tables 6 and 7 as well as the above Table 8, it is seen that the compound represented by Formula (I) in the present invention has a beneficial effect on improvement in durability of the polarizing plate and suppression of coloration and at the same time has an advantage of stabilization during the production process.

### Example 4

Polarizing plates were prepared as described below and the durability thereof was evaluated.

### (Preparation of Cellulose Acylate Solution 401)

The following composition was poured into a mixing tank, and each of components was dissolved by stirring to prepare a cellulose acylate solution 401.

Composition of cellulose acylate solution 401

| | |
|---|---|
| Cellulose acetate having 2.87 of acetyl substitution | 100.0 parts by mass |
| degree and 370 of polymerization degree | |
| Plasticizer: Polycondensate | 10.0 parts by mass |
| of phthalic acid/ethanediol (hydrophobizing agent 1) | |
| The end thereof is an acetate ester group and the | |
| number-average molecular weight thereof is 800. | |
| Methylene chloride (first solvent) | 389.8 parts by mass |
| Methanol (second solvent) | 58.2 parts by mass |

### (Preparation of Matting Agent Solution 402)

The following composition was poured into a dispersing machine, and each of components was dissolved by stirring to prepare a matting agent solution 402.

Composition of matting agent solution 402

| | |
|---|---|
| Silica particles having an average particle | 2.0 parts by mass |
| size of 20 nm (AEROSIL R972, manufactured by | |
| Nippon Aerosil Co., Ltd) | |
| Methylene chloride (first solvent) | 75.5 parts by mass |
| Methanol (second solvent) | 11.3 parts by mass |
| Cellulose acylate solution 401 | 0.9 parts by mass |

### (Preparation of Durability of the Polarizing Plate-Improving Agent Solution 403)

The following composition was poured into a mixing tank, and each of components was dissolved by stirring to prepare a durability of the polarizing plate-improving agent solution 403.

Composition of durability of the polarizing
plate-improving agent solution 403

| | |
|---|---|
| Exemplified compound (A-3) | 20.0 parts by mass |
| Reductone (L) | 1.0 parts by mass |
| Methylene chloride (first solvent) | 73.5 parts by mass |
| Methanol (second solvent) | 6.4 parts by mass |

The above-described Reductone (L) has the following structure and is L-Ascorbyl 6-Palmitate manufactured by Tokyo Chemical Industry Co., Ltd.

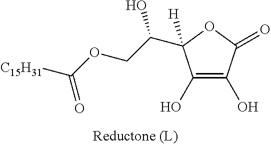

### (Preparation of Ultraviolet Absorber Solution 404)

The following composition was poured into a mixing tank, and each of components was dissolved by heating and stirring to prepare an ultraviolet absorber solution 404.

Composition of ultraviolet absorber solution 404

| | |
|---|---|
| Following ultraviolet absorber (UV-2) | 10.0 parts by mass |
| Methylene chloride (first solvent) | 78.3 parts by mass |
| Methanol (second solvent) | 11.7 parts by mass |

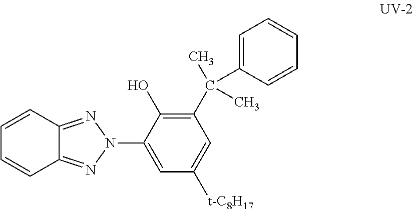

### <Casting>

1.3 parts by mass of the above-described matting agent solution 402, 3.3 parts by mass of the durability of the polarizing plate-improving agent solution 403, and 4.0 parts by mass of the ultraviolet absorber solution 404 were each subjected to a filtration, and then were mixed using an inline mixer, and further 91.4 parts by mass of the cellulose acylate solution 401 was added to the mixture and was nixed using the inline mixer to prepare a dope. Using a band casting device, the thus-prepared dope was casted on a casting support made from stainless steel (support temperature 22° C.). Then, the formed film was peeled off on the condition that the amount of a residual solvent in the dope was about 20% by mass, and then both ends of the film in the width direction were fixed with a tenter, and then the film was dried while stretching 1.10 (10%) times under a temperature of 120° C. in the width direction on the condition that the amount of a residual solvent was from 5 to 10% by mass. After that, the film was further dried by letting it transport between rolls of the heat treatment apparatus to obtain the cellulose acylate film 401. The thickness of the obtained cellulose acylate film was 23 μmm, and the width thereof was 1,480 mm.

Further, the cellulose acylate films 402 to 426 of the present invention were produced in the same manner as the cellulose acylate film 401, except that the kind and addition amount of Exemplified compound and the kind and addition amount of plasticizer in the above-described cellulose acylate film 401 was changed so as to conform to those shown in Table 9.

In addition, comparative cellulose acylate film c50 was produced respectively in the same manner as the cellulose acylate film 401, except that the durability of the polarizing plate-improving agent solution 403 was not mixed.

For the cellulose acylate films 401 to 426 and the comparative cellulose acylate film c50 prepared as described above, optical film coloration was evaluated in the same manner as Example 1. Further, polarizing plates were prepared using these cellulose acylate films to evaluate a durability of the polarizing plate in the same manner as Example 2. Further, optical films with a hard coat layer were prepared to evaluate lightfast adhesion property.

It is noted that evaluation of the durability of the polarizing plate was carried out under the following aging conditions. The obtained results were evaluated according to the following criteria.

### —Condition of Storage Over Time—

Samples 401 to 426 and c50: 500 hours under the environment of 60° C. and relative humidity: 95%
A+: The change of the orthogonal transmissivity CT before and after aging was less than 0.5%.
A: The change of the orthogonal transmissivity CT before and after aging was from 0.5% to less than 0.7%.
B: The change of the orthogonal transmissivity CT before and after aging was from 0.7% to less than 1.0%.
C: The change of the orthogonal transmissivity CT before and after aging was 1.0% or more.

The obtained results are shown together in Table 9 described below.

TABLE 9

| | | | | | | | | | Lightfast | |
|---|---|---|---|---|---|---|---|---|---|---|
| | Additives | | | | Plasticizer | | | Dura- | adhesion | |
| | | | | Addi- | | Addi- | Color- | bility of | property | |
| Film | Com- | Addition | Com- | tion | | tion | ation | polarizing | (hard coat | |
| No. | pound | amount ^{a)} | pound | amount ^{a)} | Kind | amount ^{a)} | over time | plate | layer) | Remarks |
| 401 | A-3 | 4 | Reductone L | 0.2 | Hydrophobizing | 10 | A | A+ | B | Present |
| | | | | | agent 1 | | | | | invention |
| 402 | A-2 | 4 | TINUVIN 123 | 0.2 | Hydrophobizing | 12 | A | B | A | Present |
| | | | | | agent 1 | | | | | invention |
| 403 | A-1 | 4 | TINUVIN 770 | 0.2 | Hydrophobizing | 10 | B | A | B | Present |
| | | | Citric acid | 0.02 | agent 1 | | | | | invention |
| 404 | A-5 | 8 | ADKSTAB LA-81 | 0.4 | Hydrophobizing | 10 | A | A | A | Present |
| | | | Poem K-37V | 0.1 | agent 1 | | | | | invention |
| 405 | A-3 | 4 | TINUVIN 123 | 0.2 | Hydrophobizing | 8 | A | A | B | Present |
| | | | Poem K-37V | 0.1 | agent 1 | | | | | invention |
| 406 | A-2 | 4 | ADKSTAB PEP-36 | 0.2 | MONOPET | 9.0/3.0 | A | B | A | Present |
| | | | Poem K-37V | 0.1 | SB/SAIB-100 | | | | | invention |
| 407 | A-4 | 2 | IRGANOX 1010 | 0.02 | MONOPET | 9.0/3.0 | B | B | A | Present |
| | | | Poem K-37V | 0.02 | SB/SAIB-100 | | | | | invention |
| 408 | A-2 | 1 | IRGANOX HP-136 | 0.05 | MONOPET | 9.0/3.0 | A | B | A | Present |
| | | | | | SB/SAIB-100 | | | | | invention |
| 409 | A-19 | 4 | IRGANOX MD1024 | 0.1 | MONOPET | 9.0/0.0 | A | B | A | Present |
| | | | TINUVIN 123 | 0.1 | SB/SAIB-100 | | | | | invention |
| 410 | A-3 | 4 | TINUVIN 123 | 02 | Hydrophobizing | 10 | A | A | B | Present |
| | | | Tecran DO | 0.02 | agent 1 | | | | | invention |
| 411 | A-5 | 4 | IRGANOX 1010 | 0.2 | Hydrophobizing | 10 | A | B | A | Present |
| | | | Stafoam DL | 0.02 | agent 1 | | | | | invention |
| 412 | A-1 | 4 | TINUVIN 152 | 0.15 | Hydrophobizing | 10 | B | A | B | Present |
| | | | Triazine compound | 0.02 | agent 1 | | | | | invention |
| | | | T-1 | | | | | | | |
| 413 | A-1 | 4 | Hydroxylamine | 0.1 | Hydrophobizing | 10 | B | A | B | Present |
| | | | compound H1 | | agent 1 | | | | | invention |
| 414 | A-2 | 4 | Hydroxylamine | 0.1 | Hydrophobizing | 10 | A | B | A | Present |
| | | | compound H2 | | agent 1 | | | | | invention |
| 415 | A-3 | 4 | TINUVIN 123 | 0.18 | Hydrophobizing | 10 | A | A | B | Present |
| | | | Triazine compound T-2 | 0.012 | agent 1 | | | | | invention |
| 416 | A-1 | 4 | TINUVIN 123 | 0.2 | Hydrophobizing | 10 | A | A | B | Present |
| | | | Chelest 3PA | 0.02 | agent 1 | | | | | invention |
| | | | Multivalent | 0.08 | | | | | | |
| | | | amine A | | | | | | | |
| 417 | A-3 | 4 | TINUVIN 123 | 0.2 | Hydrophobizing | 10 | A | A | B | Present |
| | | | Chelest PH-540 | 0.01 | agent 1 | | | | | invention |
| | | | Multivalent | 0.02 | | | | | | |
| | | | amine A | | | | | | | |
| 418 | A-5 | 4 | IRGANOX 1010 | 0.2 | Polycondensation | 12 | A | B | A | Present |
| | | | EPOMIN SP-006 | 0.02 | polymer (A) | | | | | invention |
| 419 | A-3 | 4 | TINUVIN 123 | 0.18 | Hydrophobizing | 10 | A | A | B | Present |
| | | | EPOMIN PP-061 | 0.024 | agent 1 | | | | | invention |
| 420 | A-4 | 4 | TINUVIN 123 | 0.2 | Hydrophobizing | 10 | B | A | A | Present |
| | | | Multivalent | 0.02 | agent 1 | | | | | invention |
| | | | amine A | | | | | | | |
| 421 | A-2 | 8 | Reductone L | 0.2 | Hydrophobizing | 10 | A | A+ | A | Present |
| | | | Multivalent | 0.005 | agent 1 | | | | | invention |
| | | | amine B | | | | | | | |
| 422 | A-5 | 4 | IRGANOX HP-136 | 0.1 | Hydrophobizing | 10 | A | B | A | Present |
| | | | NYMEEN L-202 | 0.001 | agent 1 | | | | | invention |
| 423 | A-1 | 4 | TINUVIN 123 | 01 | Polycondensation | 12 | B | A | B | Present |
| | | | Chelest PH-540 | 0.005 | polymer (A) | | | | | invention |
| | | | Amine C | 0.02 | | | | | | |
| 424 | A-3 | 4 | TINUVIN 123 | 0.18 | Hydrophobizing | 10 | A | A | B | Present |
| | | | Chelest PH-540 | 0.003 | agent 1 | | | | | invention |
| | | | EPOMIN PP-061 | 0.024 | | | | | | |
| 425 | A-3 | 6 | TINUVIN 123 | 0.27 | Hydrophobizing | 10 | A | A+ | B | Present |
| | | | Chelest PH-540 | 0.005 | agent 1 | | | | | invention |
| | | | EPOMIN PP-061 | 0.036 | | | | | | |
| 426 | A-3 | 4 | None | | Hydrophobizing | 10 | A | A | B | Present |
| | | | | | agent 1 | | | | | invention |
| c50 | None | — | | | Hydrophobizing | 10 | A | C | A | Comparative |
| | | | | | agent 1 | | | | | Example |

Here, newly used materials in the above Table 9 are as follows.

### [Used Materials]

Reductone L: L-Ascorbyl 6-Palmitate (manufactured by Tokyo Chemical Industry Co., Ltd.)

Triazine compound T-1: F-10 described in paragraph No. 0166 of JP-A-8-333325

Triazine compound T-2: A-8 described in paragraph No. 0039 of JP-A-8-194277

Hydroxylamine compound H1: A-50 described in paragraph No. 0026 of JP-A-8-62767

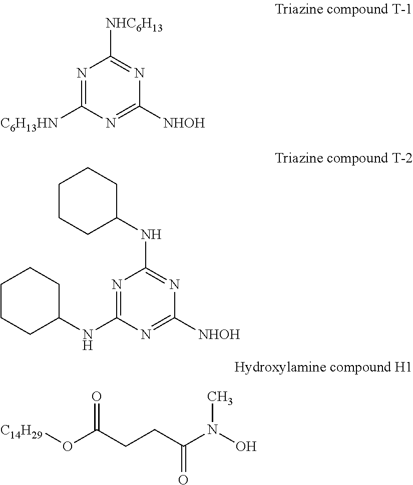

Hydroxylamine compound H2: dibenzylhydroxylamine (manufactured by Tokyo Chemical Industry Co., Ltd.)

Multivalent amine A: N,N,N′,N″,N″-pentakis(2-hydroxypropyl)diethylenetriamine (manufactured by Tokyo Chemical Industry Co., Ltd.)

Multivalent amine B: tetraethylenpentamin (manufactured by Tokyo Chemical Industry Co., Ltd.)

Amine C: Tri-n-octylamine (manufactured by Tokyo Chemical Industry Co., Ltd.)

Chelest 3PA manufactured by Chelest corporation

Chelest PH-540 manufactured by Chelest corporation

ADKSTAB PEP-36 manufactured by Adeka corporation

IRGANOX1010 manufactured by BASF

IRGANOX HP-136 manufactured by BASF

IRGANOX MD 1024 manufactured by BASF

TINUVIN 123 manufactured by BASF

TINUVIN 152 manufactured by BASF

TINUVIN 770 manufactured by BASF

ADKSTAB LA-81 manufactured by Adeka corporation

Tecran DO manufactured by Nagase ChemteX Corporation

Poem K-37V manufactured by RIKEN VITAMIN CO., LTD.

Stafoam DL manufactured by NOF CORPORATION

NYMEEN L-202 manufactured by NOF CORPORATION

EPOMIN SP-006 manufactured by NIPPON SHOKUBAI CO., LTD.

EPOMIN PP-061 manufactured by NIPPON SHOKUBAI CO., LTD.

Hydrophobizing agent 1: polycondensate of phthalic acid/ethane diol (the end thereof is an acetyl ester group and the number-average molecular weight thereof is 800)

Polycondensation polymer (A): polyester obtained from adipic acid and ethane diol (the end thereof is a hydroxyl group) (number-average molecular weight=1,000)

As shown in Table 9, the cellulose acylate films 401 to 426 of the present invention are excellent in film coloration over time and also deterioration of lightfast adhesion property to a hard coat layer was suppressed.

Further, in comparison with the polarizing plate using the comparative cellulose acylate film c50, a change of the orthogonal transmissivity CT between before and after storage over time of the polarizing plate using the cellulose acylate films 401 to 426 of the present invention was lowered, so that deterioration of the polarizing performances thereof was suppressed.

As a result, use of the polarizing plate of the present invention allows production of the liquid crystal display having such excellent performances as shown above.

Having described our invention as related to the present embodiments, it is our intention that the invention not be limited by any of the details of the description, unless otherwise specified, but rather be construed broadly within its spirit and scope as set out in the accompanying claims.

### REFERENCE SIGNS LIST

1 Dope for surface layer
2 Dope for core layer (base layer)
3 Co-casting Giesser
4 Casting support
21A, 21B Polarizing plate
22 Color filter substrate
23 Liquid crystal layer
24 Array substrate
25 Light guide plate
26 Light source
31a, 31b Cellulose acylate film (Polarizing plate protective film)
32 Polarizer

1. A cellulose acylate film, comprising at least:
a cellulose acylate; and
a compound represented by the following Formula (I): 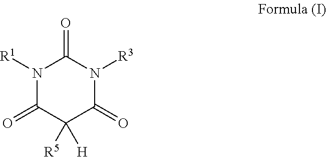
wherein R¹, R³ and R⁵ each independently designate a hydrogen atom, an alkyl group, a cycloalkyl group, an alkenyl group, or an aromatic group, which groups may have a further substituent; with the proviso that at least one of R¹, R³ and R⁵ is an allyl group substituted with a group having a ring structure or a cycloalkyl group, and the total number of the ring structures existing in R¹, R³ and R⁵ is 3 or more.

2. The cellulose acylate film according to claim 1,
wherein at least two of R¹, R³ and R⁵ are an alkyl group substituted further with a group having a ring structure as a substituent or a cycloalkyl group.

3. The cellulose acylate film according to claim 1,
wherein R⁵ is an alkyl group substituted further with a group having a ring structure as a substituent or a cycloalkyl group.

4. The cellulose acylate film according to claim 1,
wherein R¹ and R³ each independently designate an alkyl group which may have a further substituent or an aromatic group which may have a further substituent.

5. The cellulose acylate film according to claim 1,
wherein the cellulose acylate has a total acyl substitution degree “A” which is in the range represented by the following formula:
1.5≦A≦3.0

6. The cellulose acylate film according to claim 1,
wherein an acyl group of the cellulose acylate is an acetyl group, and the cellulose acylate has a total acetyl substitution degree “B” which is in the range represented by the following formula:
2.0≦B≦3.0

7. The cellulose acylate film according to claim 6,
wherein the total acetyl substitution degree “B” is 2.5 or more and less than 2.97.

8. The cellulose acylate film according to claim 1, comprising at least one polycondensation ester compound.

9. The cellulose acylate film according to claim 8,
wherein the polycondensation ester compound is a compound obtained by polycondensing at least one dicarboxylic acid represented by the following Formula (a) and at least one diol represented by the following Formula (b): 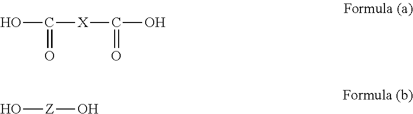
wherein,
in formula (a), X designates a divalent aliphatic group having 2 to 18 carbon atoms or a divalent aromatic group having 6 to 18 carbon atoms, and
in formula (b), Z designates a divalent aliphatic group having 2 to 8 carbon atoms.

10. The cellulose acylate film according to claim 8,
wherein the polycondensation ester compound has a number average molecular weight from 500 to 2,000.

11. The cellulose acylate film according to claim 8,
wherein the polycondensation ester compound has sealed terminals.

12. The cellulose acylate film according to claim 1, comprising: a monosaccharide or at least one carbohydrate compound containing 2 to 10 monosaccharide units.

13. The cellulose acylate film according to claim 12,
wherein the carbohydrate compound has an alkyl group, an aryl group, or an acyl group, as a substituent.

14. A polarizing plate, comprising at least:
the cellulose acylate film according to claim 1; and
a polarizer.

15. A liquid crystal display, comprising at least:
the polarizing plate according to claim 14; and
a liquid crystal cell.
